(19) United States
(12) Patent Application Publication
(10) Pub. No.: US 2025/0336566 A1
(43) Pub. Date: Oct. 30, 2025

(54) SYSTEMS AND METHODS FOR DETERMINING COMPOSITE CONDUCTOR PARAMETERS USING OPTICAL FIBERS

(71) Applicant: TS Conductor Corp., Huntington Beach, CA (US)

(72) Inventors: Jianzhong Jason HUANG, San Clemente, CA (US); Qing HE, Quebec (CA)

(21) Appl. No.: 19/184,421

(22) Filed: Apr. 21, 2025

Related U.S. Application Data
(60) Provisional application No. 63/638,196, filed on Apr. 24, 2024.

(51) Int. Cl. H01B 9/00; G01D 5/353; G01K 11/322; G01K 11/324; G01L 1/24; G02B 6/02; H01B 13/22

(52) U.S. Cl. CPC H01B 9/005; G01D 5/35316; G01K 11/322; G01K 11/324; G01L 1/242; G02B 6/02076; H01B 13/22

(57) ABSTRACT

A conductor includes a strength member including a core formed of a composite material. An encapsulation layer is disposed around the core. A groove may be defined in at least one of the core or the encapsulation layer. An optical fiber assembly is disposed in the groove, and includes a fiber core and a fiber encapsulation layer disposed therearound. A conductor layer is disposed around the strength member. A sensing element may be disposed within the fiber core at a pre-determined location along a length of the fiber core. A system may include a controller communicatively coupled to the optical fiber assembly to determine a value or change in a value of the operating parameter of the conductor. The system is configured to independently determine at least two different operating parameter of the conductor with high precision. A coupler may be coupled to an axial end of the conductor.

### CROSS-REFERENCE TO RELATED APPLICATIONS

The present application claims priority to and the benefit of U.S. Provisional Application No. 63/638,196, filed Apr. 24, 2024, and entitled, “Systems and Methods for Determining Composite Conductor Parameters Using Optical Fibers,” the entire disclosure of which is hereby incorporated by reference herein.

### TECHNICAL FIELD

The embodiments described herein relate generally to devices, systems and methods for determining operating parameters of a composite conductor by using optical fiber sensing.

### BACKGROUND

The electrical grid is a major contributor to greenhouse emissions and global warming. The US electrical grid is more than 25 years old and globally about 2,000 TWh electricity is wasted annually, and about 1 Billion Metric Ton of GHG emission is associated with just compensatory generation. As the demand for electricity grows, there is an increased demand for higher capacity electricity transmission and distribution lines. The amount of power delivered by an electrical conductor is dependent on the current-carrying capacity (also referred to as the ampacity) of the conductor transmitting the electric current. It is desirable to sense various operating parameters (e.g., temperature, sag) of electrical conductors during operation of electrical conductors for rapid identification of line faults and/or atmospheric conditions, and addressing any issues in a rapid fashion.

### SUMMARY

Systems and methods for determining real-time sag and temperature information of a composite conductor by using optical fiber based sensing are provided. Embodiments described herein relate generally to systems and methods for monitoring (e.g., real-time monitoring) of operating parameters of a composite conductor using optical fiber sensing. The measurements employing embodiments of the present disclosure may be used for real-time sag and/or temperature measurements of overhead power lines (e.g., transmission lines).

In some embodiments, an apparatus includes a conductor including a strength member. The strength member includes a core formed of a composite material, and an encapsulation layer disposed around the core. An optical fiber assembly is disposed in the core. The optical fiber assembly includes a fiber core and a fiber encapsulation layer. A conductor layer is disposed around the strength member. In some embodiments, a sensing element can be disposed within the fiber core at a pre-determined location along a length of the fiber core, the sensing element configured to exhibit a change in at least one of its optical properties in response to a change in a value of an operating parameter of the conductor.

A conductor, includes: a strength member, including: a core formed of a composite material, an encapsulation layer disposed around the core, and an optical fiber assembly disposed in the core, the optical fiber assembly including a fiber core, a fiber encapsulation layer disposed around the fiber core, and a sensing element disposed within the fiber core at a pre-determined location along a length of the fiber core, the sensing element configured to exhibit a change in at least one of its optical properties in response to a change in a value of an operating parameter of the conductor; and a conductor layer disposed around the strength member.

In some embodiments, a system includes a conductor including a strength member includes: a core formed of a composite material, an encapsulation layer disposed around the core; and an optical fiber assembly disposed in the core, the optical fiber assembly including: a fiber core, a fiber encapsulation layer disposed around the fiber core, and a sensing element disposed within the fiber core at a pre-determined location along a length of the fiber core, the sensing element configured to exhibit a change in at least one of its optical properties in response to a change in a value of an operating parameter of the conductor; and a conductor layer disposed around the strength member.

In some embodiments, at least one fiber Bragg gratings (FBGs) (i.e., one set of fiber Bragg gratings) can be disposed within the fiber core at a predetermined location along a length of the fiber core.

In some embodiments, a system includes: a conductor including: a strength member, including: a core formed of a composite material, an encapsulation layer disposed around the core, and an optical fiber assembly disposed in the core, the optical fiber assembly including: a fiber core, and a fiber encapsulation layer disposed around the fiber core, and a sensing element disposed within the fiber core at a pre-determined location along a length of the fiber core, the sensing element configured to exhibit a change in at least one of its optical properties in response to a change in a value of an operating parameter of the conductor; and a conductor layer disposed around the strength member; and a controller communicatively coupled to the optical fiber assembly, the controller configured to: receive a sensing signal from the optical fiber assembly, the sensing signal indicative of the operating parameter of the conductor, and at least one of: transmit the sensing signal to a receiver, or interpret the signal to determine a value of the operating parameter and transmit the value of the operating parameter to the receiver.

In some embodiments, a method includes providing the apparatus according to multiple embodiments described above to an external environment. The method includes transmitting an optical signal into the optical fiber assembly, and receiving a backscattered signal from the optical signal reflected in the optical fiber assembly. The method further includes determining at least one of: a change in strain distribution along a pre-determined length of the optical fiber assembly based on the received backscattered signal, the determined change in strain distribution being representative of a corresponding change in strain distribution of the conductor, or a change in temperature distribution along a pre-determined length of the optical fiber assembly based on the received backscattered signal, the determined change in temperature distribution being representative of a corresponding change in temperature distribution of the conductor.

In some embodiments, a method of forming a conductor includes: forming a composite core with an optical fiber assembly disposed therein, the optical fiber assembly including one or more optical fibers disposed axially along a length of the composite core; disposing an encapsulation layer around the composite core to form a strength member; disposing a set of conductor members around the strength member to form a conductor layer; and treating an outer surface of the conductor layer.

In some embodiments, a conductor includes: a strength member, including: a core including a composite material, an encapsulation layer disposed around the core, a groove defined in at least one of the core or the encapsulation layer, and an optical fiber assembly disposed in the groove, the optical fiber assembly including a fiber core, a fiber encapsulation layer disposed around the fiber core, and a sensing element disposed within the fiber core at a pre-determined location along a length of the fiber core, the sensing element configured to exhibit a change in at least one of its optical properties in response to a change in a value of an operating parameter of the conductor; and a conductor layer disposed around the strength member

In some embodiments, a method of operating a conductor including a conductor layer disposed around a strength member, the strength member including a core formed of a composite material, an encapsulation layer disposed around the core, and an optical fiber assembly disposed in the core, the optical fiber assembly including a fiber core, a fiber encapsulation layer disposed around the fiber core, and a sensing element disposed within the fiber core at a pre-determined location along a length of the fiber core, the sensing element configured to exhibit a change in at least one of its optical properties in response to a change in a value of an operating parameter of the conductor, the method includes transmitting an optical signal through the optical fiber assembly, such that the optical fiber assembly reflects at least a portion of the optical signal to form a backscattered signal, receiving the backscattered signal via an optical receiver, transmitting the backscattered signal to a controller including a processor, and processing the backscattered signal, via the processor, to determine a value of a parameter of the conductor. In some embodiments, the value of the parameter is a first value of the parameter, the method further including, modifying the parameter, via the controller, from the first value to a second value different from the first value.

In some embodiments, a method, includes: forming a groove in at least one of a core or an encapsulation layer, the groove extending from a first axial end to a second axial end of at least one of the core or the encapsulation layer: disposing an optical fiber assembly in the groove, the optical fiber assembly including one or more optical fibers disposed axially along a length of the groove: disposing the encapsulation layer around the core to form a strength member; and disposing a conductor layer around the strength member to form a conductor.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1A is a schematic illustration of a conductor for use in grid electrical transmission that includes a strength member including a composite core and an encapsulation layer, an optical fiber assembly disposed in the composite core, and a conductor layer disposed around the strength member, according to an embodiment.

FIG. 1B is a front cross-section view of an optical fiber assembly that may be disposed in the conductor of FIG. 1A, according to an embodiment.

FIG. 1C is a plot of bend radiuses of optical fibers, according to various embodiments.

FIG. 1D is a front cross-section view of an optical fiber assembly that may be disposed in the conductor of FIG. 1A, according to an embodiment.

FIG. 2 is front cross-section view of a conductor, according to an embodiment.

FIG. 3 is a front cross-section view of a conductor, according to an embodiment.

FIG. 4 is a front cross-section view of a conductor, according to an embodiment.

FIG. 5 is a schematic illustration of a system that includes a controller and an assembly including a conductor coupled to a coupler, according to an embodiment.

FIG. 6 is a schematic illustration of a system that includes a controller and an assembly including a conductor coupled to a coupler, according to an embodiment.

FIG. 7A is a schematic illustration of an assembly that includes a first conductor coupled to a second conductor via a coupler, according to an embodiment.

FIG. 7B is a schematic illustration of an assembly that includes a first conductor coupled to a second conductor via a coupler, according to an embodiment.

FIG. 8A is a schematic illustration of a stripping tool for stripping an encapsulation layer off a strength member of a conductor to allow accessing of a composite core of the strength member and thereby, at least a portion of an optical fiber assembly disposed therein, according to an embodiment.

FIG. 8B is a side view of an axial end of a composite core of a strength member of a conductor that has been stripped off an encapsulation layer via the stripping tool of FIG. 8A and a portion of which has been removed to allow access to a portion of an optical fiber assembly disposed therein, according to an embodiment.

FIG. 9 is schematic illustration of a system for sensing operating parameters of a conductor and transmitting the operating parameters or determined values of the operating parameters to a remote server, according to an embodiment.

FIG. 10A is schematic illustration of a system for sensing operating parameters of a conductor and transmitting the operating parameters or determined values of the operating parameters to a remote server, according to an embodiment.

FIG. 10B is schematic block diagram of a controller that is included in the systems of FIGS. 5, 6, and 9, according to an embodiment.

FIG. 11 is schematic illustration of a system for transmitting sensing signals received from an optical fiber assembly of conductor to a remote server via communication wires, according to an embodiment.

FIG. 12 is a schematic flow chart of a method for manufacturing a conductor including a strength member that includes a composite core having an optical fiber assembly disposed in the composite core and an encapsulation layer disposed around the composite core, and a conductor layer disposed around the strength member, according to an embodiment.

FIG. 13 is a schematic flow chart of a method for measuring operating parameters of a conductor including a strength member that includes a composite core having an optical fiber assembly disposed in the composite core and an encapsulation layer disposed around the composite core, and a conductor layer disposed around the strength member, according to an embodiment.

FIG. 14 is a schematic of a system for measuring sag in a conductor suspended between two poles of towers, via an optical fiber assembly embedded within a composite core of the conductor, and a controller configured to received optical signals from the optical fiber assembly, according to an embodiment.

FIG. 15A-G are schematic illustrations of conductors including grooves for optical fiber assemblies, according to various embodiments.

FIG. 16 is a schematic flow chart of a method for manufacturing a conductor including a groove and an optical fiber assembly disposed in the groove, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to systems and methods for determining and real-time monitoring of operating parameters (e.g., sag, temperature) of composite conductors and, in particular, electrical conductors that include a strength member including a composite core and an encapsulation layer disposed around the composite core, and a conductive layer(s) that may include a plurality of strands of a conductive material disposed around the strength member. An optical fiber assembly is disposed in the composite core and is configured to sense one or more operating parameters of the conductor.

“Sag” or “sagging” as described herein refers to the vertical distance between two points of support of the transmission towers and the lowest peak point of conductor that is suspended between the transmission towers or otherwise two suspension points, and is a result of bending of the conductor. Sag is an important parameter as it can impact the structural and/or functional properties of a conductor. For example, if there is too much tension, the sag will be too little and the conductor can snap. Therefore, extra sag may be deliberately provided to lower the tension in the conductor. However, if there is too much sag, it will increase the amount of conductor used, increasing the material cost, but too little sag may not meet regulatory standards. The more space there is between transmission towers, the more the transmission line will sag. In addition, the sag has to be such that it can withstand ice loading in the winter which can increase the weight of the conductor, thus increasing sag, which may breach safety standards. Similarly, if the sag is low, then when the line contracts in the winter, low sag will indicate a high tension, and as a result of this contraction, the line may snap. Thus, monitoring of the sag in conductors is beneficial in maintaining the sag within regulatory standards, and enabling proactive corrective measures if the sag increases or decreases beyond desired values.

In some embodiments, the systems and methods described herein can solve the problem of real-time measurement of power line sagging magnitude. Specifically, systems and methods described herein can provide a precise real-time sag measurement alongside the entire monitored power line in a cost-effective manner. Embodiments described herein also relate to systems and methods for electrical transmission using composite conductors and, in particular, to electrical conductors that include a strength member including a composite core and an encapsulation layer disposed around the composite core, and a conductive layer(s) that may include a plurality of strands of a conductive material disposed around the strength member. An optical fiber assembly is disposed in the composite core or in the encapsulating layer around the composite core and is configured to sense one or more operating parameters of the conductor.

Systems and methods described herein can also be adapted for the conventional conductors such that various operating parameters of the conductors such as, for example, sag, fault location, temperature, tension load, etc., can be measured passively and/or in real time. This can lead to awareness of the conductor and circuit condition for in system reliability and resiliency, operational flexibility, and optimization of the PowerGrid performance at all times, including much needed accurate situational awareness during extreme weather events.

Overhead power lines are a critical component of United States' electrical infrastructure, enabling the transmission of electricity across vast distances. However, these lines are subject to a variety of environmental factors that can affect their performance and safety. One of the most significant of these factors is sagging, a phenomenon where the line droops lower over time, particularly due to heating caused by the current it carries. This sagging can potentially violate ground clearance requirements, and may lead to power outages and/or safety hazards.

To manage this, utility companies have traditionally applied assumptions to determine the maximum current-carrying capacity (i.e., ampacity) of these lines. However, these assumptions often limit the true capability of the power lines, leading to inefficiencies in power transmission.

In recent years, in-situ monitoring of conductor sag and temperature profiles has emerged as a promising solution to this problem. This approach offers several key benefits, including dynamic line rating, the ability to assess the impact of extreme weather on the grid, insights into circuit conditions, such as conductor damage or vegetation issues, and early warnings of low clearance for enhanced grid safety. Despite these advantages, accurately measuring the conductor's arc length of each span after initial installation, and continuously monitoring the conductor's sag variation, temperature profile change, and strain profile change remain significant challenges. Current methods lack the precision needed to measure sag changes down to the centimeter range, which is crucial for maintaining line sag and clearance.

There are a couple of techniques in the field for measuring optical fiber conditions such as length, temperature profile, and strain profile. Optical time domain reflectometer (OTDR) is mainly used for measuring the optical length of the fiber. If the fiber's effective refractive index is known along the fiber, then the fiber's physical length can be calculated. However, the fiber's effective refractive index is not precisely known along the fiber since the environmental temperature could vary along the fiber, therefore the fiber physical length calculations are not very accurate. Furthermore, OTDR measures the whole fiber length (i.e., from dead-end to dead-end), but it is not able to measure each span's arc length.

Raman backscattering based distributed temperature sensing (DTS) measures the temperature profile along the fiber, while OTDR's basic function is for gauging the fiber length. Therefore, if the temperature profile along the fiber is unknown and the tension is not constant, the fiber physical length calculation is not very accurate.

Brillouin backscattering based distributed strain sensing (DSS) is used to measure the strain profile along the fiber, while OTDR is its basic function for gauging the fiber length. Therefore, if the tension (strain) along the fiber is unknown and not constant, the fiber physical length calculation is not very accurate.

As discussed above, existing techniques have their limitations. For instance, using an optical fiber inside the Optical Ground Wire (OPGW) can monitor environmental temperature, wind speed, wind direction, and icing data from weather forecasts. However, it cannot measure the actual sag, temperature, and strain changes of the conductor. Similarly, using an optical fiber inside one of the three Optical Phase Conductors (OPPC) can monitor one conductor's temperature but not the other two conductors. Moreover, these fibers are loose inside a metal tube, making them unsuitable for measuring conductor strain changes.

Lidar technology offers another approach, capable of measuring conductor clearance (i.e., sag) after initial installation and during scheduled routine checks. However, continuous monitoring would require installing a lidar per span, which is not economically viable. Furthermore, lidar measurements are unreliable in adverse weather conditions, such as fog, heavy snow, or icing rain.

In contrast, embodiments described herein provide cost-effective, accurate, and reliable methods for measuring and monitoring conductor arc length, sag variation, temperature profile change, and/or strain profile change.

Embodiments of the composite conductors that include a strength member and a conductor layer disposed around the strength member, and that include an optical fiber assembly disposed in a core of the strength member, may provide one or more benefits including, for example: 1) enabling accurate calculations of at least two operating parameters (e.g., temperature, sag) of the conductor using a single optical fiber and from a single optical fiber end: 2) allowing accurate distributed sensing of temperature to enable monitoring of temperature anomalies in the environment around the conductor, for example, to detect hot spots, cold spots, heatwaves, wildfires, winter storms, etc.: 3) providing precise length measurements of the conductor, allowing determination of a sag error of less than a half of a foot for a 500 meter long conductor: 4) disposing the optical fiber assembly in the composite core at strategic locations to allow easy access to the optical fiber assembly for splicing with another conductor, or coupling to a controller: 5) providing a special cutting tool to allow users (e.g., repairmen or installation workers) to rapidly and facilely access the optical fiber assembly from within the composite core: 6) reducing operational costs and transmission losses by allowing real time sensing of conductor faults and other operational parameters, and transmission to remote servers for rapid identification of transmission problems and responding thereto: 7) reducing optical transmissions losses by providing optical fiber assemblies with, or configuring optical fiber assemblies to have, a low bend radius: 8) enabling data transmission from opto-electronic instruments to central control stations to monitor facility or service provided by the central control stations: 9) providing a strength member that has a gap free encapsulation layer around a composite core that inhibits presence of air, oxygen, and/or electrolytes at the interface between the encapsulation layer and the core, thereby protecting encapsulation layer and core interface from corrosion, and the core from oxidation, moisture plasticization, ultraviolet (“UV”) light, corrosion, and generally environmental degradation: 10) protecting the fiber core and the composite core from compression and bending failures via the encapsulation layer: 11) providing cushioning via the encapsulation layer to protect the fiber core and the composite core during crimp coupling of the conductor to conventional crimp couplers, thereby reducing installation cost because special tools, special training, or custom couplers are not required for installation: 12) increase conductor strength and preserve residual tension in the composite core during manufacturing of the strength member such that any compressive stress in the conductor must first overcome the pre-existing tension in the composite core, thereby delaying buildup of compressive stress and inhibiting compression buckling failure that is associated with conventional conductors, as well as increasing bending stiffness: 13) disposing or otherwise, embedding one or more optical sensing assemblies within the composite core instead of a separate steel or aluminum tube as with conventional conductors, thereby causing the optical fiber assembly to be in intimate contact with the composite core of the conductor to enable the optical fiber assembly to measure strain, sag, or any change in conductor length with high fidelity; and 14) protecting the optical fiber assembly from moisture and environmental degradation by disposing the optical fiber assembly in the composite core and disposing the encapsulation layer therearound.

In some embodiments, the systems and methods described herein include the utilization of a hybrid optical interrogation solution (e.g., use of DTS and DSS, DTS and FBG). Some embodiments provided herein are designed to accurately measure the physical length variation of a span of each optical fiber assembly by assessing the strain change within the optical fiber assembly. This strain change can be subsequently translated into the sag change of each respective span.

As described herein, the term “bend radius” refers to the minimum allowable radius of curvature that an optical fiber can be safely bent without causing excessive optical signal loss or damage to the optical fiber.

As used herein, the term ‘micro-bending” is defined as the attenuation of an optical fiber that relates to the light signal loss associated with lateral stresses along the length of the optical fiber. The light signal loss is due to the coupling from the fiber's guided fundamental mode to lossy, higher-order radiation modes. Mode coupling occurs when fibers suffer small random bends along the optical fiber axes.

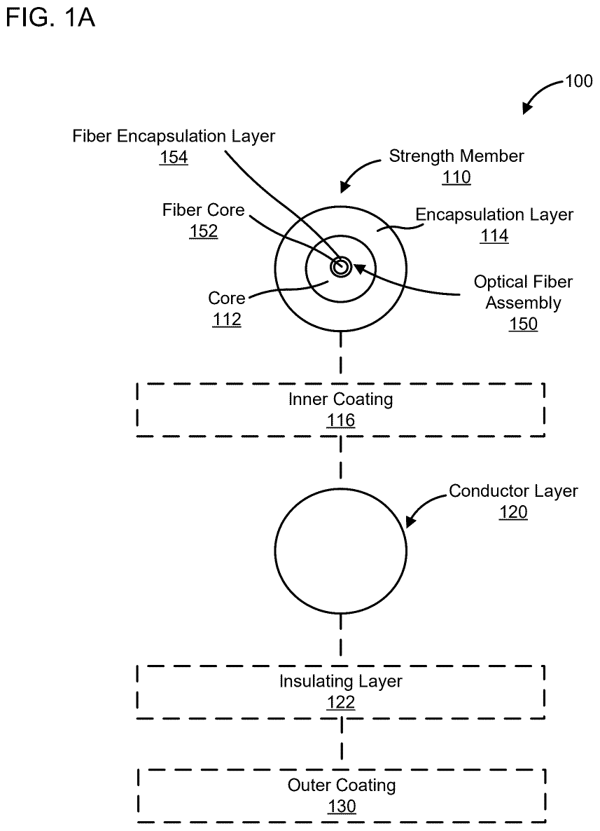

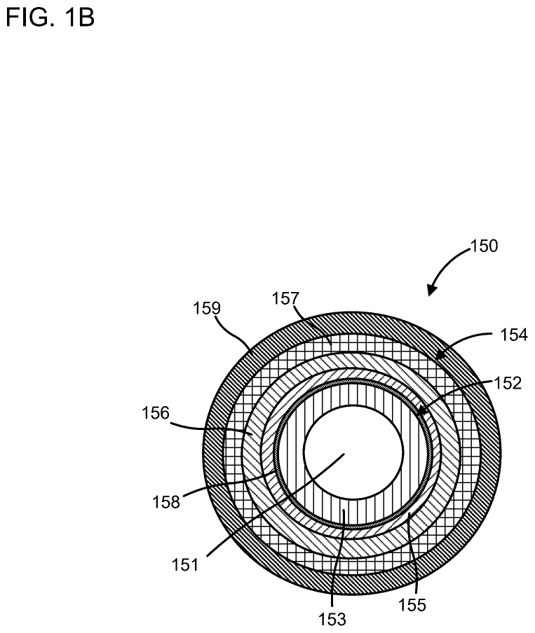

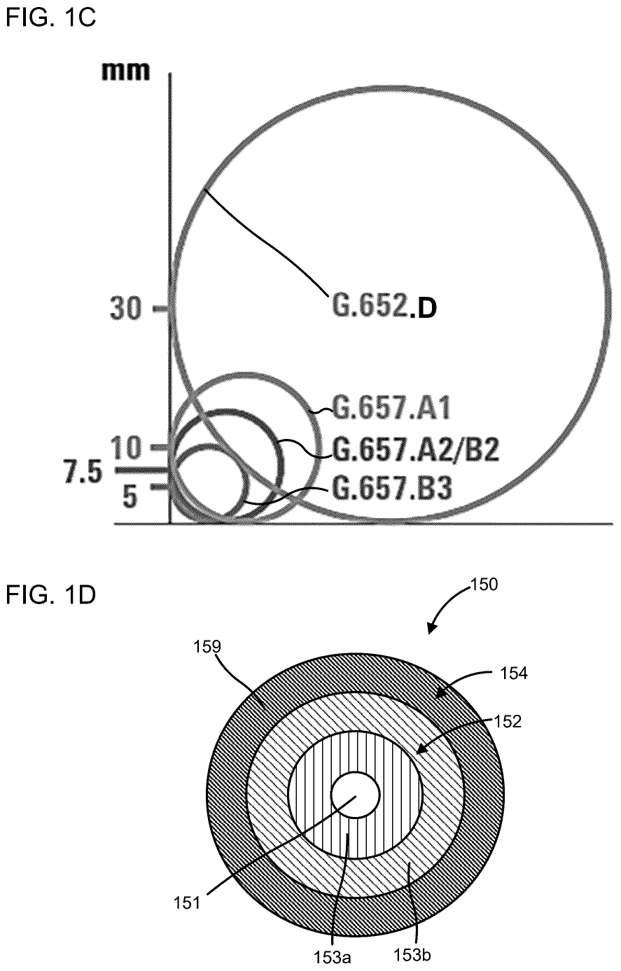

FIG. 1A is a schematic illustration of a conductor 100, according to an embodiment. The conductor 100 includes a strength member 110 including a composite core 112 (also referred to herein as “core 112”) and an encapsulation layer 114 disposed around the core 112, an optical fiber assembly 150 disposed in the core 112, a conductor layer 120 disposed around the strength member 110, and optionally, an insulating layer 122 disposed on the conductor layer 120, an outer coating 130 disposed on the insulating layer 122 or the conductor layer 120, and/or an inner coating 116 disposed around strength member 110, i.e., between the conductor layer 120 and the strength member 110.

In some embodiments, the encapsulation layer 114 is disposed circumferentially around the core 112. In some embodiments, the encapsulation layer 114 may inhibit (e.g., prevent) moisture ingress, for example, into the core 112 and/or the optical fiber assembly 150. For example, in some embodiments, the encapsulation layer 114 may be configured to inhibit moisture from contacting the core 112 or the optical fiber assembly 150. In some embodiments, the encapsulation layer 114 may be at least partially coupled to (e.g., in physical contact with) the core 112. For example, in some embodiments, the encapsulation layer 114 may be coupled to (e.g., in physical contact with) the core 112 along a length thereof.

In some embodiments, the length of the encapsulation layer 114 that is coupled to the core 112 is substantially the same as an entire length of the core 112. In some embodiments, the encapsulation layer 114 may be configured to conduct electricity (e.g., voltage and/or current) therethrough. In some embodiments, the encapsulation layer 114 may include an electrically conductive material. In some embodiments, the encapsulation layer 114 can include a metal, for example, to prevent moisture ingress. In some embodiments, the encapsulation layer 114 may include at least one of aluminum, steel reinforced aluminum, or an aluminum alloy. In some embodiments, the encapsulation layer 114 may be configured to protect the core 112 and/or the optical fiber assembly 150 from damage, for example, environmental damage from exposure to moisture or excess temperatures.

The core 112 may be formed from a composite material. In some embodiments, the composite material may include nonmetallic fiber reinforced metal matrix composite, carbon fiber reinforced composite of either thermoplastic or thermoset matrix, or composites reinforced with other types of fibers such as quartz, AR-Glass, E-Glass, S-Glass, H-Glass, silicon carbide, silicon nitride, alumina, basalt fibers, especially formulated silica fibers, any other suitable composite material, or any combination thereof. In some embodiments, the composite material includes a carbon fiber reinforced composite of a thermoplastic or thermoset resin. In some embodiments, the composite material includes at least one of carbon fibers, carbon nanotubes (CNTs) or graphene. The reinforcement in the composite strength member(s) can be discontinuous, for example, include whiskers or chopped fibers, or continuous fibers in substantially aligned configurations (e.g., parallel to axial direction) or randomly dispersed (including helically wind or woven configurations). In some embodiments, the composite material may include a continuous or discontinuous polymeric matrix composite reinforced by carbon fibers, glass fibers, quartz, or other reinforcement materials, and may further include fillers or additives (e.g., nanoadditives). In some embodiments, the core 112 may include a carbon composite including a polymeric matrix of epoxy resin cured with anhydride hardeners.

The core 112 may have any suitable cross-sectional width (e.g., diameter). In some embodiments, the core 112 has a diameter in a range of about 3 mm to about 15 mm, inclusive (e.g., 3, 4, 5, 6, 7, 8, 9, 10, 11, 12, 13, 14, or 15 mm, inclusive). In some embodiments, the core 112 may have a diameter in a range of about 5 mm to about 10 mm, inclusive. In some embodiments, the core 112 may have a diameter in a range of about 10 mm to about 15 mm, inclusive. In some embodiments, the core 112 may have a diameter in a range of about 7 mm to about 12 mm, inclusive. In some embodiments, the core 112 may have a diameter of about 9 mm.

The core 112 may have a first glass transition temperature (e.g., for thermoset composites), or melting point (e.g., for thermoplastic composites). In some embodiments, the first glass transition temperature or melting temperature is in a range of about 60 degrees Celsius to about 350 degrees Celsius, inclusive (e.g., about 100, about 110, about 120, about 130, about 140, about 150, about 160, about 170, about 180, about 190, about 200, about. 210, about 220, about 230), about 240), about 250), about 260), about 270, about 280, about 290, about 300, about 310, about 320, about 330), about 340, or about 350 degrees Celsius, inclusive). In some embodiments, the first glass transition temperature or melting temperature may be at least about 70 degrees Celsius (e.g., at least 100, at least 120, at least 140, at least 150, at least 160, at least 180, at least 200, at least 220, at least 240, at least 260, at least 28, or at least 300, degrees Celsius, inclusive). In some embodiments, the strength member 110 may have a processing temperature, i.e., a temperature at which the strength member 110 is manufactured or fabricated, which is substantially similar to the first glass transition temperature, for example, in a range of about 60 degrees Celsius to about 350 degrees Celsius.

The glass transition temperature or melting temperature of the core 112 may correspond to a threshold operating temperature of the conductor 100, which may limit the ampacity of the conductor 100. In other words, a maximum amount of current that can be delivered through the conductor 100 is the current at which the operating temperature of the conductor 100, or at least the temperature of the core 112, is less than the glass transition temperature or melting temperature of the composite core 112.

In some embodiments, the core 112 defines a circular cross-section. In some embodiments, the core 112 may define an ovoid, elliptical, polygonal, or asymmetrical cross-section. In some embodiments, the strength member 110 may include a single core 112. In other embodiments, the strength member 110 may include multiple cores, for example, 2, 3, 4, or even more, with the encapsulation layer 114 being disposed around the multiple cores or around each individual core. In such embodiments, each of the multiple cores may be substantially similar to each other, or at least one of the multiple cores may be different from the other cores (e.g., have a different size, different shape, formed from a different material, have components such as the optical fiber assembly 150 embedded therein, etc.).

In some embodiments, the conductor layer 120 may be disposed around the strength member 110. For example, in some embodiments, the conductor layer 120 may be disposed circumferentially around the core 112 and/or the encapsulation layer 114. In some embodiments, the conductor layer 120 may be at least partially coupled to (e.g., in physical contact with) at least one of the core 112 or the encapsulation layer 114. For example, in some embodiments, the conductor layer 120 may be disposed circumferentially around, and at least partially coupled to, the encapsulation layer 114. In some embodiments, the conductor layer 120 may be configured to conduct electricity (e.g., voltage and/or current) therethrough. In some embodiments, the conductor layer 120 may include an electrically conductive material. For example, in some embodiments, the conductor layer 120 can include at least one of aluminum, steel reinforced aluminum, an aluminum alloy, or copper.

The optical fiber assembly 150 is disposed in the core 112, for example, embedded within the core 112 during the manufacturing of the core 112, or otherwise during manufacturing of the strength member 110. While generally described as being disposed in the core 112, in some embodiments, the optical fiber assembly 150 may be disposed at any suitable location within the conductor 100. For example, in some embodiments, the optical fiber assembly 150 may be disposed in the encapsulation layer 114 around the core 112. In some embodiments, the optical fiber assembly 150 may be disposed in the conductor layer 120, for example, disposed inside one or more conductive strands included in the conductor layer 120. In some embodiments, the optical fiber assembly 150 may be disposed in the insulating layer 122 that may be disposed around the conductor layer 120. The optical fiber assembly 150 may include a single-mode a multi-mode optical fiber assembly, or any combination of single or multi-mode optical fiber assemblies, and the optical fiber assembly 150 may be configured to transmit optical energy therethrough.

In some embodiments, the optical fiber assembly 150 may be configured to have a pulling test level above a certain threshold in order to sustain potential high strain of the conductor 100. That is, the optical fiber assembly 150 may be designed and tested prior to being incorporated into the conductor 100 to withstand significant mechanical stress or pulling forces without breaking or being damaged.

The optical fiber assembly 150 may be disposed axially along, or otherwise parallel to, a central axis of the core 112, and may extend along an entire length of the core 112, and thereby, the conductor 100. The optical fiber assembly 150 includes a fiber core 152 and a fiber encapsulation layer 154 disposed around the fiber core 152. The fiber core 152 may include an optical fiber (e.g., including at least one of a single-mode optical fiber, a multi-mode optical fiber, a graded index fiber, a step index fiber, a glass optical fiber, a plastic optical fiber, any other suitable optical fiber, a plurality thereof, or a combination thereof), for example, that is capable of transmitting optical energy or light having a wavelength in a range of about 100 nm to about 1 mm, inclusive (e.g., from the ultraviolet to the infrared range).

In some embodiments, a sensing element (not shown) can be disposed within the fiber core 152 at a pre-determined location along a length of the fiber core 152. The sensing element is configured to exhibit a change in at least one of its optical properties in response to a change in a value of an operating parameter of the conductor 100. In some embodiments, the sensing element is configured to exhibit a change in its refractive index in response to a change in a value of an operating parameter of the conductor.

In some embodiments, the sensing element may include reflective elements (e.g., reflective structures) disposed within the fiber core 152. These reflective elements (i.e., reflective structures) can serve one or more distinct functions. For example a function of these reflective elements may be to reflect electromagnetic radiation (e.g., at least a portion of an electromagnetic radiation (e.g., a beam of light) in the fiber core 152) out of the fiber's core (e.g., fiber core 152), thereby providing electromagnetic radiation to an external detector (e.g., a controller).

In some embodiments, optical energy (e.g., electromagnetic radiation, light beam, etc.) may travel in the fiber core 152 along a central axis of the fiber core 152 (e.g., aligned substantially with the central axis of the core 112), for example, via total internal reflection (TIR) of the electromagnetic radiation in the fiber core 152 (e.g., via a difference in refractive index between the optical fiber in the fiber core 152 and cladding therearound). In some embodiments, the central axis of the fiber core 152 may be a first path (i.e., first optical path) in which the optical energy travels in the fiber core 152. In other words, in some embodiments, the first path may be defined along the central axis of the fiber core 152. In some embodiments, the reflective elements may be configured to reflect at least a portion of the electromagnetic radiation from the first path (i.e., first optical path) to a second path (i.e., second optical path) different from the first path.

For example, in some embodiments, the second path may be at an angle, for example, defined relative to an axis substantially perpendicular to the central axis of the fiber core 152 (and/or an axis defined substantially perpendicular to an interface between optical fiber and cladding included in the fiber core 152). In some embodiments, the angle of the second path may be less than or equal to a critical angle for TIR (e.g., angle of the second path and critical angle defined relative to an axis defined substantially perpendicular to the central axis of the fiber core 152 and/or relative to an axis defined substantially perpendicular to an interface between optical fiber and cladding included in the fiber core 152, such that a beam of light to be reflected via TIR) in the fiber core 152, for example, such that light (e.g., the electromagnetic radiation) reflected by the reflective elements may escape the fiber core 152, e.g., and be captured by an external analysis device for analysis of the light.

In some embodiments, the first and second paths may overlap. For example, incident light may be communicated along the length of the fiber core 152 along a first direction at a first wavelength. Light reflected by the reflected elements may travel backwards along a second direction opposite the first direction through the fiber core 152, and be detected by a sensor configured to receive the light.

The reflective elements can take various forms, such as a grating or a simple scattering structure like a point feature. In some embodiments, the reflective elements may include one or more microstructures, optical prisms, other suitable reflective structures, or a combination thereof, the reflective elements configured to reflect a portion of the beam of light. In some embodiments, the microstructures may have a size in a range of about 3 microns to about 15 microns. Alternatively, or additionally, a second function that may be provided by the reflective elements involves the analysis of the electromagnetic radiation propagating within the fiber core 152. This analysis can generate a signal containing information to be detected.

Exemplary operating parameters that can be measured using the optical fiber assembly 150 include at least one of temperature, sag, strain, pressure, position, shape and vibration. The optical fiber assembly 150 may be configured as and/or part of any of a variety of measurement apparatuses or systems. For example, the optical fiber assembly 150 may be configured as, or may include, a temperature sensor, a strain sensor, a distributed temperature sensor (DTS), an interferometer, and may use one or more optical detection methods such as, for example, optical frequency-domain reflectometry (OFDR), optical time-domain reflectometry (OTDR) sensor, and/or distributed strain sensing (DSS) system for measuring one or more parameters of the conductor 100.

In some embodiments, the sensing element can include at least one fiber Bragg grating (FBG). In some embodiments, the sensing element, or the at least one FBG, includes a plurality of FBGs (i.e., more than one set of FBGs) distributed along a pre-determined length of the optical fiber assembly 150. In some embodiments, at least a portion of the conductor 100 includes an overhead power line that may be suspended between two adjacent support structures (such as towers or poles), and a span of the overhead line can include two FBGs disposed within the fiber core 152 with a pre-determined distance from each other, for example, proximate to axial ends of the conductor 100. That is, in some embodiments, the pre-determined distance refers to a distance between two FBGs (i.e., two set of gratings) disposed along the span of the overhead line.

In some embodiments, the pre-determined distance can be at least about 10 m, at least about 25 m, at least about 50 m, at least about 75 m, at least about 100 m, at least about 125 m, at least about 150 m, at least about 200 m, at least about 225 m, at least about 250 m, at least about 275 m, at least about 300 m, at least about 325 m, or at least about 350 m. In some embodiments, the pre-determined distance can be no more than about 1,000 m, no more than about 750 m, no more than about 500 m, no more than about 450 m, no more than about 400 m, no more than about 350 m, no more than about 300 m, no more than about 250 m, no more than about 200 m, no more than about 150 m, or no more than about 100 m. Combinations of the above-referenced thicknesses are also possible (e.g., at least about 10 m and no more than about 1,000 m, or at least about 50 m and no more than about 500 m), inclusive of all values and ranges therebetween.

As used herein, the term “fiber Bragg gratings (FBGs)” is a permanent periodic refractive index modulation in the core (e.g., fiber core 152) of an optical fiber that extends along a selected length of the core (e.g., fiber core 152), such as about 1-100 mm. FBGs reflect light within a narrow bandwidth centered at a Bragg wavelength “λ_{B}”. The reflected Bragg wavelength λ_{B} from FBGs can change with changes in conditions around the fiber, such as changes in temperature, strain, and pressure, sufficient to change the effective refractive index seen by propagating light and/or the grating period of the FBGs. By measuring the reflected Bragg wavelength λ_{B}, FBGs can be used as a sensor for measuring such conditions. FBGs can also be used as a pressure sensor by measuring the shift in Bragg wavelength caused by compression of the fiber.

The gratings (i.e., FBGs) may be written in any selected radial or angular position or orientation, for example, via the femtosecond laser methods described herein. For example, the grating may be positioned centrally within the fiber core 152, i.e., at or near the central longitudinal axis of the fiber core 152, or offset radially from the central axis. In addition, multiple gratings (i.e., FBGs) may be written at different radial and/or angular positions or orientations, e.g., for detection of bending stresses.

The length and number of FBGs is not limited. The distance between each grating of FBGs can vary depending on the specific application and design parameters. The spacing between each gratings within one FBGs is referred to as the grating period or pitch.

In some embodiments, the grating period of FBGs can be in the range of several hundred nanometers (nm) to a few millimeters (mm). In some embodiments, the grating period of FBGs can be in the range of several hundred nanometers (nm) to a few micrometers (μm). For example, in some embodiments, the grating period of FBGs is no more than about 5 mm, no more than about 4 mm, no more than about 3 mm, no more than about 2 mm, no more than about 1 mm, no more than about 0.5 mm, no more than about 0.1 mm, no more than about 0.05 mm, or no more than about 0.01 mm.

In some embodiments, a number of gratings having a selected grating period may be written along a selected portion of the fiber core 152. FBGs may be placed along any length of the optical fiber assembly 150 (e.g., fiber core 152). In this way, a distributed sensing system can be made that provides measurements along an entire length of the conductor 100 (or along some length of interest) using a single continuous optical fiber (e.g., fiber core 152 which is continuous along some length of interest of the conductor 100).

In some embodiments, the FBGs can be written such that the length of fiber has a continuous or quasi-continuous grating. For example, using the methods described herein, an optical fiber may be written with a continuous grating extending along a selected length of the optical fiber (e.g., fiber core 152). In another example, a plurality of gratings can be positioned very close to one another (end-to-end) to provide a near continuous measurement unit.

In some embodiments, FBGs can be written into an optical fiber included in the optical fiber assembly 150 using femtosecond laser writing processes. In some embodiments. FBGs can be embedded into an optical fiber (e.g., fiber core 152) by changing its refractive index using femtosecond laser writing processes or written by UV laser during fiber drawing.

In some embodiments, the composite material (e.g., of the core 112) and the optical fiber assembly 150 have a similar, or substantially the same, thermal expansion coefficient (i.e., coefficient of thermal expansion (CTE)). In some embodiments, the composite material (e.g., of the core 112) has a first thermal expansion coefficient (i.e., first CTE). In some embodiments, the optical fiber assembly 150 (e.g., fiber core 152, fiber encapsulation layer 154) has a second thermal expansion coefficient (i.e., second CTE) lying within a range of plus or minus about 0.1%, about 0.5%, about 1%, about 2%, about 3%, about 4%, about 5%, or about 10% of the first thermal expansion coefficient.

FIG. 1B is a front-cross section view of the optical fiber assembly 150 showing one or more layers that may be included in the optical fiber assembly 150, according to an embodiment. In some embodiments, the fiber core 152 may include a central core 151 and a cladding layer 153 disposed around the central core 151. In some embodiments, the central core 151 has a first refractive index, and the cladding layer 153 disposed around the central core 151 has a second refractive index lower than the first refractive index to confine light transmitted through the central core 151. While FIG. 1B shows the optical fiber assembly 150 as including a plurality of layers, this is for illustrative purposes only and one or more of the layers included in the optical fiber assembly 150 may be optional, may be arranged or disposed in any suitable arrangement, or the optical fiber assembly 150 may include additional layers not shown in FIG. 1B and as described herein. All such embodiments are envisioned and should be considered to be within the scope of the present application.

In some embodiments, the central core 151 includes a doped silica. In some embodiments, the doped silica may include germanium (Ge) and/or alkali metal, i.e., the silica may be doped with germanium and/or alkali metal (e.g., at least one of Li, Na, K, Rb, Cs, or Fr). In other words, in some embodiments, the central core 151 may include silica and a dopant including at least one of Ge, Li, Na, K, Rb, Cs, or Fr. In some embodiments, the central core 151 includes doped silica to provide a positive refractive index relative to pure silica. In some embodiments, the central core 151 includes pure silica (i.e., silica that is not doped, i.e., undoped silica). In some embodiments, the central core 151 may include a solid core. In some embodiment, the central core 151 may include a hollow core (e.g., define a channel or conduit therethrough). In such embodiments, the fiber core 152 may include a hollow-core photonic-crystal fiber. In some embodiments, the fiber core 152 may include a single central core 151 as shown in FIG. 1B. In some embodiments, the fiber core 152 may include multiple cores (e.g., include a multi-core fiber). In such embodiments, each of the multiple cores may be used to transmit the same optical signal or different optical signals, for example, signals carrying different information or used for measuring different operating parameters of the conductor 100.

In some embodiments, the central core 151 has a diameter in a range of about 2 μm to about 80 μm, inclusive of all values and ranges therebetween. For example, in some embodiments, the central core 151 has a diameter of at least about 2 μm, at least about 2.5 μm, at least about 3 μm, at least about 3.5 μm at least about 4 μm, at least about 4.5 μm, at least about 5 μm, at least about 5.5 μm, at least about 6 μm, at least about 6.5 μm, at least about 7 μm, at least about 7.5 μm, at least about 8 μm, at least about 8.5 μm, at least about 9 μm, at least about 9.5 μm, at least about 10 μm, at least about 10.5 μm, at least about 11 μm, at least about 11.5 μm, at least about 12 μm, at least about 12.5 μm, at least about 13 μm, at least about 13.5 μm, at least about 14 μm, at least about 15 μm, at least about 16.5 μm, at least about 17 μm, at least about 17.5 μm, at least about 18 μm, at least about at least about 18.5 μm, at least about 19 μm, at least about 19.5 μm, at least about 20 μm, at least about 22 μm, at least about 24 μm, at least about 26 μm, at least about 28 μm, at least about 30 μm, at least about 32 μm, at least about 34 μm, at least about 36 μm, at least about 38 μm, at least about 40 μm, at least about 42 μm, at least about 44 μm, at least about 46 μm, at least about 48 μm, at least about 50 μm, at least about 52 μm, at least about 54 μm, at least about 56 μm, at least about 58 μm, at least about 60 μm, or at least about 62 μm. In some embodiments, the central core 151 has a diameter of no more than about 80 μm, no more than about 75 μm, no more than about 70 μm, no more than about 65 μm, no more than about 60 μm, no more than about 55 μm, no more than about 50 μm, no more than about 45 μm, no more than about 40 μm, no more than about 35 μm, no more than about 30 μm, no more than about 25 μm, no more than about 20 μm, no more than about 15 μm, no more than about 14.5 μm, no more than about 14 μm, no more than about 13.5 μm, no more than about 13 μm, no more than about 12.5 μm, no more than about 12 μm, no more than about 11.5 μm, no more than about 11 μm, no more than about 10.5 μm, or no more than about 10 μm. Combinations of the above-referenced thicknesses are also possible (e.g., at least about 2 μm and no more than about 80 μm, or at least about 10.5 μm and no more than about 40 μm), inclusive of all values and ranges therebetween.

In some embodiments, the cladding layer 153 is configured to inhibit transmission of optical energy therethrough to prevent transmission losses. In some embodiments, the cladding layer 153 includes a silica. In some embodiments, the cladding layer 153 includes an undoped silica. In some embodiments, the cladding layer 153 may include silica doped with at least one of a halogen (e.g., at least one of Fl, Cl, Br, I, At, or Ts, such as at least one of Fl, Cl, Br, or I) and/or an alkali metal (e.g., at least one of Li, Na, K. Rb, Cs, or Fr). In some embodiments, the cladding layer 153 may include silica and a dopant including at least one of Fl, Cl, Br, I, At, Ts, Li, Na, K, Rb, Cs, or Fr. In some embodiments, the cladding layer 153 includes a silica doped with at least one of fluorine, chlorine, or an alkali metal. In some embodiments, the cladding layer 153 may include silica and a dopant including at least one of Fl or Cl. While FIG. 1B shows the optical fiber assembly 150 as including a single cladding layer 153, in some embodiments, the optical fiber assembly 150 may include multiple cladding layers. For example, the cladding layer 153 can include 2, 3, or more layers (e.g., include a double clad or triple clad fiber).

In some embodiments, the fiber core 152 includes the central core 151, and the cladding layer 153 disposed around the central core 151, the cladding layer 153 having a thickness in a range of about 80 μm to about 1,000 μm. In some embodiments, the cladding layer 153 includes a first cladding layer having a first index of refraction (i.e., first refractive index) and a second cladding layer having a second index of refraction (i.e., second refractive index) different than the first index of refraction. In some embodiments, the sensing element can be disposed within the cladding layer 153. For example, in some embodiments, the sensing element can be disposed in the first cladding layer at a pre-determined location along the length of the fiber core. In some embodiments, the sensing element can include at least one FBG.

In some embodiments, the cladding layer 153 may have a thickness configured to reduce micro-bending induced optical energy transmission losses, for example, reduce the micro-bending induced optical energy transmission losses to be equal to or less than 5 dB/km. Expanding further, embedding the optical fiber assembly 150 in the core 112 that may be formed of a composite material can generate random strains on the optical fiber assembly 150 during the curing process of the core 112 causing micro-bending. The micro-bending can build up along the length of the fiber, and this micro-bending can be significant for optical fibers having thin claddings (e.g., having a thickness of less than 80 μm). As described herein, the cladding layer 153 of the optical fiber assembly 150 has a thickness that significantly reduces micro-bending induced optical energy transmission losses, for example, by increasing the stiffness of the optical fiber assembly 150.

In some embodiments, the cladding layer 153 has a thickness in a range of about 80 μm to about 2,000 μm, inclusive of all values and ranges therebetween. In some embodiments, the cladding layer 153 has a thickness of at least about 80 μm, at least about 90 μm, at least about 100 μm, at least about 110 μm, at least about 120 μm, at least about 130 μm, at least about 140 μm, at least about 150 μm, at least about 160 μm, at least about 170 μm, at least about 180 μm, at least about 190 μm, at least about 200 μm, at least about 210 μm, at least about 220 μm, at least about 230 μm, at least about 240 μm, at least about 250 μm, at least about 260 μm, at least about 270 μm, at least about 280 μm, at least about 290 μm, at least about 300 μm, at least about 310 μm, at least about 320 μm, at least about 330 μm, at least about 340 μm, at least about 350 μm, at least about 360 μm, at least about 370 μm, at least about 380 μm, at least about 390 μm, at least about 400 μm, at least about 410 μm, at least about 420 μm, at least about 430 μm at least about 440 μm, at least about 450 μm, at least about 460 μm, at least about 470 μm, at least about 480 μm, at least about 490 μm, at least about 500 μm, at least about 550 μm, at least about 600 μm, at least about 650 μm, or at least about 700 μm. In some embodiments, the cladding layer 153 has a thickness of no more than about 2,000 μm, no more than about 1800 μm, no more than about 1500 μm, no more than about 1300 μm, no more than about 1,000 μm, no more than about 800 μm, no more than about 500 μm, no more than about 400 μm, no more than about 300 μm, no more than about 200 μm, or no more than about 100 μm. Combinations of the above-referenced thicknesses are also possible (e.g., at least about 150 μm and no more than about 1,000 μm or at least about 400 μm and no more than about 500 μm), inclusive of all values and ranges therebetween.

In some embodiments, the cladding layer 153 has a thickness in a range of about 800 μm to about 2,000 μm. In some embodiments, the cladding layer 153 has a thickness in a range of about 150 μm and to about 1,000 μm. In some embodiments, the cladding layer 153 may have a thickness of about 80 μm, about 100 μm, about 150 μm, about 200 μm, about 250 μm, about 300 μm, about 350 μm, about 400 μm, about 500 μm, about 600 μm, about 700 μm, about 800 μm, about 900 μm, or about 1,000 μm, inclusive.

The fiber encapsulation layer 154 is disposed around the fiber core 152. The fiber encapsulation layer 154 may be configured to protect the fiber core 152 from mechanical and environmental stresses, for example, to reduce micro-bending induced losses, and/or protect the optical fiber (e.g., included in the fiber core 152) from heat that may be generated during formation of the core 112 of the strength member 110, and may include a single layer or multiple layers.

As show in FIG. 1B, in some embodiments, the fiber encapsulation layer 154 may include a protective layer 155 or buffer layer disposed on the fiber core 152. In some embodiments, the protective layer 155 may include an acrylate based coating having a thickness in a range of about 10 μm to about 300 μm (e.g., about 10, 20, 30, 40, 50, 60, 70, 80, 90, 100, 110, 120, 130, 140, 150, 160, 170, 180, 190, 200, 210, 220, 230, 240, 250, 260, 270, 280, 290, or about 300 μm, inclusive).

In some embodiments, the fiber encapsulation layer 154 may include a cladding layer (e.g., substantially the same as cladding layer 153).

In some embodiments, the fiber encapsulation layer 154 may include a temperature resistant layer 156 disposed on the protective layer 155, or in place of the protective layer 155 such that the temperature resistant layer 156 is disposed directly on the fiber core 152. In some embodiments, the temperature resistant layer 156 may have a second glass transition temperature or melting temperature that is greater than the first glass transition temperature or melting temperature of the core 112, or processing temperature of the strength member 110. In some embodiments, the second glass transition temperature or melting temperature may be in a range of about 80 degrees Celsius to about 450 degrees Celsius, inclusive (e.g., about 80), about 90, about 100, about 110, about 120, about 130, about 140, about 150, about 160), about 170, about 180, about 190, about 200, about 210, about 220, about 230, about 240), about 250), about 260), about 270), about 280), about 290, about 300, about 350), about 360, about 370), about 380, about 390, about 400, about 410, about 420, about 430), about 440), or about 450) degrees Celsius, inclusive).

In some embodiments, the second glass transition temperature or melting temperature may be at least about 80 degrees Celsius. In some embodiments, the second glass transition temperature or melting temperature may be at least about 100 degrees Celsius. In some embodiments, the second glass transition temperature or melting temperature may be at least about 120 degrees Celsius. In some embodiments, the second glass transition temperature or melting temperature may be at least about 140 degrees Celsius. In some embodiments, the second glass transition temperature or melting temperature may be at least about 160 degrees Celsius. In some embodiments, the second glass transition temperature or melting temperature may be at least about 170 degrees Celsius. In some embodiments, the second glass transition temperature or melting temperature may be at least about 180 degrees Celsius. In some embodiments, the second glass transition temperature or melting temperature may be at least about 190 degrees Celsius. In some embodiments, the second glass transition temperature or melting temperature may be at least about 200 degrees Celsius. In some embodiments, the second glass transition temperature or melting temperature may be at least about 220 degrees Celsius. In some embodiments, the second glass transition temperature or melting temperature may be at least about 240 degrees Celsius. In some embodiments, the second glass transition temperature or melting temperature may be at least about 260 degrees Celsius. In some embodiments, the second glass transition temperature or melting temperature may be at least about 280 degrees Celsius. In some embodiments, the second glass transition temperature or melting temperature may be at least about 300 degrees Celsius. In some embodiments, the second glass transition temperature or melting temperature may be at least about 320 degrees Celsius. In some embodiments, the second glass transition temperature or melting temperature may be at least about 340 degrees Celsius. In some embodiments, the second glass transition temperature or melting temperature may be at least about 360 degrees Celsius. In some embodiments, the second glass transition temperature or melting temperature may be at least about 380 degrees Celsius. In some embodiments, the second glass transition temperature or melting temperature may be at least about 400 degrees Celsius. In some embodiments, the second glass transition temperature or melting temperature may be at least about 420 degrees Celsius. In some embodiments, the second glass transition temperature or melting temperature may be at least about 440 degrees Celsius. In some embodiments, the second glass transition temperature or melting temperature may be at least about 450 degrees Celsius.

In some embodiments, the temperature resistant layer 156 may include a temperature resistant coating or buffer layer having the second glass transition temperature or melting temperature. In some embodiments, the temperature resistant layer 156 may include a silicone and/or polyimide coating (e.g., a 180C silicone coating or a 280C silicone coating). In some embodiments, the temperature resistant layer 156 may have a thickness in a range of about 0.1 mm to about 3 mm, inclusive (e.g., a 180C silicone coating). In some embodiments, the temperature resistant layer 156 may have a thickness in a range of about 0.001 mm to about 0.1 mm, inclusive (e.g., a thin polyimide or a 280C silicone coating). In some embodiments, the temperature resistant layer 156 may have a thickness in a range of about 400 μm to about 1,000 μm, inclusive (e.g., about 400, 450, 500, 550, 600, 650, 700, 750, 800, 850, 900, 950, or 1,000 μm, inclusive).

In some embodiments, the temperature resistant layer 156 may also have a low Young's modulus (i.e., modulus of elasticity) that may allow protecting the central core 151 and cladding layer 153 by efficiently dissipating internal stresses that can arise when the exterior of the optical fiber assembly 150 is bent or subjected to an external force. That is, the soft and/or flexible temperature resistant layer 156 disposed on the fiber core 152 may also help to decrease strain toward a surface of the cladding layer 153, thereby reducing micro-bending losses.

In some embodiments, the temperature resistant layer 156 may have a Young's modulus of at least about 0). 1 MPa, at least about 0.5 MPa, at least about 1 MPa, at least about 2 MPa, at least about 3 MPa, at least about 4 MPa, at least about 5 MPa, at least about 8 MPa, at least about 10 MPa, at least about 12 MPa, at least about 15 MPa, at least about 18 MPa, at least about 20 MPa, at least about 30 MPa, at least about 35 MPa, at least about 40 MPa, at least about 45 MPa, at least about 50 MPa, at least about 60 MPa, at least about 70 MPa, or at least about 80 MPa. In some embodiments, the temperature resistant layer 156 may have a Young's modulus of no more than about 1000 MPa, no more than about 500 MPa, no more than about 400 MPa, no more than about 300 MPa, no more than about 200 MPa, no more than about 100 MPa, no more than about 80 MPa, no more than about 50 MPa, no more than about 40 MPa, no more than about 30 MPa, no more than about 20 MPa, no more than about 10 MPa, or no more than about 5 MPa. Combinations of the above-referenced Young's modulus values also possible (e.g., at least about 0.5 MPa and no more than about 30 MPa or at least about 10 MPa and no more than about 400 MPa), inclusive of all values and ranges therebetween.

In some embodiments, the temperature resistant layer 156 is thermally stable up to about 400 degrees Celsius, up to about 350 degrees Celsius, up to about 330 degrees Celsius, up to about 300 degrees Celsius, up to about 280 degrees Celsius, up to about 250) degrees Celsius, up to about 220 degrees Celsius, up to about 200 degrees Celsius, up to about 150 degrees Celsius, or up to 100 degrees Celsius

In some embodiments, the fiber encapsulation layer 154 may include a jacket 157 disposed on the temperature resistant layer 156, disposed on the protective layer 155 in embodiments in which the temperature resistant layer 156 is not included, or disposed directly on the fiber core 152 in embodiments in which each of the temperature resistant layer 156 and the protective layer 155 are excluded. The jacket 157 may be formed from any suitable material such as, for example, acrylate, fluoroacrylate, silicone, polyimide (PI), carbon, polyetheretherketone (PEEK), nylon, poly butylene terephthalate (PBT), polypropylene (PP), polyethylene (PE), low-smoke, zero halogen (LSZH) PE-PP, polyvinylchloride (PVC), polyvinylidene fluoride (PVDF), polyurethane (TPU), halogen free flame retardant polyurethane (HFFR), thermoplastic polyester elastomers (TPE), ethylene tetrafluoroethylene ETFE, TEFLON™, polyfluoroalkoxy TEFLON™, any other suitable material or a combination thereof. In some embodiments, the jacket 157 may include PEEK, nylon, or any other suitable material that is disposed tightly around the fiber core 152 or around inner layers of the fiber encapsulation layer 154 (e.g., the protective layer 155 and/or temperature resistant layer 156). In such embodiments, the jacket 157 may have a thickness in a range of about 400 μm to about 1.000 μm, inclusive (e.g., about 400, 450, 500, 550, 600, 650, 700, 750, 800, 850, 900, 950, or 1,000 μm, inclusive). In some embodiments, the jacket 157 may include PVC, PE, PVD, LSZH, or any other suitable material that is disposed loosely around the fiber core 152 or inner layers 155, 156 of the fiber encapsulation layer 154. In such embodiments, the jacket 157 may have a thickness in a range of about 900 μm to about 3,000 μm, inclusive (e.g., 900, 1,000, 1,200, 1,400, 1,600, 1,800, 2,000, 2,200, 2,400, 2,600, 2,800, or 3,000 μm, inclusive).

In some embodiments, the jacket 157 has a Young's modulus of greater than about 30 MPa. In some embodiments, the jacket 157 has a Young's modulus greater than the Young's modulus of the thermal resistant layer 156 to further protect the fiber core 152 from micro-bending losses. In some embodiments, the jacket 157 has Young's modulus of at least about 30 MPa, at least about 50 MPa, at least about 70 MPa, at least about 100 MPa, at least about 120 MPa, at least about 150 MPa, at least about 180 MPa, at least about 200 MPa, at least about 250 MPa, at least about 300 MPa, at least about 350 MPa, at least about 400 MPa, at least about 450 MPa, at least about 500 MPa, at least about 550 MPa, at least about 600 MPa, at least about 650 MPa, at least about 700 MPa, at least about 750 MPa, at least about 800 MPa, or at least about 850 MPa. In some embodiments, the jacket 157 has a Young's modulus of no more than about 2000 MPa, no more than about 1800 MPa, no more than about 1500 MPa, no more than about 1200 MPa, no more than about 1000 MPa, no more than about 800 MPa, no more than about 500 MPa, no more than about 200 MPa, no more than about 100 MPa, no more than about 80 MPa, or no more than about 50 MPa. Combinations of the above-referenced Young's modulus values also possible (e.g., at least about 100 MPa and no more than about 1000 MPa or at least about 30 MPa and no more than about 400 MPa), inclusive of all values and ranges therebetween.

In some implementations, it may be desirable to inhibit water ingress into the optical fiber assembly 150. Water diffusion into the optical fiber assembly 150 can lead to an irreversible attenuation in optical signals being transmitted through the optical fiber assembly 150. Moisture can also ingress into microcracks in the fiber core 152 and enlarge such microcracks which can reduce the life of the optical fiber assembly 150. The effect can be even more dramatic in cold weather when the diffused moisture can freeze and expand causing further damage or failure of the optical fiber assembly 150. While the encapsulation layer 114 disposed around the core 112 substantially inhibits moisture ingress into the core 112 and thereby, the optical fiber assembly 150, moisture may still be able to enter and diffuse into the optical fiber assembly 150, for example, during the manufacturing process of the strength member 110, or from exposed axial ends of the optical fiber assembly 150 that may extend out of the strength member 110 (e.g., for coupling to the optical fiber assembly 150 of another conductor or terminating at a receiver or controller.

In some embodiments, the fiber encapsulation layer 154 may also include one or more water exclusion layers to inhibit moisture ingress into the optical fiber assembly 150 or at least a portion of the optical fiber assembly 150 (e.g., the fiber core 152) from moisture. For example, in some embodiments, the fiber encapsulation layer 154 may include an inner moisture exclusion layer 158 disposed around the fiber core 152, for example, disposed around the cladding layer 153. The inner moisture exclusion layer 158 may include a thin layer of a moisture resistant material that conformally or uniformly coats the fiber core 112 (e.g., disposed on the cladding layer 153) such to inhibit moisture ingress into the fiber core 152. In some embodiments, the inner moisture exclusion layer 158 may include a thin coating formed from carbon, metals (e.g., aluminum, gold, copper, alloys), or polymers (e.g., TEFLON®, nylon, etc.)

In some embodiments, the fiber encapsulation layer 154 may additionally, or alternately include an outer moisture exclusion layer 159, that may be disposed around one or more inner layers of the fiber encapsulation layer 154, for example, around the jacket 157, or around the temperature resistant layer 156. In other words, the outer moisture exclusion layer 159 may form the outer most layer of the fiber encapsulation layer 154. In some embodiments, the outer moisture exclusion layer 159 may include a thin layer of a moisture resistant material that forms the outer most layer of the fiber encapsulation layer and is configured to inhibit moisture ingress into the fiber core 152. In some embodiments, the outer moisture exclusion layer 159 may include a thin coating formed from carbon, metals (e.g., aluminum, gold, copper, alloys), or polymers (e.g., TEFLON®, nylon, etc.) In some embodiments, the outer moisture exclusion layer 159 may include an additional component separate from the optical fiber assembly 150. For example, the outer moisture exclusion layer 159 may include a tube (e.g., a metal tube such as a stainless steel or aluminum tube) defining a channel within which the optical fiber assembly 150 is disposed. In such embodiments, the optical fiber assembly 150 may be disposed loosely within the outer moisture exclusion layer 159, or the outer moisture exclusion layer 159 may be compressed or extruded over the fiber encapsulation layer 154 such that there is substantially no clearance between optical fiber assembly 150 and the outer moisture exclusion layer 159. In some embodiments, multiple optical fiber assemblies 150 may be disposed within a single outer moisture exclusion layer 159.

In some embodiments, the optical fiber assembly 150 includes at least one of G.657.A1. G.657.A2, G.657.B2, G.657.B3 or G.652.D optical fibers. The optical fiber assembly 150 that has a lower bend radius (e.g., having an optical fiber with a lower bend radius) may correspond to having a lower micro-bending induced optical energy transmission losses. For example, FIG. 1C is a plot of bend radiuses of the G.652.D. G.657.A1. G.657.A2/B2, and G.657.B3 optical fiber assemblies, without any additional layers disposed thereon. While the G.652.D optical fiber has a bend radius of about 30 mm, the G.657.A1 optical fiber assembly has a bend radius of about 10 mm, the G.657.A2/B2 assembly has a bend radius of about 7.5 mm, and the G.657.B3 optical fiber assembly has a bend radius of about 5 mm. This indicates that the G.657.A1. G.657.A2/B2, and the G.657.B3 optical fiber assemblies may have lower micro-bending induced optical energy transmission losses relative to the G.652.D optical fiber assembly.

In some embodiments, the optical fiber assembly 150 may include a G.657.B3 optical fiber, which includes a fiber core 152 having central core 151 including germanium doped silica, a silica cladding layer 153 having a thickness in a range of about 60 μm to about 130 μm, inclusive disposed around the central core 151, and an acrylate protective layer 155 having a thickness in a range of about 50 μm to about 200 μm, inclusive, disposed on the cladding layer 153. The optical fiber assembly 150 including the G.657.B3 optical fiber may have a bend radius of less than 10 μm, and may have a micro-bending induced optical energy transmission loss of equal to or less than about 5 dB/km. In some embodiments, to provide heat protection and/or to further reduce micro-bending induced optical transmission losses, the optical fiber assembly 150 including the G.657.B3 optical fiber may include the fiber encapsulation layer 154 including one or more additional layers disposed on the protective layer 155. For example, the fiber encapsulation layer 154 may include the temperature resistant layer 156, for example, a silicone or polyimide coating, disposed on or around the protective layer 155, and having a thickness in a range of about 0.01 mm to about 3.0 mm, inclusive. The fiber encapsulation layer 154 may also include the jacket 157 disposed on the temperature resistant layer 156. The jacket 157 may be formed from PEEK or any other jacket material described herein, and may have a thickness in a range of about 80 μm to about 2,000 μm, inclusive. In some embodiments, including the temperature resistant layer 156 and/or the jacket 157 may reduce the micro-bending loss of the G.657.B3 optical fiber to be equal to or less than 1 dB/km.

In some embodiments, the optical fiber assembly 150 may include the G.657.B3 optical fiber as described herein, but having a thicker cladding layer 153 than previously described herein, for example, a cladding having a thickness in a range of about 100 μm to about 500 μm, inclusive. In some embodiments, the fiber encapsulation layer 154 that additionally includes the temperature resistant layer 156 is disposed around the acrylate protective layer 155. In some embodiments, the temperature resistant layer 156 may include a silicone buffer layer having a thickness in a range of about 80 μm to about 1,500 μm, inclusive (e.g., a 180C silicone layer). In some embodiments, the temperature resistant layer 156 may include a thin high temperature coating disposed on the acrylate protective layer 155, which has a thickness in a range of about 10 μm to about 100 μm, inclusive (e.g. a 280C silicone coating).

In some embodiments, the optical fiber assembly 150 may include a G.652.D optical fiber that includes the fiber core 150 having central core 151 including germanium doped silica, the cladding layer 153 having a thickness in a range of about 80 μm to about 1,000 μm, inclusive (e.g., about 200 μm) disposed around the central core 151, and the fiber encapsulation layer 154 including the protective layer 155 formed from acrylate and having a thickness in a range of about 100 μm to about 200 μm, inclusive disposed on the cladding layer 153. Conventional G.652.D optical fibers include a cladding having a thickness of about 62.5 μm. Such conventional G.652.D optical fibers generally have a bend radius of about 30 mm, and can have a micro-bending induced optical energy transmission loss of equal to or greater than about 300 dB/km. In contrast, the G.652.D optical fiber described herein having the thicker cladding layer 153 may have a micro-bending induced optical energy transmission loss of equal to or less than 5 dB/km.

In some embodiments, to provide heat protection and/or to further reduce micro-bending induced optical transmission losses, the fiber encapsulation layer 154 of the G.652.D optical fiber assembly may additionally include the temperature resistant layer 156, for example, a silicone or polyimide coating, disposed on or around the protective layer 155. The temperature resistant layer 156 may have a thickness in a range of about 0.01 mm to about 3.0 mm, inclusive. The fiber encapsulation layer 154 of the G.652.D optical fiber assembly 150 may also include the jacket 157 disposed on the temperature resistant layer 156. The jacket 157 may be formed from may be formed from PEEK or any other suitable material described herein, and may have a thickness in a range of about 80 μm to about 3,000 μm, inclusive. In some embodiments, including the temperature resistant layer 156 and/or the jacket 157 may reduce the micro-bending loss of the G.652.D optical fiber assembly 150 to be equal to or less than 5 dB/km.

In some embodiments, the optical fiber assembly 150 may be configured to transmit optical communication signals (e.g., internet signals, cable signals, telecom signals, etc.), and may configured as fiber-to-home cables. In some embodiments, the optical fiber sensing assembly 150 may be configured to measure various operating parameters of the conductor 100, for example, mechanical parameters such as strain (e.g., distributed strain), stress, sag, change in length, etc., or temperature (e.g., distribute temperature), or electrical operating parameters (e.g., detect line faults or breaks). For example, a signal generator may be used to communicate optical energy (e.g., a continuous or pulsed laser light) with wavelength (λₒ) into the fiber core 152, and analyze the returning optical energy (e.g., Raman back scattering light or Brillouin back scattering light) from the same fiber core 152 to obtain precise temperature (T) and strain (ε) profile along the conductor 100 in real-time.

In some embodiments, time of flight measurements may be used to determine the conductor length for precise line sag information or line fault location real time. When optical energy (e.g., laser light) propagates inside the fiber core 152, it may interact with the material which forms the fiber core 152 and generate Raman scattering light and Brillouin scattering light. The power intensity of anti-Stokes Raman Back Scattering light is sensitive only to fiber's temperature change, therefore the intensity ratio between anti-stokes and stokes peaks is used to calculate the temperature (T) variation. Detection of wavelength change of Brillouin back scattering light can be used to measure both temperature (T) and strain (c) of the fiber. In some embodiments, the optical fiber assembly 150 may be able to sense various parameters of the conductor 100 or surroundings thereof using optical time domain reflectometry (OTDR), distributed temperature sensing (DTS), distributed strain sensing (DSS), and/or distributed acoustic sensing (DAS).

In some embodiments, the optical fiber assembly 150 may be configured to sense or monitor vibration in the conductor 100 or in the air surrounding the conductor 100. In some embodiments, the optical fiber assembly 150 may be configured to sense aeolian vibrations that are high frequency and low amplitude vibrations, and/or sense galloping vibrations that are low frequency and high amplitude vibrations. Aeolian vibrations may correspond to wind speeds of less than about 8 m/s, and ability to sense aeolian vibrations may enable the optical fiber assembly 150 to sense wind speed. Moreover, galloping vibrations may correspond to wind speeds of equal to or greater than about 10 m/s, and ability to sense these vibrations may allow determination of high winds around the conductor 100, which can damage the conductor 100 or may be indicators of a hazardous weather. In some embodiments, the optical fiber assembly 150 may be configured to monitor vibrations in a range of about 2 m/s to about 50 m/s, that may enable monitoring vibrations in a portion or sub-span of the conductor 100. In some embodiments, 5 or more optical fiber assemblies 150 may be included in the conductor 100 that are collectively used for vibration monitoring.

As previously described, conventional conductors include optical fiber sensors that may be stranded on the conductor or disposed within a separate tube (e.g., a hollow stainless steel or aluminum tube) that is co-located with various conductor layers of such conventional conductors. These conventional configurations are “loose” configurations” that do not allow the optical fibers to be in intimate contact with the various conductor layers of such conventional conductors which inhibits such optical fiber sensors from being able to measure mechanical properties (e.g., sab, change in length, strain, etc.) of such conventional conductors. In contrast, the optical fiber assembly 150 may be disposed in the core 112 such that the optical fiber assembly 150 is in intimate contact with the core 112. Because of this intimate contact, any mechanical stress, strain, sag, and/or change in length of the conductor 100 is also experienced by the optical fiber assembly 150, thus allowing the optical fiber assembly 150 to accurately measure changes in mechanical operating parameters. Moreover, the intimate contact also allows accurate measurement of conductor temperature (e.g., to allow detection and inhibit overheating of the core 112 above the first glass temperature) and/or to environmental temperature, for example, to enable monitoring of temperature anomalies in the environment around the conductor, for example, to detect hot spots, cold spots, heatwaves, wildfires, winter storms, etc.

As described herein in more detail, the core 112 with the optical fiber assembly 150 disposed therein may be formed by heating the composite core material to a forming temperature that may about equal to or above the first glass transition temperature or melting temperature of the core 112, or the processing temperature of the strength member, as previously described herein. The heated core material may be then molded, pulled, pultruded, or extruded along with the optical fiber assembly 150 (and optionally, along with the encapsulation layer 114) so as to form the core 112 (or otherwise, the strength member 110) with the optical fiber assembly 150 disposed or embedded in the core 112, and being in intimate contact with the core 112. Jackets used in conventional optical fibers have a glass transition temperature or melting temperature that is similarly to or lower than the first glass transition temperature or melting temperature, or processing temperature, such that the jackets of such conventional optical fibers would be damaged during the manufacturing process. In contrast, the second glass transition temperature or melting temperature or melting temperature of the fiber encapsulation layer 154 (e.g., the temperature resistant layer 156 and/or the jacket 157) of the optical fiber assembly 150 is greater than the first glass transition temperature or melting temperature such that heating of the composite material during forming of the core 112 does not damage the fiber encapsulation layer 154. Thus, the optical fiber assembly 150 can be disposed in, embedded in, or integrated into the core 112 while damage to the fiber encapsulation layer 154 is inhibited due to its higher second glass transition temperature or melting temperature. Moreover, the fiber encapsulation layer 154 may include one or more layers configured to reduce micro-bending induced transmission losses, as previously described herein.

While FIG. 1A shows the core 112 including a single optical fiber assembly 150, in some embodiments, a plurality of optical fiber assemblies 150 may be disposed in the core 112. In some embodiments, the one or more optical fiber assemblies 150 may be loosely packed inside the composite core 112 such that it is strongly bonded to the composite material of the core 112, but the loose packing beneficially reduces micro-bending of optical fibers.

In some embodiments, the composite core 112 may have a first color and the fiber encapsulation layer 154 (e.g., an outer jacket layer of the fiber encapsulation layer 154) may have a second color different from the first color. For example, the composite material used to form the core 112 may include carbon fibers, graphene, graphite, or some other reinforcing material that has a dark color such that the first color may be a dark color (e.g., black or near black color). In such embodiments, it may be difficult for a user installing the conductor 100 and desiring to access the optical fiber assembly 150 disposed within the core 112, to visually differentiate the optical fiber assembly 150 from the dark background provided by the core 112. To allow the user to easily differentiate the optical fiber assembly 150 from the core 112 material, the second color of the fiber encapsulation layer 154 may have a high contrast relative to the core 112. For example, the fiber encapsulation layer 154 may have a bright color such as white, bright pink, bright green, bright orange, bright blue, or any other suitable color that has a substantially high contrast with the color of the core 112. In some embodiments, the fiber encapsulation layer 154 may include a fluorescent material or include a fluorescent dye (e.g., nanoparticles, quantum dots, Eosin yellow, luminol, fluorescein, coumarin, cyanine, rhodamine, acridine orange, malachite green, zinc sulfide, any other suitable fluorescent material or a combination thereof) that may allow a user to visually differentiate the optical fiber assembly 150 from the core 112 (e.g., by shining a suitable excitation light on the core 112 so as to cause the fiber encapsulation layer 154 to fluoresce). In some embodiments, the fiber encapsulation layer 154 may include a phosphorescent material (e.g., phosphorous).

The optical fiber assembly 150 may be disposed at any suitable location in the core 112. In some embodiments, the optical fiber assembly 150 may be disposed approximately along a central axis of the strength member 110, or a central axis of the conductor 100 in embodiments in which the conductor 100 has a single strength member 110.

As previously described, micro-bending is usually caused by external mechanical stresses against the cable material that compress the optical fiber, or may be due to actual bending of the strength member 110, for example, during installation or use of the conductor 100. For example, the micro-bending may be caused in the optical fiber assembly 150 during manufacturing of the strength member 110 (e.g., pultruding or extruding of the composite core 112 along with the optical fiber assembly 150 disposed therein), deliberate bending of the conductor 100 (e.g., due to coiling of the conductor 100 in a spool), or during operation of the conductor 100 (e.g., due to tensile stresses, sag, or compressive stresses caused by temperature changes or accumulation of dirt, dust, snow, or ice on the conductor 100). Micro-bending can result in random, high-frequency perturbations in the optical fiber assembly 150 that can cause signal transmission losses. Micro-bending stresses will generally be the smallest at or proximate to the central axis of the core 112. Thus, locating the optical fiber assembly 150 along the central axis of the core 112 may reduce the micro-bending stresses on the optical fiber assembly 150, thereby reducing optical energy transmission losses.

In some embodiments, the optical fiber assembly 150 may have a micro-bending induced optical energy transmission loss in a range of about 0.1 dB/km to about 30 dB/km, inclusive of all values and ranges therebetween. For example, in some embodiments, the optical fiber assembly 150 may have a micro-bending induced optical energy transmission loss of at least about 5.0 dB/km, at least about 4.8 dB/km, at least about 4.5 dB/km, at least about 4.2 dB/km, at least about 4.0 dB/km, at least about 3.8 dB/km, at least about 3.5 dB/km, at least about 3.2 dB/km, at least about 3.0 dB/km, at least about 2.8 dB/km, at least about 2.5 dB/km, at least about 2.2 dB/km, at least about 2.0 dB/km, at least about 1.8 dB/km, at least about 1.5 dB/km, at least about 1.2 dB/km, at least about 1.0 dB/km, at least about 0.8 dB/km, at least about 0.6 dB/km, at least about 0.4 dB/km, at least about 0.2 dB/km, or at least about 0.1 dB/km. In some embodiments, the optical fiber assembly 150 has a micro-bending induced optical energy transmission loss of no more than about 30 dB/km, no more than about 28 dB/km, no more than about 25 dB/km, no more than about 22 dB/km, no more than about 20 dB/km, no more than about 18 dB/km, no more than about 15 dB/km, no more than about 12 dB/km, no more than about 10 dB/km, no more than about 8 dB/km, no more than about 5 dB/km, no more than about 3 dB/km, no more than about 2 dB/km, no more than about 1 dB/km, no more than about 0.5 dB/km, no more than about 0.1 dB/km, or no more than about 0.05 dB/km. Combinations of the above-referenced micro-bending induced losses are also possible (e.g., at least about 0.1 dB/km and no more than about 4.5 dB/km or at least about 5 dB/km and no more than about 30 dB/km), inclusive of all values and ranges therebetween. Using an optical fiber assembly 150 that has a low micro-bending induced optical energy transmission loss advantageously allows positioning of the optical fiber assembly 150 at any suitable location in the core 112, for example, offset from the central-axis or proximate to an radially outer edge of the core 112, as described herein.

In some embodiments, the optical fiber assembly 150 has a micro-bending induced optical energy transmission loss between about 0.2 dB/km and about 20 dB/km, about 0.2 dB/km and about 15 dB/km, about 0.2 dB/km and about 10 dB/km, about 0.2 dB/km and about 5 dB/km, about 0.2 dB/km and about 4 dB/km, about 0.2 dB/km and about 3 dB/km, about 0.2 dB/km and about 2 dB/km, or about 0.2 dB/km and about 1.0 dB/km.

In some embodiments, the optical fiber assembly 150 has a bend radius of at least about 20 mm, at least about 19 mm, at least about 18 mm, at least about 17 mm, at least about 16 mm, at least about 15 mm, at least about 14 mm, at least about 13 mm, at least about 12 mm, at least about 11 mm, at least about 10 mm, at least about 9 mm, at least about 8 mm, at least about 7 mm, at least about 6 mm, at least about 5 mm, at least about 4 mm, at least about 3 mm, or at least about 2 mm such that the optical fiber assembly 150 has a micro-bending induced optical energy transmission loss of at equal to or less than about 5.0 dB/km. In some embodiments, the optical fiber assembly 150 has a bend radius of no more than about 40 mm, no more than about 38 mm, no more than about 35 mm, no more than about 32 mm, no more than about 30 mm, no more than about 28 mm, no more than about 25 mm, no more than about 22 mm, no more than about 20 mm, no more than about 18 mm, no more than about 15 mm, no more than about 12 mm, no more than about 10 mm, no more than about 9 mm, no more than about 8 mm, no more than about 7 mm, no more than about 6 mm, or no more than about 5 mm. Combinations of the above-referenced bend radius values are also possible (e.g., at least about 6 mm and no more than about 15 mm or at least about 5 mm and no more than about 10 mm), inclusive of all values and ranges therebetween. Using an optical fiber assembly 150 that has a low bend radius may advantageously lead to a low micro-bending induced optical energy transmission loss, which allows positioning of the optical fiber assembly 150 at any suitable location in the core 112, for example, offset from the central-axis or proximate to an radially outer edge of the core 112, as described herein.

In some instances, it may be desirable to enable a user to easily access the optical fiber assembly 150 disposed or embedded in the core 112. For example, in some instances a user or worker may need to remove at least a portion of the conductor layer 120, the encapsulation layer 114, and the core 112 to gain access to the optical fiber assembly 150 to allow routing and coupling of the optical fiber assembly 150 to a controller (e.g., the controller 570 as described in further detail herein), or for splicing the optical fiber assembly 150 with an optical fiber assembly of another conductor. It may be difficult for the user to gain access to or visually identify the optical fiber assembly 150 if it is located or buried deep within the core 112. In some embodiments, the optical fiber assembly 150 may be disposed proximate to a radially outer edge of the core 112. In other words, the optical fiber assembly 150 may be disposed parallel to the central axis of the core 112 proximate to an outer peripheral edge of the core 112. This may allow the user to easily access the optical fiber assembly 150 by removing only a small portion of the core 112 proximate to a radially outer edge of the core 112.

In some embodiments, a shortest radial distance from an outer edge of the optical fiber assembly 150 to a proximate radial outer edge of the core 112 may be in a range of about 0.1 mm to about 3 mm, inclusive (e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.2, 2.4, 2.6, 2.8, or 3.0 mm, inclusive). In some embodiments, the shortest radial distance may be at least 0.1 mm. In some embodiments, the shortest radial distance may be at least 0.2 mm. In some embodiments, the shortest radial distance may be at least 0.3 mm. In some embodiments, the shortest radial distance may be at least 0.4 mm. In some embodiments, the shortest radial distance may be at least 0.5 mm. In some embodiments, the shortest radial distance may be at least 0.6 mm. In some embodiments, the shortest radial distance may be at least 0.7 mm. In some embodiments, the shortest radial distance may be at least 0.8 mm. In some embodiments, the shortest radial distance may be at least 0.9 mm. In some embodiments, the shortest radial distance may be at least 1.0 mm. In some embodiments, the shortest radial distance may be at least 1.2 mm. In some embodiments, the shortest radial distance may be at least 1.4 mm. In some embodiments, the shortest radial distance may be at least 1.6 mm. In some embodiments, the shortest radial distance may be at least 1.8 mm. In some embodiments, the shortest radial distance may be at least 2.0 mm. In some embodiments, the shortest radial distance may be at least 2.2 mm. In some embodiments, the shortest radial distance may be at least 2.4 mm. In some embodiments, the shortest radial distance may be at least 2.6 mm. In some embodiments, the shortest radial distance may be at least 2.8 mm. In some embodiments, the shortest radial distance may be at least 3.0 mm.

In some embodiments, the shortest radial distance may be at most 3 mm. In some embodiments, the shortest radial distance may be at most 2.8 mm. In some embodiments, the shortest radial distance may be at most 2.6 mm. In some embodiments, the shortest radial distance may be at most 2.4 mm. In some embodiments, the shortest radial distance may be at most 2.2 mm. In some embodiments, the shortest radial distance may be at most 2.0 mm. In some embodiments, the shortest radial distance may be at most 1.9 mm. In some embodiments, the shortest radial distance may be at most 1.8 mm. In some embodiments, the shortest radial distance may be at most 1.7 mm. In some embodiments, the shortest radial distance may be at most 1.6 mm. In some embodiments, the shortest radial distance may be at most 1.5 mm. In some embodiments, the shortest radial distance may be at most 1.4 mm. In some embodiments, the shortest radial distance may be at most 1.3 mm. In some embodiments, the shortest radial distance may be at most 1.2 mm. In some embodiments, the shortest radial distance may be at most 1.1 mm. In some embodiments, the shortest radial distance may be at most 1.0 mm.

The optical fiber assembly 150 may thus be used to measure conductor length of the conductor 100 for measuring precise sag in the monitored circuit real time accuracy. The sag determination may be independent of environmental condition. The conductor length may also be useful to determine a fault location in the conductor 100 when necessary for prompt dispatch of crew to the exact fault location. Accurate distributed temperature sensing may allow for monitoring of surrounding areas such as wildfires or winter storm, as well as hot spots (e.g., partial conductor damage from broken strands) and cold spots (e.g., vegetation accidents with tree onto the conductor). Determination of the strain profile along conductor length of the conductor 100 may allow for accurate monitoring of snow or ice accumulation to enable proactive remediation (e.g., ice melting) and storm restoration. Such information may allow a controller (e.g., a power grid control room) to monitor the conductor 100 operation in real time with confidence and reliability.

The encapsulation layer 114 is disposed around the core 112, for example, circumferentially around the core 112. In some embodiments, an inner insulation layer (not shown) may optionally be interposed between the core 112 and the encapsulation layer 114. The inner insulation layer may be formed from any suitable insulative material, for example, glass fibers (e.g., disposed either substantially parallel to axial direction or woven or braided glass), a resin layer, an insulative coating, any other suitable insulative material or a combination thereof. In some embodiments, the inner insulation layer may also be disposed on axial ends of the core 112, for example, to protect the axial ends of the core 112 from corrosive chemicals, environmental damage, etc.

The encapsulation layer 114 may be formed from any suitable electrically conductive or non-conductive material. In some embodiments, the encapsulation layer 114 may be formed from a conductive material including, but not limited to aluminum (e.g., 1350-H19), annealed aluminum (e.g., 1350-0), aluminum alloys (e.g., Al—Zr alloys, 6000 series Al alloys such 6201-TSl, -T82, -T83, 7000 series Al alloys, 8000 series Al alloys, etc.), copper, copper alloys (e.g., copper magnesium alloys, copper tin alloys, copper micro-alloys, etc.), any other suitable conductive material, or any combination thereof. In some embodiments, the encapsulation layer 114 is formed from Al and is pre-tensioned, i.e., is under tensile stress after being disposed on the core 112. In some embodiments, the encapsulation layer 114 may be formed from a non-conductive material, e.g., polymers, carbon fiber, glass fiber, ceramics, silicone, rubber, polyurethane, any other suitable non-conductive material, or a combination thereof.

The encapsulation layer 114 may be disposed on the core 112 using any suitable process. In some embodiments, the encapsulation process for disposing the encapsulation layer 114 around the core 112 may employ a conforming machine. For example, the encapsulation process may be performed with a similarly functional machine other than a conforming machine, and be optionally further drawn to achieve target characteristics of the encapsulation layer 114 (e.g., a desired geometry or stress state). The conforming machines or the similar machines used for disposing the encapsulation layer 114 may allow quenching of the encapsulation layer 114. The conforming machine may be integrated with stranding machine, or with pultrusion machines used in making fiber reinforced composite strength members. While FIG. TA shows a single encapsulation layer 114 disposed around the core 112, in some embodiments, multiple encapsulation layers 114 may be disposed around the core 112. In such embodiments, each of the multiple encapsulation layers 114 may be substantially similar to each other, or may be different from each other (e.g., formed from different materials, have different thicknesses, have different tensile strengths, etc.). In some embodiments, core 112 may include a carbon fiber reinforced composite, and the encapsulation layer 114 may include aluminum, for example, pre-tensioned or pre-compressed aluminum.

In some embodiments, an interface between the core 112 and the encapsulation layer 114 may include surface features, for example, grooves, slots, notches, indents, detents, etc. to enhance adhesion, bonding and/or interfacial locking between a radially outer surface of the core 112 and a radially inner surface of the encapsulation layer 114. Such surface features may facilitate retention and preservation of the stress from pre-tensioning in the encapsulation layer 114. In some embodiments, the composite core 112 may have a glass fiber tow disposed around its outer surface to create a screw shape or twisted surface. In some embodiments, a braided or woven fiber layer is applied in the outer layer of the core 112 to promote interlocking or bonding between the core 112 and the encapsulation layer 114.

In some embodiments, the encapsulation layer 114 may have a thickness in a range of about 0.3 mm to about 5 mm, inclusive, or even higher (e.g., 0.3, 0.5, 1, 1.5, 2.0, 2.5, 3.0, 3.5, 4.0, 4.5, 5.0 mm, inclusive, or even higher). In some embodiments, a ratio of an outer diameter of the encapsulation layer 114 to an outer diameter of the core 112 is in range of about 1.2:1 to about 5:1, inclusive (e.g., 1.2:1, 1.5:1, 2:1, 2.5:1, 3:1, 3.5:1, 4:1, 4.5:1, or 5:1, inclusive).

In some embodiment, the strength member 110 may have a minimum level of tensile strength, for example, at least 600 MPa (e.g., at least 600, at least 700, at least 800, at least 1,000, at least 1,200, at least 1,400, at least 1,600, at least 1,800, or at least 2,000 MPa). In some embodiments, the elongation during pre-tension of the strength member 110 may include elongation by at least 0.01% strain (e.g., at least 0.01%, at least 0.05%, at least 0.1%, at least 0.15%, at least 0.2%, at least 0.25%, at least 0.3%, at least 0.35%, at least 0.4%, at least 0.45%, or at least 0.5% strain, inclusive) depending on the type of strength members and the degree of knee point reduction, and the strength member 110 may be pre-tensioned before or after entering the conforming machine. Moreover, the strength member 110 may be configured to endure radial compression from crimping of conventional fittings as well as radial pressure during conforming of drawing down process or folding and molding of at least 3 kN (e.g., at least 3, at least 4, at least 5, at least 10, at least 15, at least 20, or at least 25 kN, inclusive), for example for composite cores 112 with little to substantially no plastic deformation.

In some embodiments, the encapsulation layer 114 may have an outer surface that is configured to be smooth and shiny (e.g., surface treated) so as to reduce absorptivity (i.e., enhance solar reflectivity) so as to reduce an operating temperature of the core 112 and to prevent the temperature of the core 112 from exceeding its glass transition temperature or melting temperature or melting point. As described in further detail herein, the outer coating 130 may be formulated to have high radiative emissivity in the 2.5 microns to 15 microns wavelength, inclusive of the solar radiation. While this may cause cooling of the conductor layer 120, the radiated heat will also travel towards the strength member 110 and cause heating of the core 112, for example, cause the core 112 to be at a higher operating temperature than the conductor layer 120, which is undesirable. To reduce absorption of this emitted radiation, the outer surface of the encapsulation layer 114 may be sufficiently reflective so as to have solar absorptivity of less than 0.6 (e.g., less than 0.55, less than 0.5, less than 0.45, less than 0.4, less than 0.35, less than 0.3, less than 0.25, less than 0.2, less than 0.15, or less than 0.1, inclusive) at a wavelength in a range of 2.5 microns to 15 microns, inclusive (e.g., 2.5, 3.0, 3.5, 4.0, 4.5, 5.0, 5.5, 6.0, 6.5, 7.0, 7.5, 8.0, 8.5, 9.0, 9.5, 10.0, 11, 12, 13, 14, or 15 microns, inclusive), at an operating temperature of the conductor 100 in a range of 90 degrees Celsius to 250 degrees Celsius, inclusive (e.g., 90, 100, 120, 140, 160, 180, 200, 220, 240, or 250 degrees Celsius, inclusive).

In some embodiments, the outer surface of the encapsulation layer 114 is optionally, at least one of treated or coated with a coating (e.g., the inner coating 116) so as to have a reflectivity of greater than about 50% (e.g., greater than 50%, greater than 60%, greater than 65%, greater than 70%, greater than 75%, greater than 80%, greater than 85%, greater than 90%, or greater than 95%, inclusive) at thermal radiative wavelengths corresponding to an operating temperature of greater than about 90 degrees Celsius. In some embodiments, the outer surface of the encapsulation layer 114 may be surface treated (e.g., plasma treated, texturized, etc.) to have the solar absorptivity as described above.

In some embodiments, the strength member 110, i.e., the outer surface of the encapsulation layer 114 may be optionally coated with the inner coating 116 to reduce solar absorptivity. For example, the inner coating 116 may be disposed between the encapsulation layer 114 and the conductor layer 120. In some embodiments, the inner coating 116 may be formulated to have an absorptivity (e.g., solar absorptivity) of less than 0.6 (e.g., less than 0.6, less than 0.55, less than 0.5, less than 0.45, less than 0.4, less than 0.35, less than 0.3, less than 0.25, less than 0.2, less than 015, or less than 0.1, inclusive) at a wavelength in a range of 2.5 microns to 15 microns, inclusive (e.g., 2.5, 3.0, 3.5, 4.0, 4.5, 5.0, 5.5, 6.0, 6.5, 7.0, 7.5, 8.0, 8.5, 9.0, 9.5, 10.0, 11.0, 12.0, 13.0, 14.0, or 15.0 microns, inclusive), at an operating temperature of the conductor 100 in a range of 90 degrees Celsius to 250 degrees Celsius, inclusive (e.g., 90, 100, 120, 140, 160, 180, 200, 220, 240, or 250 degrees Celsius, inclusive). The inner coating 116 may be configured to reflect a substantial amount of solar radiation in the wavelength of equal to or less than 2.5 microns (e.g., at least 50% of solar radiation in a wavelength of equal to or less than 2.5 microns that is incident on the encapsulation layer 114). In some embodiments, a thickness of the inner coating 116 may be in a range of about 1 micron to about 500 microns, inclusive (e.g., 1, 5, 10, 20, 30, 40, 50, 60, 70, 80, 90, 100, 150, 200, 250, 300, 350, 400, 450, or 500 microns, inclusive).

In some embodiments, the inner coating 116 may have a reflectivity of greater than about 50% (e.g., greater than 50%, greater than 60%, greater than 65%, greater than 70%, greater than 75%, greater than 80%, greater than 85%, greater than 90%, or greater than 95%, inclusive) at thermal radiative wavelengths corresponding to an operating temperature of greater than about 90 degrees Celsius. As previously described, the strength member 110 may include a composite core 112 that may be black in color (e.g., includes a carbon composite). The core 112 may therefore, act as a black body absorbing radiation causing the core 112 to have a higher temperature relative to the conductor layer 120 or otherwise, the encapsulation layer 114. This may further reduce an upper limit of the operating temperature of the conductor 100 by up to 10 degrees Celsius, thus constraining the ampacity of the conductor 100. In contrast, the encapsulation layer 114 having the highly reflective outer surface, and/or the inner coating 116 having low solar absorptivity reflect a substantial portion of the heat emitted by the conductor layer 120 back into the environment. This may facilitate lowering an operating temperature of core 112, therefore protecting the core 112 and allowing the conductor 100 to operate at a higher temperature relative to the core 112 so as to inhibit the temperature of the core 112 from exceeding a threshold temperature (e.g., its glass transition temperature or melting temperature or melting point). In some embodiments, the inner coating 116 may include any inner coating having any suitable structure and function as described in detail in U.S. Pat. No. 11,854,721, filed Dec. 26, 2023, and entitled “Composite Conductors Including Radiative and/or Hard Coatings and Methods of Manufacture,” (the “'721 patent”) the entire disclosure of which is incorporated herein by reference.

The conductor layer 120 is disposed around the strength member 110 and configured to transmit electrical signals therethrough at an operating temperature in a range of 60 degrees to 250 degrees Celsius, inclusive. In some embodiments, the conductor layer 120 may include a plurality of strands of a conductive material disposed around the strength member 110. For example, the conductor layer 120 may include a first set of conductive strands disposed around the strength member 110 in a first wound direction (e.g., wound helically around the strength member 110 in a first rotational direction), a second set of conductive strands disposed around the first set of strands in a second wound direction (e.g., wound helically around the first set of conducive strands in a second rotational direction opposite the first rotational direction), and may also include a third set of strands wound around the second set of strands in the first wound direction, and may further include any number of additional strands as desired.

In some embodiments, the conductor layer 120 (e.g., a plurality of strands of conductive material) may include, for example, aluminum, aluminum alloy, copper or copper alloy including micro alloy as conductive media, etc. In some embodiments, the conductor layer 120 may include conductive strands including Z, C or S wires to keep the outer strands in place. The conductor layer 120 may have any suitable cross-sectional shape, for example, circular, triangular, trapezoidal, etc. In some embodiments, the conductor layer 120 may include a stranded aluminum layer that may be round or trapezoidal. In some embodiments, the conductor layer 120 may include Z shaped aluminum strands. In some embodiments, the conductor layer 120 may include S shaped aluminum strands. In some embodiment, the conductor 100 may include any of the conductors described in U.S. Pat. No. 9,633,766, filed Sep. 23, 2015, and entitled “Energy Efficient Conductors with Reduced Thermal Knee Points and the Method of Manufacture Thereof,” the entire disclosure of which is incorporated herein by reference.

In some embodiments, the strength member 110 may be adequately tensioned while the conductor layer 120 of aluminum or copper or their respective alloys disposed around the strength member 110 may be applied to cause the conductor 100 to form a cohesive conductive hybrid rod that is spoolable onto a conductor reel. In some embodiments, to facilitate conductor spooling onto a reel and conductor spring back at ease, the conductor 100 may be optionally configured to be non-round (e.g., elliptical) such that the shorter axis (in conductor 100) is subjected to bending around a spool (or a sheaves wheel during conductor installation) to facilitate a smaller bend or spool radius, while the strength members 110 may be configured to have a longer axis to facilitate spring back for installation. The overall conductor 100 may be round with non-round strength member 110 or multiple strength members 110 arranged to be non-round, and the spooling bending direction may be along the long axis of the strength member 110 to facilitate spring back while not overly subjecting the conductor layer 120 with additional compressive force from spooling bending.

To further facilitate spooling of the conductor layer 120 on the strength member 110, in some embodiments, the conductor layer 120 may include multiple segments, for example, strands or sets of strands or wires of conductive material (e.g., 2, 3, 4 etc.), and each segment bonded to strength member 110 while retaining compressive stress, and the segments rotates one full rotation or more along the conductor 100 length (equal to one full spool in a reel) to facilitate easy spooling. Thus, the conductor 100 may be configured to have negligible skin effect (i.e., conducting layer thickness is less than the skin depth required at alternating current (AC) circuit frequency), the strength member 110 may be under sufficient residual tensile stress, and the conductor layer 120 (e.g., each of the strands of the conductive material) may be mostly free of tension or under compressive stress. In some embodiments, the strands of the conductive material (e.g., in the conductor layer 120) may be formed from a conforming machine, for example, by extruding hot deformable (e.g., semi solid) conductive material (e.g., aluminum) from a mold. The strands can be molded to be round or trapezoidal. In some embodiments, the extrusion mold or die may have a stranding lay ratio defined therein so that during the stranding operation of the conductive strands, no shaping may be needed (e.g., removing of sharp corners or edges of the conductive strands to avoid corona as is performed in conventional stranding operations). In some embodiments, the conductive media may be extruded out of the mold or die at an angle so as to form conductive strands that wrap around the strength member 110 at an angle, as described herein.

In some embodiments, for AC applications where skin effect is prominent, the conductor layer 120 may include a plurality of layers of conductive strands disposed concentrically around the strength member 110, with each layer being of finite thickness to maximize skin effect for lowest AC resistance at minimal conductor content. In some embodiments, the conductor layer 120 may be optionally stranded to facilitate conductor spooling around a reasonably sized spool and facilitate conductor stringing. In some embodiments, the outermost strands included in the conductor layer 120 may be TW, C, Z, S, or round strands if more aluminum or copper are used, as it will not cause permanent bird caging problem (i.e., the inner strands of the conductor layer 120 may not be deformed such that they prevent the outer strands from proper resettlement after tension is released or reduced). Accordingly, the smooth outer surface and the compact configuration can effectively reduce the wind load and ice accumulation on the conductor 100, resulting in less sag from ice or wind related weather events.

In some embodiments, the conductor 100 may be pre-stressed, for example, by subjecting the conformed conductor 100 to a paired tensioner approach or trimming the pre-tensioned core 112 length before dead-ending, all accomplished without exerting the high tensile stress to the pole arms to pre-tension conventional conductors in the electric poles. For example, the conductor 100 may be subjected to pre-tensioning treatment using sets of bull wheels prior to the first sheave wheel during stringing operation, without exerting additional load to the electric towers. This can, for example, be accomplished by two sets of tensioners, with a first set (i.e., first tensioner) maintaining normal back tension to the conductor drum/reel, while a second set (i.e., second tensioner) restoring the normal stringing tension to avoid excessive load to electric poles or towers, for example, old towers in reconductoring projects.

The conductor 100 may be subjected to the pre-tensioning stress between the first and second tensioners, for example, about 2 times of the average conductor every day tensile load to ensure that the pre-tensioning is driving its knee point below the normal operating temperature so that conductor layer 120 is not in tension for optimal self-damping and the conductor 100 substantially does not change its sag with temperature. In some embodiments, the conductor layer 120 (e.g., each strand of conductive material included in the conductor layer 120) may include aluminum having electrical conductivity of at least 50% ICAS, at least 55% ICAS, at least 60% ICAS, or at least 65% ICAS, or may include copper having electrical conductivity of at least 65% ICAS, at least 75% ICAS, or even at least 95% ICAS.

The conductor 100 may combine pre-tensioning with strength member 110 that may include an encapsulation layer 114 formed of a conductive material of sufficient compressive strength and thickness to substantially preserve the pre-tensioning stress in the strength member 110, while rendering the conductor layer 120 disposed around the strength member 110 mostly tension free or in compression after conductor field installation, and preserving the low thermal expansion characteristics of the strength member 110. The conductor 100 may have an inherently lower thermal knee point. Unlike gap conductors requiring complicated installation tools and process, where the conductor, fitting, installation, and repair are very expensive, the conductor 100 may be easy to install and repair, while maintaining low sag, high capacity, and energy efficiency as a result of knee point shift.

In some embodiments, metallurgical bonding may be provided between the strength member 110 and the conductor layer 120. In some embodiments, adhesives (e.g., CHEMLOK® 250 from Lord Corp) may be applied to the surface of the strength member 110 of the conductor 100 to further promote the adhesion between the strength member 110 and the conductor layer 120 disposed thereon. Additionally, surface features on the strength member 110 may be incorporated to promote interlocking between the conductor layer 120 and the strength member 110 (e.g., stranded strength member 110 such as multi-strand composite cores in C⁷ or steel wires in conventional conductors; pultruded composite core with protruding or depleting surface features; and an intentional rough surface on strength members such as ACCC core from CTC Global where a single or multiple strand glass or basalt or similar and other types of insulating material were disposed around the strength member 110, instead of just longitudinally parallel configuration described herein). In some embodiments, the conductor layer 120 may include aluminum, aluminum alloy, copper and copper alloys, lead, tin, indium tin oxide, silver, gold, nonmetallic materials with conductive particles, any other conductive material, conductive alloy, or conductive composite, or combination thereof.

It should be appreciated that, the conductor layer 120 may be under no substantial tension while the strength member 110 may be pre-stretched/tensioned. After the pre-tension in the strength member 110 is released, the conductor layer 120 may be subjected to compression, which may minimize the shrinking back of the strength member 110. The strength member 110 made with composite materials may have a strength above 80 ksi (i.e., kilopounds per square inch), and a modulus ranging from 5 Mpsi to 40 Mpsi (megapounds per square inch), and a CTE of about 1×10⁻⁶/° C. to about 8×10⁻⁶/° C., inclusive.

The level of pre-tensioning in the conductor 100 may be dependent on conductor size, conductor configuration, conductor application environment, and the desirable target thermal knee point. If the goal is to have a conductor thermal knee point at or near the stringing temperature (e.g., ambient), the tension desired onto the strength member 110 may only be about the same stringing sag tension (e.g., about 10% to about 20%, inclusive, of rated conductor strength), plus about 5% to about 50%, inclusive, of the stringing sag tension level (e.g., about 10% to about 30%, inclusive) extra to keep all aluminum included in the conductor layer 120 (or copper in the case of copper conductors) free of tension after stringing, which is significantly lower compared to conductor pre-tensioning in the electric towers where a load about 40% of conductor tensile strength are commonly used. If lower thermal knee point is desired, higher pre-tensioning stress may be used. It is also important to note that the composite core 112 of the strength member 110 may include carbon fibers that are strong, light weight, and have low thermal sag. The encapsulated strength member 110 using fiber reinforced composite materials may be particularly advantageous where the elastic strength member 110 facilitates spring back of the encapsulated strength member 110 from the reeled configuration for field installation. In some embodiments, the strength member 110 may be pre-strained by at least 0.05% (e.g., at least 0.05%, at least 0.1%, at least 0.15%, at least 0.2%, at least 0.25, or at least 0.3%, inclusive).

In some embodiments, for example, for AC transmission applications, the conductor layer 120 may include concentric layers (e.g., strands) of conductive media disposed around the strength member 110 during a conforming process. The skin depth may be adjusted based on transmission frequency. In some embodiments, the skin depth may be in a range of about 6 mm to about 12 mm, inclusive at 60 Hz (e.g., 6, 7, 8, 9, 10, 11, or 12 mm, inclusive), or in a range of about 12 mm to about 20 mm, inclusive at 25 Hz (e.g., 12, 13, 14, or 15 mm, inclusive) for pure copper. For pure aluminum, the skin depth may be in a range of about 9 mm to about 14 mm, inclusive at 25 Hz (e.g., 9, 10, 11, 12, 13, or 14 mm, inclusive) and in a range of about 14 mm to about 20 mm at 60 Hz (e.g., 14, 15, 16, 17, 18, 19, or 20 mm, inclusive). A thickness of each strand of conductive media included in the conductor layer 120 may be less than the maximum allowable depth, for example, to achieve low resistance, e.g., in AC applications. In some embodiments, each of the conductive strands included in the conductor layer 120 may include copper having a thickness of up to 12 mm (e.g., up to 12, up to 11, up to 10, up to 9, or up to 8 mm, inclusive). In some embodiments, each of the conductive strands included in the conductor layer 120 may include aluminum having a thickness of up to 16 mm (e.g., up to 16, up to 14, up to 13, up to 12, up to 11, or up to 10 mm, inclusive). In some embodiments, a dielectric coating may be interposed between the conductive strands to optimize for the skin effect. In some embodiments, lubricants may be provided between adjacent conductive strands to facilitate some relative motion of the conductive strands included in the conductor layer 120.

In some embodiments, an interface between the strength member 110 and the conductor layer 120 may be further optimized with surface features in the strength member 110 enhancing interfacial locking and/or bonding between the strength member 110 and the conductor layer 120 to retain and preserve the stress from pre-tensioning. Such features may include, but are not limited to, protruded features on an outer surface of the strength member 110 (e.g., and outer surface of the encapsulation layer 114 of the inner coating 116) as well as rotation of the strength member 110 around the axial direction. Furthermore, the same features can be incorporated into the interface between subsequent conductive strands included in the conductor layer 120. In some embodiments, the strength member 110 may include a glass fiber tow disposed around its surface to create a screw shape or twisted surface. In some embodiments, a braided or woven fiber layer is applied in the outer layer of the strength member 110 to promote interlocking or bonding between strength member 110 and the conductor layer 120. Steel wires may be shaped with similar surface features. In some embodiments, the strength member 110 may be pre-tensioned by pre-tensioning the reinforcement fibers in a matrix of conductive media such as aluminum or copper or their respective alloys. Such reinforcement fibers may include ceramic fibers, non-metallic fibers, carbon fibers, glass fibers, and/or others of similar types.

In some embodiments, the insulating layer 122 (e.g., a jacket) may optionally be disposed around the conductor layer 120. The insulating layer 122 may be formed from any suitable electrically insulative material, for example, rubber, plastics, or polymers (e.g., polyethylene, PTFE, high density polyethylene, cross-linked high density polyethylene, etc.). The insulating layer 122 may be configured to electrically isolate or shield the conductor 100. In some embodiments, the insulating layer 122 may be excluded.

In some embodiments, an outer surface of the conductor layer 120 (e.g., outer surface of the outermost conductive strands or an outer surface of each of the conductive strands) or the insulating layer 122 is treated with features and/or include features to cause the outer surface to have a solar absorptivity of less than 0.6 (e.g., less than 0.55, less than 0.5, less than 0.45, less than 0.4, less than 0.35, less than 0.3, less than 0.25, less than 0.2, less than 0.15, or less than 0.1, inclusive). In some embodiments, the outer surface has a solar absorptivity of less than 0.55.

In some embodiments, to reduce the operating temperature of the conductor 100, the conductor 100 may also include the outer coating 130 disposed on the conductor layer 120. The outer coating 130 is formulated to have a solar absorptivity of less than about 0.6 (e.g., less than 0.6, less than 0.55, less than 0.5, 1 less than 0.45, less than 0.40, less than 0.35, less than 0.30, less than 0.25, less than 0.20, less than 0.15, less than 0.1, inclusive or even lower) at a wavelength of less than 2.5 microns, and a radiative emissivity of greater than 0.5 (e.g., greater than 0.50, greater than 0.55, greater than 0.60, greater than 0.65, greater than 0.70, greater than 0.75, greater than 0.80, greater than 0.85, greater than 0.90, greater than 0.95, inclusive, or even higher) at a wavelength in a range of 2.5 microns to 15 microns, inclusive at an operating temperature in a range of 60 degrees C. to 250 degrees Celsius, inclusive. In some embodiments, the outer coating 130 is formulated to have radiative emissivity of greater than about 0.55. For example, the coating 130 may be formulated to have a radiative emissivity of equal to or greater than 0.85 (e.g., 0.85, 0.86, 0.87, 0.88, 0.89, 0.90, 0.91, 0.92, 0.93, 0.94, 0.95, inclusive, or even higher) at a wavelength of about 6 microns, and a solar absorptivity of less than 0.3 (e.g., 0.29, 0.28, 0.27, 0.26, 0.25, 0.24, 0.23, 0.22, 0.21, 0.20, 0.15, 0.10, inclusive, or even lower) at a wavelength of less than 2.5 microns at an operating temperature of about 200 degrees Celsius.

The low solar absorptivity of the outer coating 130 at a wavelength of less than 2.5 microns causes the outer coating 130 to reflect a substantial amount of solar radiation (e.g., greater than 50%, greater than 60%, greater than 70%, greater than 80%, greater than 90%, or even greater than 95% of the incident solar radiation) in the wavelength of less than 2.5 microns, thus reducing solar absorption and inhibiting increase in operating temperature of conductor 100. Moreover, the high radiative emissivity of the outer coating 130 at the wavelength in a range of 2.5 microns to 15 microns causes the outer coating 130 to emit heat being generated by the conductor 100 due to passage of current therethrough as photons, thus increasing radiation of heat away from the conductor 100 into the environment, further reducing the operating temperature of the conductor 100. In some embodiments, the outer coating 130 may cause a reduction in operating temperature of the conductor 100 at a particular current in a range of about 5 degrees Celsius to about 40 degrees Celsius, inclusive (e.g., 5, 6, 7, 8, 9, 10, 12, 14, 16, 18, 20, 25, 30, 35, or 40 degrees Celsius, inclusive). Thus, the conductor 100 can be operated at a lower temperature at the same ampacity. Conversely, the ampacity of the conductor 100 may be increased at the same operating temperature, relative to a conductor that does not include the outer coating 130. In some embodiments, in which a coupler mechanism is crimped to an axial end of the conductor 100, for example, to couple the conductor 100 to another conductor, or a dead-end fitting for coupling the conductor 100 to a transmission pole or tower, etc., the outer coating 130 may also be coated on the such fittings, couplers, or tension hardware, such as for example, dead-end couplers, splice couplers, suspension clamps, or any other suitable fittings or couplers to keep the temperatures of such fittings as low as possible and extend the life thereof.

In some embodiments, an outer surface of at least a portion of the conductive strands forming the conductor layer 120 may be cleaned, for example, using surfactants or solvents to provide a clean surface for depositing the outer coating 130. In some embodiments, the outer surface of the conductor layer 120 (e.g., each of the strands forming the conductor layer 120, the outer most strands, or an outer surface of the outer most strands) or the insulating layer 122 may be roughened by sand blasting to provide a rough surface to facilitate adhesion of the outer coating 130 thereto. In some embodiments, the base coat and/or the outer coating 130 may be hydrophobic, for example, to inhibit ice formation, inhibit fouling, protect against UV radiation, and inhibit water born dirt.

The outer coating 130 may be applied in the form of a paint or slurry using any suitable method, for example, painting, dipping, spraying, evaporation, deposition followed by curing or cross-linking, or shrink wrapping. In some embodiments, the outer surface of the conductor layer 120 (e.g., at least the outer most conductive strands included in the conductor layer 120) may be cleaned, for example, to remove oil, grease, lubricants, dirt etc., that may have deposited on the conductive strands during manufacturing of the conductive strands. The outer surface of the conductive strands of the conductor layer 120 may be cleaned using any suitable method such as, for example, via acid, solvents or using a mechanical means (e.g., sand blasted) to facilitate adhesion of the outer coating 130 to the outer surface of the conductor layer 120. In some embodiments in which the insulating layer 122 is disposed around the conductor layer 120, the outer surface of the insulating layer 122 may be cleaned or texturized (e.g., via sand blasting) before depositing the outer coating 130 thereon. The deposited outer coating 130 may be dried using hot air, infrared or naturally dried.

In some embodiments, the outer coating 130 may provide one or more benefits such as, for example, being transparent, being electrically conductive, having less curing time during coating, having high thermal aging resistance, having reduced dust accumulation, having corrosion resistance, being hydrophobic, having ice accumulation resistance, having weather resistance, having scratch and abrasion resistance, having wear resistance, having flame resistance, having self-healing properties, having reduced surface friction, having better reloadability, having a reduction in conductor pull forces, or any combination thereof. Additionally, the outer coating 130 can impart improvements in conductor lifespan and performance. Hydrophobic properties can mean that a water droplet on a coating can have a contact angle of about 900 or more. In some embodiments, hydrophobic properties can mean that a water droplet on a coating can have a contact angle of about 130 degrees or more. Self-healing can be activated by exposure to one, or more conditions including normal atmospheric conditions, UV conditions, thermal conditions, or electric field conditions.

In some other embodiments, the outer coating 130 may be hydrophilic, that minimizes formation of water droplets as the contact angle is substantially less than 90 degree. Such implementations may be particularly useful for reducing corona, especially for extremely high voltage (EHV) and/or ultrahigh voltage (UHV) applications where the voltage of the circuit can be above 200 kV.

In some embodiments, additionally or alternatively to the radiative and emissive properties described herein, the outer coating 130 may be a “hard coating” configured to have a hardness, cutting resistance, or erosion resistance that is at least 5% greater than a hardness, cutting resistance, or erosion resistance of aluminum or aluminum alloys. In this manner, the outer coating 130 may advantageously protect the conductor layer 120 (e.g., each of a plurality of conductive strands of the conductor layer 120) from erosion, cutting, or otherwise mechanical damage (e.g., from accidental cutting by kite strings). In some embodiments, the outer coating 130 may have an erosion resistance that is at least 5% greater than an erosion resistance of aluminum or aluminum alloys. In some embodiments, the outer coating 130 has a Vicker hardness of greater than 200 MPa. In some embodiments, the outer coating 130 may include any of the outer coatings as described in detail in the '726 application.

The conductor 100 including the optical fiber assembly 150 described herein are particularly suitable as underground conductors. The embedded optical fiber assembly 150 is shielded and protected by the core 112 for life, which protects the optical fiber assembly 150 from moisture damage and stress corrosion. Thus, the conductor 100 and the other conductors described herein are capable of distributed monitoring of conductor temperature, conductor strain, conductor discharge, earth movement at or near the underground conductor, as well as damage to the conductor 100. This is particularly beneficial for underground conductors where visual determination of faults is not possible until the conductors are dug up from the ground. Remote sensing provided by the optical fiber assembly 150 of the conductor 100 can allow determination of not only the fault sites with sufficient accuracy to allow repair teams to locate and perform maintenance on targeted locations reducing maintenance costs, the conductor 100 also allows prediction of ground movement and temperature. Thus, the conductor 100 may be used as sensors to detect earthquakes and wildfires, and locations thereof. Moreover, the conductor 100 including the optical fiber assembly 150 may also be used for vibration monitoring and can serve to detect and/or predict earthquakes.

The conductor 100 may improve sensing by providing more precise location identification of faults, for example, with a spatial resolution of equal to or less than about 25 cm, which is significantly better than conventional conductors. In some embodiments, the conductor 100 may provide a spatial resolution of about 25 cm. In some embodiments, the conductor 100 may provide a spatial resolution of equal to or less than about 15 cm. In some embodiments, the conductor 100 may provide a spatial resolution of equal to or less than about 12.5 cm. In some embodiments, the conductor 100 may provide a spatial resolution of equal to or less than about 11.0 cm. In some embodiments, the conductor 100 may provide a spatial resolution of equal to or less than about 10 cm. In some embodiments, the conductor 100 may provide a spatial resolution of equal to or less than about 9 cm. In some embodiments, the conductor 100 may provide a spatial resolution of equal to or less than about 8 cm. In some embodiments, the conductor 100 may provide a spatial resolution of equal to or less than about 7 cm. In some embodiments, the conductor 100 may provide a spatial resolution of equal to or less than about 6 cm. In some embodiments, the conductor 100 may provide a spatial resolution of equal to or less than about 5 cm. Such a high spatial resolution can enable fault location precise enough to minimize maintenance and repair activity and shortage outage time for repairs. Embedding the optical fiber assembly 150 in the core 112 of the conductor 100, which itself is encapsulated by the encapsulating layer 114, enhances optical fiber assembly 150 connectivity and/or life by inhibiting moisture ingress facilitating lifetime distributed sensing even in situations where the conductor 100 is compromised.

The conductor 100 (or any of the conductors described herein) allow for the optical fiber assembly 150 embedded therewithin to be spliced with optical fiber assemblies of other conductors with minimum crosstalk for connectivity. The conductor 100 can enable detection of wide range of data points, for example, along the entire length of the one or more conductor 100 included in underground transmission systems, thereby enhancing understanding of conductor 100 health and transient faults. Thus, the conductor 100 can enable precise fault location (e.g., using optical time domain reflectometry). Moreover, the conductor 100 can be capable of distributed sensing for temperature, strain, vibrations, and/or acoustic signals in the cable. In some implementations, the conductor 100 has temperature sensing resolution of at least about 0.01 degrees Celsius, and a strain resolution of at least about 1 micron. In some embodiments, the conductor 100 may provide a dynamic acoustic sensing range of at least about 120 dB, thus facilitating comprehensive data capture of the health or condition of the conductor 100 and the surroundings.

FIG. 1D is a front-cross section view of the optical fiber assembly 150 showing one or more cladding layers that may be included in the optical fiber assembly 150, according to an embodiment. In some embodiments, the fiber core 152 may include a central core 151 and a first cladding layer 153a disposed around the central core 151. In some embodiments, the central core 151 has a first refractive index, and the first cladding layer 153a disposed around the central core has a second refractive index lower than the first refractive index to confine light transmitted through the central core 151. The optical fiber assembly 150 further includes a second cladding layer 153b disposed around the first cladding layer 153a. In some embodiments, the second cladding layer 153b may have a refractive index that is different than the second refractive index of the first cladding layer 153a. In some embodiments, the optical fiber assembly 150 includes the fiber encapsulation layer 154 that is disposed around the second cladding layer 153b. In some embodiments, the fiber encapsulation layer 154 may include the outer moisture exclusion layer 159.

While FIG. 1B and FIG. 1D show the optical fiber assembly 150 as including a plurality of layers, this is for illustrative purposes only and one or more of the layers included in the optical fiber assembly 150 may be optional, may be arranged or disposed in any suitable arrangement, or the optical fiber assembly 150 may include additional layers not shown in FIG. 1B and as described herein. All such embodiments are envisioned and should be considered to be within the scope of the present application.

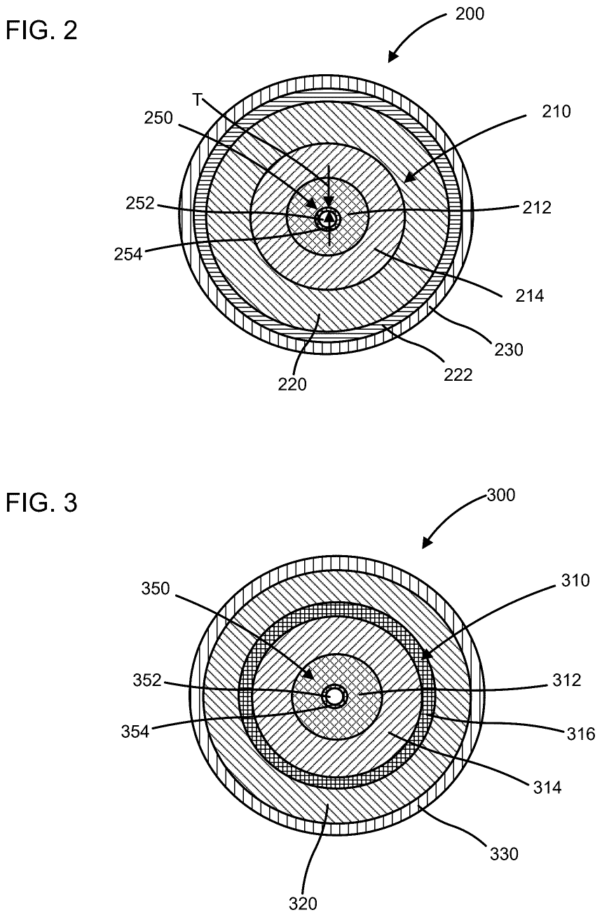

FIG. 2 is a side cross-section view of a conductor 200, according to an embodiment. The conductor 200 includes a strength member 210 including a core 212, an encapsulation layer 214 disposed around the core 212, and an optical fiber assembly 250 disposed in the core 212. The conductor 200 also includes a conductor layer 220, an outer coating 230, and may, optionally, also include an insulating layer 222 disposed between the conductor layer 220 and the outer coating 230. The conductor 200 may be used in grid transmission applications to conduct electricity.

The strength member 210 includes the core 212 and the encapsulation layer 214 disposed circumferentially around the core 212. The core 212 may be formed from a composite material. Accordingly, in some embodiments, the core 212 may also be referred to herein as “composite core 212”. In some embodiments, the composite material may include nonmetallic fiber reinforced metal matrix composite, carbon fiber reinforced composite of either thermoplastic or thermoset matrix, or composites reinforced with other types of fibers such as quartz, AR-Glass, E-Glass, S-Glass, H-Glass, silicon carbide, silicon nitride, alumina, basalt fibers, especially formulated silica fibers, any other suitable composite material, or any combination thereof. In some embodiments, the composite material may include a carbon fiber reinforced composite of a thermoplastic or thermoset resin. The reinforcement in the strength member 210 (e.g., in the composite material of the core 212) can be discontinuous such as whiskers or chopped fibers; or continuous fibers in substantially aligned configurations (e.g., parallel to axial direction) or randomly dispersed (including helically wind or woven configurations). In some embodiments, the composite material may include a continuous or discontinuous polymeric matrix composites reinforced by carbon fibers, glass fibers, quartz, or other reinforcement materials, and may further include fillers or additives (e.g., nanoadditives). In some embodiments, the core 212 may include a carbon composite including a polymeric matrix of epoxy resin cured with anhydride hardeners. In some embodiments, the core 212 may be include any material as described with respect to the core 112, and formed using any suitable mechanism or method as described with respect to the core 112.

As shown in FIG. 2, the core 212 has a substantially circular cross-section, but may have any other suitable shape, as described with respect to the core 112. In some embodiments, the core 212 may have a diameter in a range of about 5 mm to about 15 mm, inclusive (e.g., 5, 6, 7, 8, 9, 10, 11, 12, 13, 14, or 15 mm, inclusive). In some embodiments, the core 212 may have a glass transition temperature or melting temperature or melting point of at least about 100 degrees Celsius (e.g., at least 100, at least 120, at least 140, at least 150, at least 160, at least 180, at least 200, at least 220, at least 240, at least 260, at least 280, or at least 300, degrees Celsius, inclusive), as previously described with respect to the core 112. In some embodiments, the core 212 may include any core as described in detail with respect to the core 112.

The encapsulation layer 214 is disposed circumferentially around the core 212. The encapsulation layer 214 may be formed from any suitable electrically conductive or non-conductive material. In some embodiments, the encapsulation layer 214 may be formed from a conductive material including, but not limited to aluminum (e.g., 1350-H19), annealed aluminum (e.g., 1350-0), aluminum alloys (e.g., Al—Zr alloys, 6000 series Al alloys such 6201-TSl, -T82, -T83, 7000 series Al alloys, 8000 series Al alloys, etc.), copper, copper alloys (e.g., copper magnesium alloys, copper tin alloys, copper micro-alloys, etc.), any other suitable conductive material, or any combination thereof, as described with respect to the encapsulation layer 114. In some embodiments, the encapsulation layer 114 may be formed from a non-conductive material, e.g., polymers, carbon fiber, glass fiber, ceramics, silicone, rubber, polyurethane, any other suitable non-conductive material, or a combination thereof.

The encapsulation layer 214 may be disposed on the core 212 using any suitable process. In some embodiments, the encapsulation process for disposing the encapsulation layer 214 around the core 212 includes using a conforming machine or stranding machine, or any other suitable process as described with respect to the encapsulation layer 114. While FIG. 2 shows a single encapsulation layer 214 disposed around the core 212, in some embodiments, multiple encapsulation layers 214 may be disposed around the core 212. In such embodiments, each of the multiple encapsulation layers 214 may be substantially similar to each other, or may be different from each other (e.g., formed from different materials, have different thicknesses, have different tensile strengths, etc.).

In some embodiments, an interface between the core 212 and the encapsulation layer 214 may include surface features, for example, grooves, slots, notches, indents, detents, etc. to enhance adhesion, bonding and/or interfacial locking between a radially outer surface of the core 212 and a radially inner surface of the encapsulation layer 214. Such surface features may facilitate retention and preservation of the stress from pre-tensioning in the encapsulation layer 214. In some embodiments, the composite core 212 may have a glass fiber tow disposed around its outer surface to create a screw shape or twisted surface. In some embodiments, a braided or woven fiber layer is applied in the outer layer of the core 212 to promote interlocking or bonding between the core 212 and the encapsulation layer 214.

In some embodiments, the encapsulation layer 214 may have a thickness in a range of about 0.25 mm to about 5 mm, inclusive, or even higher (e.g., 0.25, 0.3, 0.5, 1, 1.5, 2.0, 2.5, 3.0, 3.5, 4.0, 4.5, 5.0 mm, inclusive, or even higher). In some embodiments, a ratio of an outer diameter of the encapsulation layer 214 to an outer diameter of the core 212 is in range of about 1.2:1 to about 5:1, inclusive (e.g., 1.2:1, 1.5:1, 2:1, 2.5:1, 3:1, 3.5:1, 4:1, 4.5:1, or 5:1, inclusive).

In some embodiment, the strength member 210 may have a minimum level of tensile strength, for example, at least 600 MPa (e.g., at least 600, at least 700, at least 800, at least 1,000, at least 1,200, at least 1,400, at least 1,600, at least 1,800, or at least 2,000 MPa, inclusive). In some embodiments, the elongation during pre-tension of the strength member 210 may include elongation by at least 0.005% strain (e.g., at least 0.005%, at least 0.01%, at least 0.1%, at least 0.2%, at least 0.25%, at least 0.3%, at least 0.35%, at least 0.4%, at least 0.45%, or at least 0.5% strain, inclusive) depending on the type of strength members and the degree of knee point reduction, and the strength member 210 may be pre-tensioned before or after entering the conforming machine. Moreover, the strength member 210 may be configured to endure radial compression from crimping of conventional fittings as well as radial pressure during conforming of drawing down process or folding and molding of at least 3 kN (e.g., at least 3 kN, at least 4 kN, at least 5 kN, at least 10 kN, at least 15 kN, at least 20 kN, or at least 25 kN, inclusive).

In some embodiments, the encapsulation layer 214 may have an outer surface that is smooth and shiny so as to maximize refractivity and reduce absorptivity (i.e., enhance reflectivity) for reducing an operating temperature of the core 212 and preventing the temperature of the core from exceeding its glass transition temperature or melting temperature. In some embodiments, the conductor 200 may include the outer coating 230 that is formulated to have a high radiative emissivity in the 2.5 microns to 15 microns wavelength, inclusive, of the solar radiation. While this may cause cooling of the conductor layer 220, the radiated heat will also travel towards the strength member 210 and cause heating of the core 212, for example, cause the core 212 to be at a higher operating temperature than the conductor layer 220, which is undesirable. In some embodiments in which there is no stranded layer of conductive materials around the encapsulation layer 214, the outer surface of the encapsulation layer 214 (e.g., an inner coating 216 disposed thereon) may be configured for high radiative emissivity to remove heat from conductor 200 through thermal radiation.

The conductor layer 220 is disposed around the strength member 210 and configured to transmit electrical signals therethrough at an operating temperature in a range of about 60 degrees to about 250 degrees Celsius, inclusive. In some embodiments, the conductor layer 220 may include a plurality of strands of a conductive material disposed around the strength member 210, as described with respect to the conductor layer 120. In some embodiments, the conductor layer 220 (e.g., a plurality of strands of conductive material) may include, for example, aluminum, aluminum alloy, copper or copper alloy including micro alloy as conductive media, etc. In some embodiments, the conductor layer 220 may include conductive strands including Z, C, or S wires to keep the outer strands in place. The conductor layer 220 may have any suitable cross-sectional shape, for example, circular, triangular, trapezoidal, etc. In some embodiments, the conductor layer 220 may include stranded aluminum layer that may be round or trapezoidal. In some embodiments, the conductor layer 220 may include Z shaped aluminum strands. In some embodiments, the conductor layer 220 may include S shaped aluminum strands. In various embodiments, the conductor layer 220 may be formed from any suitable material, as described with respect to the conductor layer 120.

In some embodiments, the strands of the conductive material of the conductor layer 220 may be formed using a conforming machine, for example, by extruding hot, deformable (e.g., semi solid) conductive material (e.g., aluminum) from a mold. The strands can be molded to be round or trapezoidal. In some embodiments, the conductive media may be extruded out of the mold or die at an angle so as to form conductive strands that wrap around the strength member 210 at an angle, as described herein. In some embodiments, the conductor layer 220 may include a plurality of layers of conductive strands disposed concentrically around the strength member 210. In some embodiments, the conductor layer 220 may be optionally stranded to facilitate conductor spooling around a reasonably sized spool and facilitate conductor stringing. In some embodiments, the outermost strands included in the conductor layer 220 may be TW, C, Z, S, or round strands, as previously described.

In some embodiments, the conductor 200 may be pre-stressed, as previously described with respect to the conductor 100. In some embodiments, the conductor layer 220 (e.g., each strand of conductive material included in the conductor layer 220) may include aluminum having electrical conductivity of at least 50% ICAS, at least 55% ICAS, at least 60% ICAS, or at least 65% ICAS, or may include copper having electrical conductivity of at least 65% ICAS, at least 75% ICAS, or even at least 95% ICAS. In some embodiments, metallurgical bonding may be provided between the strength member 210 and the conductor layer 220, for example, via an adhesive. In some embodiments, the conductor layer 220 may include aluminum, aluminum alloy, copper and copper alloys, lead, tin, indium tin oxide, silver, gold, nonmetallic materials with conductive particles, any other conductive material, conductive alloy, or conductive composite, or combination thereof. In some embodiments, a skin depth of the conductive strands included in the conductor layer 220 may be in a range of 6 mm to about 12 mm, inclusive at 60 Hz (e.g., 6, 7, 8, 9, 10, 11, or 12 mm, inclusive), or in a range of about 12 mm to about 20 mm, inclusive at 25 Hz (e.g., 12, 13, 14, or 15 mm, inclusive) for pure copper. For pure aluminum, the skin depth may be in a range of about 9 mm to about 14 mm, inclusive at 25 Hz (e.g., 9, 10, 11, 12, 13, or 14 mm, inclusive) and in a range of about 14 mm to about 20 mm at 60 Hz (e.g., 14, 15, 16, 17, 18, 19, or 20 mm, inclusive). In some embodiments, each of the conductive strands included in the conductor layer 220 may include copper having a thickness of up to 12 mm (e.g., up to 12, up to 11, up to 10, up to 9, or up to 8 mm, inclusive). In some embodiments, each of the conductive strands included in the conductor layer 220 may include aluminum having a thickness of up to 16 mm (e.g., up to 16, up to 14, up to 13, up to 12, up to 11, or up to 10 mm, inclusive). In some embodiments, a dielectric coating may be interposed between the conductive strands to optimize for the skin effect. In some embodiments, lubricants may be provided between adjacent conductive strands to facilitate some relative motion of the conductive strands included in the conductor layer 220.

In some embodiments, the insulating layer 222 (e.g., an outer jacket) may be disposed around the conductor layer 220, as shown in FIG. 2. The insulating layer 222 may be formed from any suitable electrically insulative material, for example, rubber, plastics, or polymers (e.g., polyethylene, high density polyethylene, cross-linked high density polyethylene, PTFE, etc.). The insulating layer 222 may be configured to electrically isolate or shield the conductor 200. In some embodiments, the insulating layer 222 may be excluded.

The outer coating 230 is disposed on an outer surface of the conductor layer 220, for example, around individual strands that form the conductor layer 220, or only on outer surface of the outer most conductive strands of the conductor layer 220, or on an outer surface of the insulating layer 222 as shown. The outer coating 230 may be formulated to have a solar absorptivity of less than 0.5 (e.g., 0.49, 0.45, 0.40, 0.35, 0.30, 0.25, 0.20, 0.15, 0.1, inclusive or even lower) at a wavelength of less than 2.5 microns, and a radiative emissivity of greater than 0.5 (e.g., 0.51, 0.55, 0.60, 0.65, 0.70, 0.75, 0.80, 0.85, 0.90, 0.95, inclusive, or even higher) at a wavelength in a range of 2.5 microns to 15 microns, inclusive at an operating temperature in a range of 60 degrees C. to 250 degrees Celsius, inclusive. For example, the outer coating 230 may be formulated to have a radiative emissivity of equal to or greater than 0.85 (e.g., 0.85, 0.86, 0.87, 0.88, 0.89, 0.90, 0.91, 0.92, 0.93, 0.94, 0.95, inclusive, or even higher) at a wavelength of about 6 microns, and a solar absorptivity of less than 0.3 (e.g., 0.29, 0.28, 0.27, 0.26, 0.25, 0.24, 0.23, 0.22, 0.21, 0.20, 0.15, 0.10, inclusive, or even lower) at a wavelength of less than 2.5 microns at an operating temperature of about 200 degrees Celsius.

In some embodiments, additionally or alternatively to the radiative and emissive properties described herein, the outer coating 230 may be a hard coating configured to have a hardness, cutting resistance, or erosion resistance that is at least 5% greater than a hardness, cutting resistance, or erosion resistance of aluminum or aluminum alloys. In this manner, the outer coating 230 may advantageously protect the conductor layer 220 (e.g., each of a plurality of conductive strands of the conductor layer 220) from erosion, cutting, or otherwise mechanical damage (e.g., from accidental cutting by kite strings). In some embodiments, the outer coating 230 may have an erosion resistance that is at least 5% greater than an erosion resistance of aluminum or aluminum alloys. In some embodiments, the outer coating 230 has a Vicker hardness of greater than 200 MPa. In some embodiments, the outer coating 230 may be substantially similar to the outer coating 130 described with respect to FIG. 1A-1B or any outer coating described in detail in the '726 application.

The optical fiber assembly 250 is disposed in the core 212 and includes a fiber core 252 and a fiber encapsulation layer 254 disposed around the fiber core 252. The fiber encapsulation layer 254 may have a second glass transition temperature or melting temperature that is greater than a first glass transition temperature or melting temperature of the core 252, or processing temperature of the strength member 210, as previously described herein. For example, the first glass transition temperature or melting temperature of the core 252 may be in a range of about 600 degrees Celsius to about 350 degrees Celsius, inclusive, and the second glass transition temperature or melting temperature may be in a range of about 80 degrees Celsius to about 450 degrees Celsius, inclusive. The fiber core 252 and the fiber encapsulation layer 254 may be substantially similar to the fiber core 152 and the fiber encapsulation layer 154, previously described in detail herein. In some embodiments, the fiber encapsulation layer 154 may include an outer moisture exclusion layer, or optical fiber assembly 250 may be disposed within an outer moisture exclusion layer, for example, the outer moisture exclusion layer 159, as previously described herein.

In some embodiments, the composite core 212 may have a first color and the fiber encapsulation layer 254 may have a second color different from the first color. For example, to allow the user to easily differentiate the optical fiber assembly 250 from the composite material, the second color of the fiber encapsulation layer 254 may have a high contrast relative to the core 212. For example, the fiber encapsulation layer 254 may have a bright color such as, for example, white, bright pink, bright green, bright orange, bright blue, or any other suitable color that has substantial contrast with the color of the core 212. In some embodiments, the fiber encapsulation layer 254 may include a fluorescent material or include a fluorescent dye (e.g., nanoparticles, quantum dots, Eosin yellow, luminol, fluorescein, coumarin, cyanine, rhodamine, acridine orange, malachite green, zinc sulfide, any other suitable fluorescent material, or a combination thereof), that may allow a user to visually differentiate the optical fiber assembly 250 from the core 212 (e.g., by shining a suitable excitation light on the core 212 so as to cause the fiber encapsulation layer 254 to fluoresce). In some embodiments, the fiber encapsulation layer 254 may include a phosphorescent material (e.g., phosphorous).

In some embodiments, the fiber encapsulation layer 254 may have a thickness T in a range of about 0.125 mm to about 0.5 mm, inclusive (e.g., 0.125, 0.15, 0.15, 0.1, 0.15, 0.2, 0.25, 0.3, 0.35, 0.4, 0.45, or 0.5 mm, inclusive). In some embodiments, the thickness T of the fiber encapsulation layer 254 and/or the thickness thereof may be sufficient to withstand the extrusion or pultrusion process used to form the fiber core 252 or otherwise, the strength member 210. As shown in FIG. 2, the optical fiber assembly 250 is axially aligned with a central axis (or longitudinal axis) of the core 212, for example, to reduce micro-bending stresses on the optical fiber assembly 250. In some embodiments, the optical fiber assembly 250 may include one or more sensing elements, for example, FBGs as described with respect to the optical fiber assembly 150 and configured to sense one or more operating parameters of the conductor 200, for example, temperature, sag, etc., as described in detail herein.

FIG. 3 is a side cross-section view of a conductor 300, according to an embodiment. The conductor 300 is similar to the conductor 200, for example, the conductor 300 includes a strength member 310 including a core 312 and an encapsulation layer 314, and an optical fiber assembly 350, that may be substantially similar to the core 112, 212, the encapsulation layer 114, 214, and the optical fiber assembly 150, 250, respectively, as described, and therefore not described in further detail herein. The conductor 300 also includes a conductor layer 320 disposed around strength member 310, and having an outer coating 330 disposed around the conductor layer 320. The conductor layer 320 and the outer coating 330, may be substantially similar to the conductor layer 120, 220 and the outer coating 130, 230, previously described, and therefore not described in further detail herein. While not shown, in some embodiments, an insulating layer (e.g., the insulating layer 222) may be interposed between the outer coating 330 and the conductor layer 320, as previously described.

Different from the conductor 200, the conductor 300 also includes an inner coating 316 disposed on an outer surface of the encapsulation layer 314, for example, interposed between the encapsulation layer 314 and the conductor layer 320. In some embodiments, the inner coating 316 may be formulated to have a solar absorptivity of less than 0.5 (e.g., less than 0.5, less than 0.4, less than 0.3, less than 0.2, or less than 0.1) at a wavelength in a range of 2.5 microns to 15 microns, inclusive (e.g., 2.5, 3.0, 3.5, 4.0, 4.5, 5.0, 5.5, 6.0, 6.5, 7.0, 7.5, 8.0, 8.5, 9.0, 9.5, 10.0, 11.0, 12.0, 13.0, 14.0, or 15.0 microns, inclusive), at an operating temperature of the conductor 300 in a range of 90 degrees Celsius to 250 degrees Celsius, inclusive (e.g., 90, 100, 120, 140, 160, 180, 200, 220, 240, or 250 degrees Celsius, inclusive). Thus, the inner coating 316 may be configured to reflect a substantial amount of solar radiation in the wavelength of equal to or less than 2.5 microns (e.g., at least 50% of solar radiation in a wavelength of equal to or less than 2.5 microns that is incident on the encapsulation layer 314). In some embodiments, a thickness of the inner coating 316 may be in a range of 1 micron to 500 microns, inclusive (e.g., 1, 5, 10, 20, 30, 40, 50, 60, 70, 80, 90, 100, 150, 200, 250, 300, 350, 400, 450, or 500 microns, inclusive). Coating on core surface or on the encapsulation layer 314 surface might be thermally non-conductive or have poor thermal conductivity, for example, include ceramics, to minimize conductive heat transfer between the passively heated composite core 312 and the conductive encapsulation layer 314 metal with resistance heating. In some embodiments, a thickness of the inner coating 316 may be in a range of 50 microns to 300 microns, inclusive (e.g., 50, 100, 150, 200, 250, or 300 microns, inclusive). In some embodiments, a ratio of a thickness of the outer coating 330 to the thickness of the inner coating 316 may be in a range of about 1:1 to about 10:1, inclusive (e.g., 1:1, 2:1, 3:1, 4:1, 5:1, 6:1, 7:1, 8:1, 9:1, or 10:1, inclusive). The inner coating 316 may be substantially similar to the inner coating 116 or may include any inner coating described in the '726 application.

The optical fiber assembly 350 includes a fiber core 352 and a fiber encapsulation layer 354. In some embodiments, the thickness T of the fiber encapsulation layer 354 and/or the thickness thereof may be sufficient to withstand the extrusion or pultrusion process used to form the fiber core 352 or otherwise, the strength member 310. Similar to the strength member 210 of FIG. 2, the optical fiber assembly 350 is axially aligned with a central axis (or longitudinal axis) of the core 312, for example, to reduce micro-bending stresses on the optical fiber assembly 350.

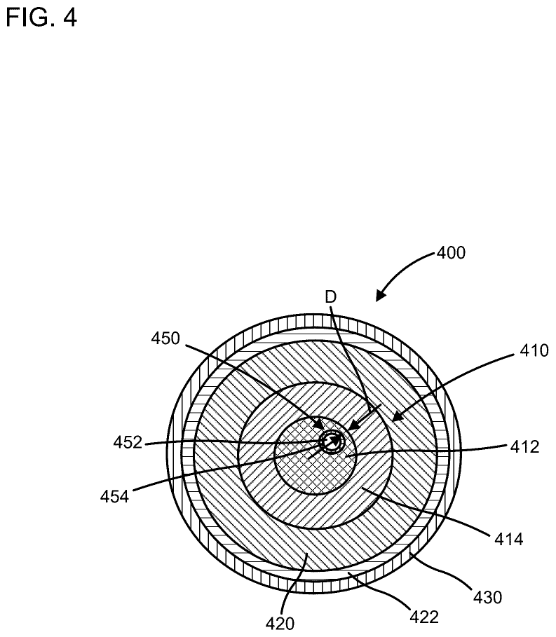

FIG. 4 is a side cross-section view of a conductor 400, according to an embodiment. The conductor 400 is similar to the conductor 200, for example, the conductor 400 includes a strength member 410 including a core 412, an encapsulation layer 414, and an optical fiber assembly 450, that may be substantially similar to the core 112, 212, the encapsulation layer 114, 214, and the optical fiber assembly 150, 250, respectively, as previously described herein. The conductor 400 also includes a conductor layer 420 disposed around strength member 410, and having an outer coating 430 disposed around the conductor layer 340. The conductor layer 420 and the outer coating 430, may be substantially similar to the conductor layer 120, 220 and the outer coating 130, 230, previously described, and therefore not described in further detail herein. In some embodiments, an insulating layer 422 (e.g., the insulating layer 222) may be interposed between the outer coating 430 and the conductor layer 420, as previously described. While not shown, in some embodiments, an inner coating (e.g., the inner coating 116, 316) may optionally be disposed around the encapsulation layer 414 or otherwise interposed between the strength member 410 and the conductor layer 420, as previously described herein.

Different from the conductor 200 and 300, the optical fiber assembly 450 is disposed proximate to a radially outer edge of the core 412 such that the optical fiber assembly 450 is radially offset from the central axis (or longitudinal axis) of the core 412. In some embodiments, a shortest radial distance D from an outer edge of optical fiber assembly 450 to a radial outer edge of the core 412 may be in a range of about 0.1 mm to about 3 mm, inclusive (e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.2, 2.4, 2.6, 2.8, or 3.0 mm, inclusive).

In some embodiments, the shortest radial distance may be at least 0.1 mm. In some embodiments, the shortest radial distance may be at least 0.2 mm. In some embodiments, the shortest radial distance may be at least 0.3 mm. In some embodiments, the shortest radial distance may be at least 0.4 mm. In some embodiments, the shortest radial distance may be at least 0.5 mm. In some embodiments, the shortest radial distance may be at least 0.6 mm. In some embodiments, the shortest radial distance may be at least 0.7 mm. In some embodiments, the shortest radial distance may be at least 0.8 mm. In some embodiments, the shortest radial distance may be at least 0.9 mm. In some embodiments, the shortest radial distance may be at least 1.0 mm. In some embodiments, the shortest radial distance may be at least 1.2 mm. In some embodiments, the shortest radial distance may be at least 1.4 mm. In some embodiments, the shortest radial distance may be at least 1.6 mm. In some embodiments, the shortest radial distance may be at least 1.8 mm. In some embodiments, the shortest radial distance may be at least 2.0 mm. In some embodiments, the shortest radial distance may be at least 2.2 mm. In some embodiments, the shortest radial distance may be at least 2.4 mm. In some embodiments, the shortest radial distance may be at least 2.6 mm. In some embodiments, the shortest radial distance may be at least 2.8 mm. In some embodiments, the shortest radial distance may be at least 3.0 mm.

In some embodiments, the shortest radial distance may be at most 3 mm. In some embodiments, the shortest radial distance may be at most 2.8 mm. In some embodiments, the shortest radial distance may be at most 2.6 mm. In some embodiments, the shortest radial distance may be at most 2.4 mm. In some embodiments, the shortest radial distance may be at most 2.2 mm. In some embodiments, the shortest radial distance may be at most 2.0 mm. In some embodiments, the shortest radial distance may be at most 1.9 mm. In some embodiments, the shortest radial distance may be at most 1.8 mm. In some embodiments, the shortest radial distance may be at most 1.7 mm. In some embodiments, the shortest radial distance may be at most 1.6 mm. In some embodiments, the shortest radial distance may be at most 1.5 mm. In some embodiments, the shortest radial distance may be at most 1.4 mm. In some embodiments, the shortest radial distance may be at most 1.3 mm. In some embodiments, the shortest radial distance may be at most 1.2 mm. In some embodiments, the shortest radial distance may be at most 1.1 mm. In some embodiments, the shortest radial distance may be at most 1.0 mm. Positioning the optical fiber assembly 450 proximate to the radially outer edge of the core 412 may make it easier and/or faster for a user to access the optical fiber assembly 450 by removing or peeling only a portion of the core 412, thereby reducing installation, or repair time and cost.

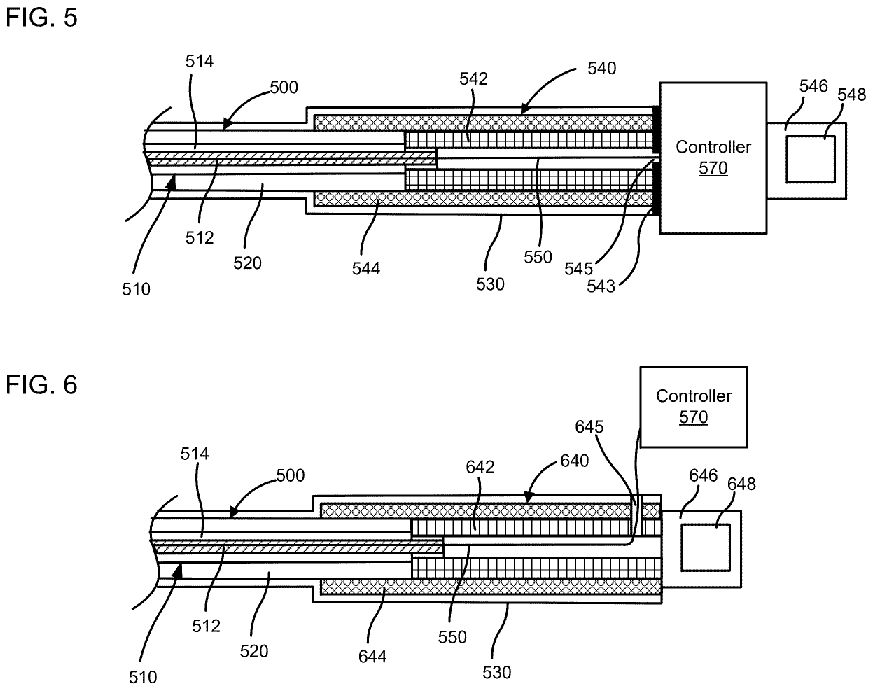

FIG. 5 is a side cross-section view of a coupler or a fitting 540 coupled (e.g., crimped) to an axial end of a conductor 500. The conductor 500 includes a strength member 510 and a conductor layer 520 disposed on the strength member 510. The strength member 510 includes a core 512 having an encapsulation layer 514 disposed therearound. An optical fiber assembly 550 is disposed in the core 512. The optical fiber assembly 550 includes a fiber core (not shown) and a fiber encapsulation layer (not shown) substantially similar to the fiber core 152, 252, 352, 452 and the fiber encapsulation layer 154, 254, 354, 454, described above with respect to the optical fiber assembly 150, 250, 350, or 450. The core 512, the encapsulation layer 514, the optical fiber assembly 550, and the conductor layer 520 may be substantially similar to the core 112, 212, 312, or 412, the encapsulation layer 114, 214, 314, or 414, the optical fiber assembly 150, 250, 350, or 450, and the conductor layer 120, 220, 320, 420, respectively, and therefore, not described in further detail herein.

The coupler or fitting 540 includes a body 542 (e.g., a cylindrical body) and defining an internal volume configured to receive a portion of an axial end of the strength member 510 and/or the conductor 500. For example, a predetermined length of the conductor layer 520 of the conductor 500 may be removed (e.g., a portion having a length in a range of about 150 mm to about 350 mm, inclusive, from the axial end of the conductor 500). The cross-sectional width of the inner volume of the body 542 may be greater than the outer cross-sectional width of the strength member 510 to allow insertion of the axial end of the strength member 510 into the body 542. The cross-sectional width of the inner volume of the body 542 may be then reduced, for example, by crimping to cause the inserted portion of the body 540 to be crimped or otherwise secured to the strength member 510. A sleeve 544 may be disposed around the body 542 (e.g., circumferentially around the body 542) and configured to contact the conductor layer 520 so as to electrically couple the coupler 540 to the conductor layer 520, and also to be physically coupled to the conductor layer 520, for example, via crimping. The coupler 540 may also include a connecting portion 546 defining a keyhole 548. The connecting portion 546 may be configured to be coupled to corresponding hooks or connectors located on poles (e.g., tension towers) from which the conductor 500 may be suspended.

As previously described, the composite material from which the core 512 is formed may be susceptible to crush force damage. However, the encapsulation layer 514 disposed around the core 512 also serves as a protection layer to protect the core 512 from the compressing force exerted during crimping of the body 542 around the strength member 510. This advantageously allows conventional crimp fittings or couplers to be used with the conductor 500, providing installation ease and flexibility, and reducing cost. While FIG. 5 depicts a particular configuration of a fitting or coupler 540 it should be appreciated that any crimp coupler can be used with the conductor 500 or any other conductor described herein, including those for coupling one conductor to another.

In some embodiments, the conductor 500 may be coated with a coating 530. Moreover, the coating 530 is also coated on at least a portion of the fitting or coupler 540. The coating 530 may be formulated to have a solar absorptivity of less than 0.5 (e.g., 0.49, 0.45, 0.40, 0.35, 0.30, 0.25, 0.20, 0.15, 0.1, inclusive or even lower) at a wavelength of less than 2.5 microns, and a radiative emissivity of greater than 0.5 (e.g., 0.51, 0.55, 0.60, 0.65, 0.70, 0.75, 0.80, 0.85, 0.90, 0.95, inclusive, or even higher) at a wavelength in a range of 2.5 microns to 15 microns, inclusive at an operating temperature in a range of 60 degrees Celsius to 250 degrees Celsius, inclusive. For example, the coating 530 may be formulated to have a radiative emissivity of equal to or greater than 0.85 (e.g., 0.85, 0.86, 0.87, 0.88, 0.89, 0.90, 0.91, 0.92, 0.93, 0.94, 0.95, inclusive, or even higher) at a wavelength of about 6 microns, and a solar absorptivity of less than 0.3 (e.g., 0.29, 0.28, 0.27, 0.26, 0.25, 0.24, 0.23, 0.22, 0.21, 0.20, 0.15, 0.10, inclusive, or even lower) at a wavelength of less than 2.5 microns at an operating temperature of about 200 degrees Celsius. In some embodiments, the coating 530 may cause a reduction in operating temperature of the conductor 500 as well as the fitting or coupler at a particular current in a range of about 5 degrees Celsius to about 40 degrees Celsius, inclusive (e.g., 5, 6, 7, 8, 9, 10, 12, 14, 16, 18, 20, 25, 30, 35, or 40 degrees Celsius, inclusive), as described herein. The coating 530 may include the outer coating 130, 230, 330, 430, 530 or any other coating described herein.

As shown in FIG. 5, a portion of the optical fiber assembly 550 extends axially outwards of the core 512 of the strength member 510 into the internal volume defined by the body 542 of the body of the coupler. As previously described, the optical fiber assembly 550 carries, communicates, or transmits signals that may be indicative of one or more operating parameters of the conductor 500 such as, for example, mechanical parameters such as strain (e.g., distributed strain), stress, sag, change in length, etc., temperature (e.g., distribution temperature), vibration (e.g., aeolian and/or galloping vibrations) or electrical operating parameters (e.g., detecting line faults or breaks) or conductor or surrounding environment. These signals have to be interpreted (e.g., decoded, filtered, amplified, etc.) to determine the values of the various operating parameters.

In some embodiments, a controller 570 is coupled to (e.g., integrated with) the coupler 540. For example, the controller 570 may be disposed at an axial end of the coupler 540 between the body 542 and the connecting portion 546 of the coupler 540, and may be integrated with the coupler 540. A housing of the controller 570 may be coupled to a wall 543 of the coupler 540 that is located at the axial end of the coupler 540 and to the connecting portion 546 (e.g., welded thereto). In other embodiments, the controller 570 may be disposed on and coupled to any other wall of the coupler 570, for example, a sidewall of the coupler 540 that is parallel to a longitudinal axis of the coupler 540 (e.g., a sidewall of the sleeve 544).

The controller 570 is configured to receive a sensing signal that is indicative of the operating parameter(s) of the conductor 500 from the optical fiber assembly 550, and at least one of transmit the sensing signal to a receiver (e.g., a satellite, a transponder, a transceiver, a remote server, etc.), or interpret the signal to determine a value of the operating parameter and transmit the value of the operating parameter to the receiver. For example, in some embodiments, the controller 570 may be configured to receive the raw sensing signal form the optical fiber assembly 550 and at least temporary log or store the raw sensing signals into a memory of the controller 570 as well as transmit the sensing signals to the external receiver. In some embodiments, the controller 570 may be configured to filter the sensing signal(s) to remove noise and generate a filtered signal, and transmit the filtered signal to the external receiver. In some embodiments, the controller 570 may be configured to interpret the sensing signal to determine the value(s) of the operating parameter(s) and transmit the value(s) of operating parameter(s) to the external receiver.

An aperture 545 is defined in the wall 543 of the coupler 540, and a portion of the optical fiber assembly 550 is routed through the aperture 545 to the controller 570 and communicatively coupled to the controller 570. As shown in FIG. 5, the wall 543 is located at an axial end of the coupler 540 that is opposite the conductor 500. In other embodiments, the aperture 545 can be defined in any other wall of the coupler 540 proximate to the controller 570, for example, a sidewall of the coupler that is parallel to a longitudinal axis of the coupler 540. In some embodiments, a sealing member (e.g., an O-ring or gasket) may be disposed in the aperture 545, and configured to seal the inner volume of the coupler 540 from an external environment. In such embodiments, the optical fiber assembly 550 may be routed through the sealing member. In some embodiments, a wall of the controller 570 may form a wall of the coupler 540, and an optical connector may be provided on the wall of the controller 570 to which the optical fiber assembly 550 can be interfaced. The controller 570 may be configured to wirelessly transfer signals indicative of the optical signals received from the optical fiber assembly 550 to a receiver. This alleviates having to draw the optical fiber assembly 550 out of the coupler 540 for interfacing with the controller 570.

FIG. 6 is a side cross-section view of another coupler 640 having the conductor 500 coupled thereto, according to an embodiment. The coupler 640 includes a body 642 (e.g., a cylindrical body) and defining an internal volume configured to receive a portion of an axial end of the strength member 510 of the conductor 500. In some embodiments, the body 642 may be similar to the body 542 of the coupler 540. A sleeve 644 may be disposed around the body 642 (e.g., circumferentially around the body 642) and configured to contact the conductor layer 520 so as to electrically couple the coupler 640 to the conductor layer 520. The coupler 640 may also include a connecting portion 646 defining a keyhole 648. The connecting portion 646 may be configured to be coupled to corresponding hooks or connectors located on poles (e.g., tension towers) from which the conductor 500 may be suspended. In some embodiments, the outer coating 530 may be disposed on an outer surface of the coupler 640 (e.g., around the sleeve 644).

Different from the coupler 540, the controller 570 is not coupled to the coupler 640. Instead, the controller 570 is disposed remote from the coupler 640, for example, on a pole or tower to which the connecting portion 646 is coupled. An aperture 645 is defined through a sidewall of the coupler 640, for example, through sidewalls of the body 642 and the sleeve 644 that are parallel to a longitudinal axis of the coupler 640. A portion of the optical assembly 550 is routed through the aperture 645 and communicatively coupled to the controller 570. In other embodiments, the aperture 645 may be defined through any other sidewall of the coupler 640 or a wall located at the axial end of the coupler 640.

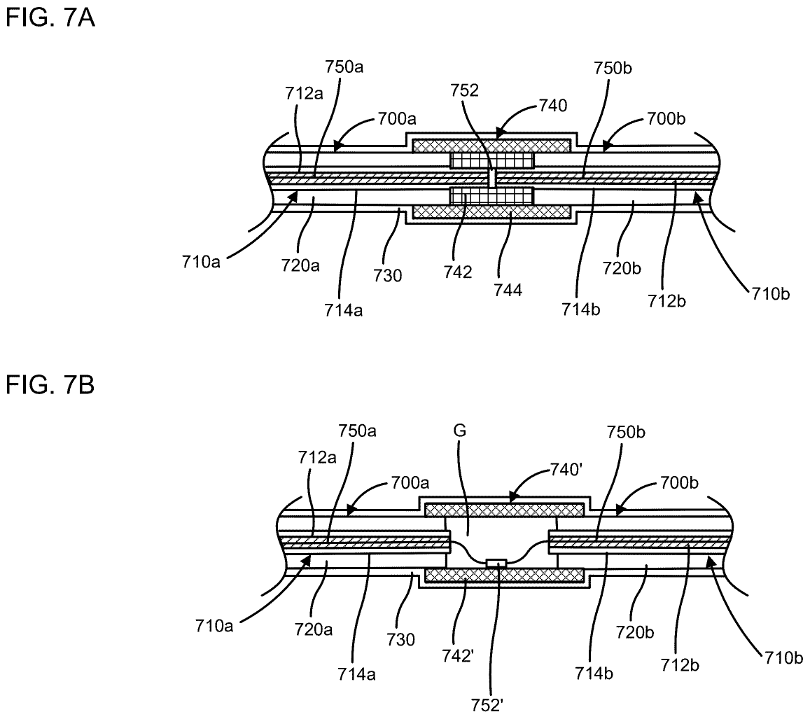

FIG. 7A is a schematic illustration of another fitting or coupler 740 that may be used to splice a first conductor 700a including a first optical assembly 750a to a second conductor 700b including a second optical assembly 750b such that the first optical assembly 750a is coupled to the second optical assembly 750b, according to an embodiment. In some embodiments, the coupler 740 may be coated with a low solar absorptivity and high radiative emissivity coating 730 (e.g., the coating 530 previously described herein). The first conductor 700a includes a first strength member 710a including a first core 712a and a first encapsulation layer 714a, and a first conductor layer 720a disposed around the first strength member 710a. Similarly, the second conductor 700b includes a second strength member 710b including a second core 712b and a second encapsulation layer 714b, and a second conductor layer 720b disposed around the second strength member 710b. The first optical assembly 750a is disposed in the first core 712a and the second optical assembly 750b is disposed in the second core 712b. The conductors 700a and 700b may be substantially similar to the conductor 500, and are therefore not described in further detail herein.

The coupler or fitting 740 includes a body 742 (e.g., a cylindrical body) defining an internal volume configured to receive portions of corresponding axial ends of the first strength member 710a and the second strength member 700b. For example, a predetermined length of the conductor layers 720a, 720b of the conductors 700a, 700b may be removed (e.g., a portion having a length in a range of about 150 mm to about 350 mm, inclusive from the axial end of the conductors 700a, 700b). The cross-sectional width of the inner volume of the body 742 is less than the outer cross-sectional width of the strength members 710a, 710b such that insertion of the axial end of the first strength member 710a and the second strength member 710b into the body 742 causes the inserted portion of the encapsulation layers 712a, 712b to be crimped and spliced to one another. A sleeve 744 may be disposed around the body 742 (e.g., circumferentially around the body 742) and configured to contact the conductor layers 720a, 720b so as to electrically couple the coupler 740 to the conductor layers 720a, 720b.

As previously described, the composite material from which the core 712a, 712b is formed may be susceptible to crush force damage. However, the encapsulation layers 714a, 714b disposed around the cores 712a, 712b also serve as a protection layers to protect the cores 712a, 712b from the compressive force exerted during crimping of the body 742a, 742b around the strength members 710a, 710b. Moreover, the first optical fiber assembly 750a is coupled to the second optical fiber assembly 750b, for example, via an optical coupler 752 (e.g., fused-fiber optical coupler, a micro-optics optical coupler, a planar waveguide optical coupler, or any other suitable optical coupler). In this manner, the first optical fiber assembly 750a may communicate sensing signals measured by the first optical fiber assembly 750a to the second optical fiber assembly 750b or vice versa for eventual communication to a controller (e.g., the controller 570).

In order to couple an axial end of a conductor such as the conductors 500, 700a, or 700b to a coupler (e.g., the coupler 540, 640, or 740), and to access the optical fiber assembly (e.g., optical fiber assembly 550, 750a, 750b) disposed therein for coupling to a controller (e.g., the controller 570) or to another optical fiber assembly, at least a portion of a conductor layer (e.g., conductor layer 520, 720a, 720b) disposed at an axial end of the conductor (e.g., conductor 500, 700a, 700b), as well as a portion of the encapsulation layer (e.g., encapsulation layer 514, 714a, 714b) and core (e.g., core 512, 712a, 712b) of the strength member (e.g., strength member 510, 710a, 710b) of the conductor (e.g., conductor 500, 700a, 700b) also has to be removed to allow a user (e.g., individual(s) responsible for installing and/or repairing the conductors) to access the optical fiber assembly (e.g., optical fiber assembly 550, 750a, 750b) disposed within the core (e.g., core 512, 712a, 712b). While the portion of the conductor layer (e.g., conductor layer 520, 720a, 720b) may be removed by stripping or peeling back portions of strands of the conductor layer (e.g., conductor layer 520, 720a, 720b), special tools may be desired to allow the user to remove the portions of the encapsulation layer (e.g., encapsulation layer 514, 714a, 714b) and/or the core (e.g., core 512, 712a, 712b) without damaging the optical fiber assembly (e.g., optical fiber assembly 550, 750a, 750b) disposed in the core (e.g., core 512, 712a, 712b).

FIG. 7B shows a schematic illustration of another fitting or coupler 740′ that is substantially similar to the coupler 740 described in connection with FIG. 7A. The coupler 740′ may be used to splice the first conductor 700a including the first optical assembly 750a to the second conductor 700b including the second optical assembly 750b such that the first optical assembly 750a is coupled to the second optical assembly 750b, according to an embodiment. In some embodiments, the coupler 740′ may be coated with a low solar absorptivity and high radiative emissivity coating 730 (e.g., the coating 530 previously described herein).

The coupler or fitting 740′ includes a body 742′ (e.g., a cylindrical body) defining an internal volume configured to receive portions of corresponding axial ends of the first conductor 700a and the second conductor 700b. Different from the coupler 740, the coupler 740′ is structured such that when axial ends of the first conductor 700a and the second conductor 700b are inserted into the body 742′, there is a gap G between the axial ends thereof. An optical coupler 752′ is disposed in the gap G, for example, coupled to an inner surface of a wall of the coupler body 742′. In some embodiments, the optical coupler 752′ may be fixedly coupled to the inner surface of the wall of the coupler 740′ for example, via fasteners, bonding, welding, or an adhesive. Axial ends of the strength members 710a, 710b, and conductor layer 720a, 720b may be removed to expose axial ends of the optical fiber assemblies 750a, 750b such that a length of each of the optical fiber assemblies 750a, 750b extends out of the corresponding axial ends of the conductors 700a, 700b. Each of the axial ends of the optical fiber assemblies 750a, 750b can then be coupled or spliced to the optical coupler 752′ to form an optical connection therebetween. The body 742′ may be coupled to the conductor layers 720a, 720b, for example, by crimping, at locations where the body 742′ is disposed around the conductor layers 720a, 720b such that negligible crimping force is applied at locations where the gap G is present. In this manner, the optical coupler 752′ may be protected from any damage that may result from the crimping force.

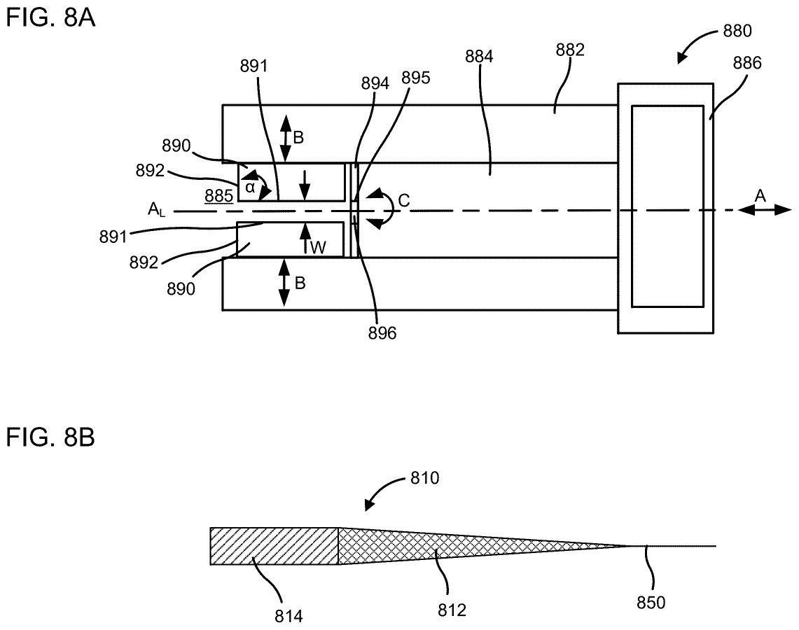

For example, FIG. 8A is a schematic illustration of a stripping tool 880 (hereinafter “tool 880”) for stripping an encapsulation layer (e.g., the encapsulation layer 114, 214, 314, 414, 514, 714a, or 714b) of a strength member (e.g., the strength member 110, 210, 310, 410, 510, 710a, or 710b) of a conductor (e.g., the conductor 100, 200, 300, 400, 500, 700a, or 700b) to allow access to a composite core (e.g., the composite core 112, 212, 312, 412, 512, 712a, or 712b) of the strength member and thereby, at least a portion of an optical fiber assembly (e.g., the optical fiber assembly 150, 250, 350, 450, 550, 750a, or 750b) disposed in the core (e.g., the core 112, 212, 312, 412, 512, 712a, or 712b), according to an embodiment.

The tool 880 includes a tool body 882 (also referred to as “body 882”) to which a handle 886 is coupled. The tool body 882 may be a longitudinal structure (e.g., a cylindrical structure) extending along a longitudinal axis A_{L} and defines an inner volume 884. An opening 885 is defined at first end of the tool body 882 and is configured to receive an axial end of a strength member of a conductor through the opening 885. The body 882 may be formed from a strong and rigid material, for example, metals (e.g., iron, aluminum, steel, stainless steel, alloys, any other suitable metal or a combination thereof), plastics, polymers, or a combination thereof. The handle 886 is coupled to a second end of the body 882 opposite the first end. The handle 886 may include ergonomic features such as grips, grooves, indents, detents, protrusions, or any other suitable feature to facilitate a user to grip the handle 886. The handle 886 can be gripped by the user and enables the user to move the body 882 back and forth in an axial direction along the longitudinal axis A_{L} in a first direction indicated by the arrow A so as to push the body around an axial end of the strength member of the conductor to draw the axial end of the strength member into the internal volume 884, or withdraw the strength member from the internal volume 884 through the opening 885.

The tool 880 may include two or more first blades 890 (e.g., 2, 3, 4, or even more blades) extending radially from an inner surface of the body 882 into the inner volume 884. In some embodiments, the first blades 890 may include a first cutting edge 891 (e.g., a sharpened edge) defined on a first edge of each of the first blades 890, which is parallel to or substantially parallel to the longitudinal axis A_{L}. In some embodiments, each the first blades 890 may be radially spaced apart from an adjacent first blade 890 by the same radial distance, or the same the radial angle. For example, based on the number of first blades 890 provided in the tool 880, the first blades 890 may be spaced apart from each other by a radial angle of 180 degrees when two first blades 890 are provided, by a radial angle of 90 degrees when four first blades 890 are provided, by a radial angle of 60 degrees when six first blades 890 are provided, by a radial angle of 45 degrees, when eight first blades 890 are provided, and so on.

The first blades 890 may be formed from a hard material (e.g., stainless steel, carbon, ceramics, etc.) capable of penetrating or cutting into the encapsulation layer of the strength member as the body 882 is moved over the strength member causing the strength member to move into the inner volume 884. The first cutting edge 891 of adjacent blades may be spaced apart by a distance W that may correspond to a cross-sectional width (e.g., diameter) of the core of the strength member such that the first blades 890 form longitudinal slits in the encapsulation layer without any substantial penetration into the core. In some embodiments, the first blades 890 may be configured to be radially displaced relative to each other in a direction shown by the arrow B so as to adjust the distance W between the first cutting edges 891 of opposing first blades 890. This may allow the tool 880 to accommodate various strength members having different cross-sectional width cores or different thickness encapsulation layers. In such embodiments, at least a portion of the blades 890 may be configured to be withdrawn into the body 882 (e.g., within radial slots defined in the body 882) to allow adjustment of the distance W. In other embodiments, the first blades 890 may be removably coupled to the body 882, for example, snap-fit or friction fit in the body 882, or coupled to the body 882 via coupling members such as screws, nuts, bolts, pins, etc. In such embodiments, the first blades 890 may be replaced with another set of blades, for example, new first blades once the first cutting edge 891 of the first blades 890 is worn, or to install first blades having different lengths so as to adjust the distance W between the first cutting edges 891 of corresponding blades based on the cross-sectional width of the strength member or a core thereof, as described herein.

In some embodiments, the first blades 890 may also include a second cutting edge 892 defined on a second edge 892 of the first blades 890 that is proximate to the opening 885 and extends in a direction orthogonal to the longitudinal axis A_{L}. The second cutting edge 892 may further facilitate cutting into the encapsulation layer as the body 882 is pushed over the strength member. While shown as being oriented at angle α of about 90 degrees relative to the first cutting edge, i.e., substantially orthogonal to the first cutting edge 891 of the corresponding first blade 890 in FIG. 8A, in some embodiments, the angle α may be greater than 90, for example, in a range of about 120 degrees to about 150 degrees, inclusive. This may facilitate the second cutting edge 892 to slice or cut into the encapsulation layer as the body 884 is displaced over the strength member to form longitudinal slots therein. In some embodiments, the corner of the first blade 690 at the interface of the first cutting edge 891 and the second cutting edge 892 may be chamfered or curved, for example, to a provide a continuous curved cutting edge from the first cutting edge 891 to the second cutting edge 892.

The tool 880 also includes a second blade 894 disposed axially inward of the first blades 890 within the body 882. The second blade 894 may include a circular blade that defines a central opening 896 and a cutting edge 895 defined on a rim of the central opening 896. The central opening 896 may have a diameter corresponding to the cross-sectional width of the core. While FIG. 8A shows the second blade 896 as being a single structure, in some embodiments, the second blade 894 may include an assembly including a plurality of circumferential blades whose respective radial cutting edges define the central opening 896. The second blade 894 is configured as a circumcizer such that as the body 882 and thereby, the second blade 894 is rotated in a clockwise or anti-clockwise direction about the longitudinal axis A_{L} as indicated by the arrow C and advanced towards the strength member along the longitudinal axis A_{L} in the direction indicated by the arrow A, the cutting edge 895 peels the encapsulation layer of the core. The longitudinal slits already formed in the encapsulation layer by the first blades 890 may facilitate the peeling off of the encapsulation layer by the circumcision action of the second blade 894. In some embodiments, the first blades 890 may be radially withdrawn in the body 882 before circumcising and peeling of the encapsulation layer from the core by the second blade 894. In some implementations, the peeled encapsulation layer may be collected in the inner volume 884 as the encapsulation layer is peeled off the core at the axial end of the strength member. The stripped encapsulation layer may later be removed from the inner volume 884 and recycled.

In some embodiments, the first blades 890 and/or the second blade 894 may also be configured to machine or grind a portion of the core to expose the optical fiber assembly disposed therewithin. For example, the first blades 890 may be structured to also form longitudinal slits in the core up to a predetermined distance, and the second blade may be used to grind or remove a portion of the core. In some embodiments, the second blade 894 may include rotary blades such as those employed in rotary pencil sharpeners to grind the core to allow access to the optical fiber assembly. In some embodiments, a separate handheld grinding tool (e.g., a tool having rotary blades similar to a rotary pencil sharpener) may be used to grind or machine the core to enable the optical fiber assembly disposed therein to be accessed. In some embodiments, additionally or alternatively, at least a portion of the core may be removed using an appropriate solvent to access the optical fiber assembly. For example, FIG. 8B is a side view of an axial end of a composite core 812 of a strength member 810 of a conductor that has been stripped off an encapsulation layer 814 via the stripping tool of FIG. 8A and a portion of which has been removed to allow access to a portion of an optical fiber assembly 850 disposed therein.

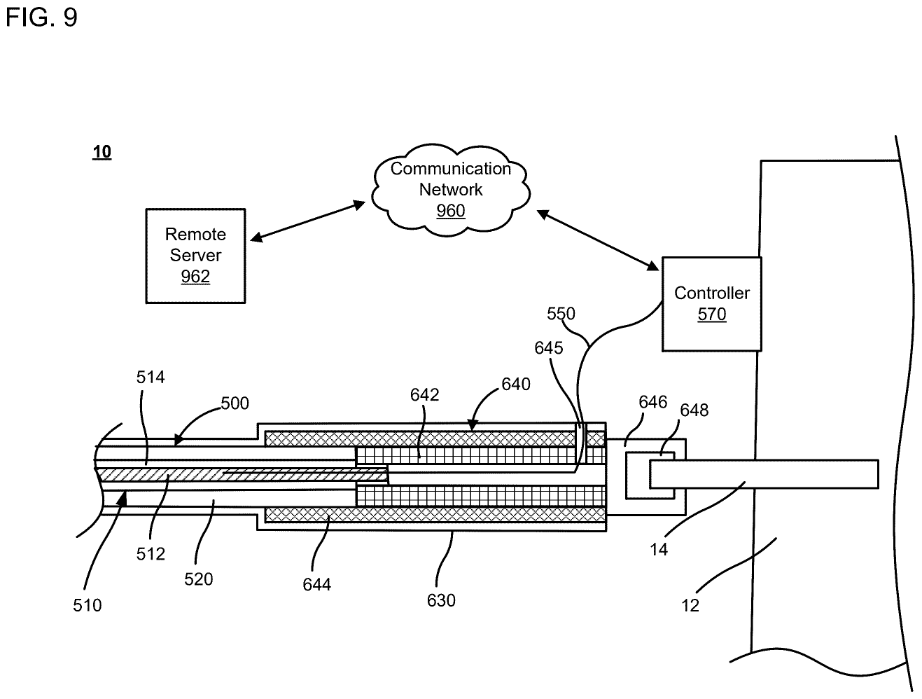

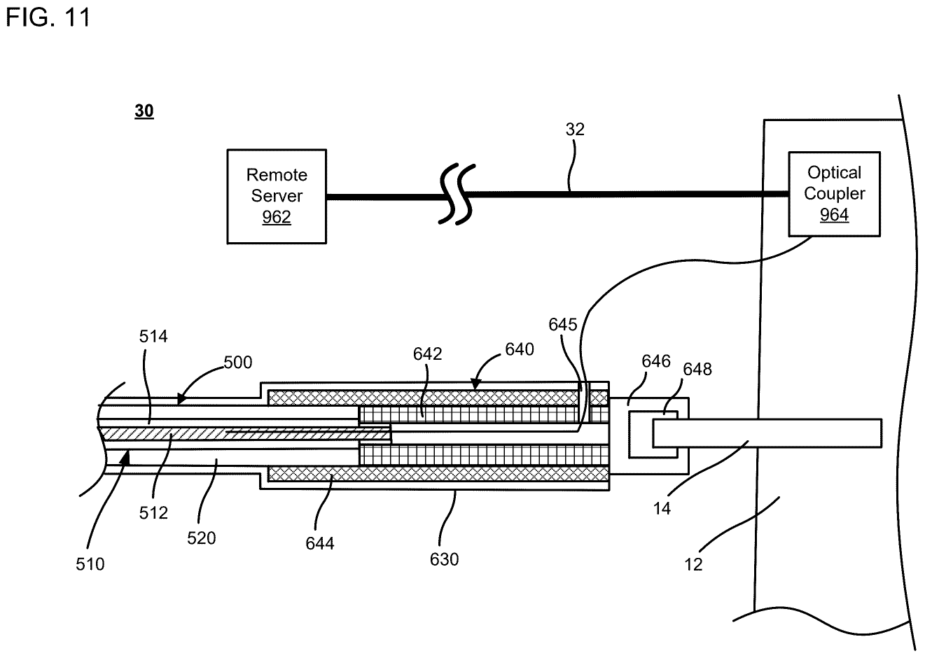

FIG. 9 is schematic illustration of a system 10 for sensing operating parameters of a conductor 500 and transmitting the operating parameters or determined values of the operating parameters to a remote server 962, according to an embodiment. The system 10 includes the conductor 500 coupled to the coupler 640, as previously described. The coupler 640 includes the connecting portion 646 defining the keyhole 648 and the aperture 645 defined through a sidewall of the coupler 640, as previously described. The coupler 640 is coupled or mounted to a pole 12 via a coupling member 14. For example, the coupling member 14 may include a bolt coupled to the pole 12, and may further include a hook that is inserted through the keyhole 648 to mount the coupler 640 to the pole 12. While shown as being included in an above ground electrical transmission system 10 in FIG. 9 (and FIG. 11), in some embodiments, the conductor 500 may be included in an underground system in which the conductor 500, or at least portions thereof or buried beneath the ground to be included in an underground electrical transmission system. Thus, the various concepts described herein are equally applicable to over ground as well as underground systems, and all such systems are intended to be within the scope of this disclosure.

In some embodiments, the system 10 further includes a light source (not shown) configured to send an optical signal into the optical fiber assembly 550. In some embodiments, the light source can be an interrogator sending a pulsed light or a continuous-wave light into the optical fiber assembly 550. In some embodiments, the light source may include a narrow-linewidth laser.

In some embodiments, the optical fiber assembly 550 can further include at least one FBGs (e.g., a plurality of FBGs) disposed within the fiber core at a predetermined location along a length of the fiber core.

In some embodiments, the sensing signal received from the optical fiber assembly 550 includes a backscatter signal from a light reflected from the fiber core. In some embodiments, the light can be transmitted into the fiber core via a light source optically coupled to the conductor 500.

In some embodiments, the sensing signal received from the optical fiber assembly 550 can include at least one of a Rayleigh backscattered signal, a Brillouin backscattered signal, and/or a Raman backscattered signal.

In some embodiments, the operating parameter of the conductor 500 may include at least one of temperature, strain, length, or sag of the conductor.

In some embodiments, the system 10 can provide a highly cost-effective solution for monitoring overhead power lines using optical fiber-based sensing technology. The cost-effectiveness can be measured in terms of cost per mile of the transmission line. This is particularly beneficial for monitoring transmission lines over long distances, as one system can cover a transmission line of up to about 1000 km, up to about 500 km, up to about 250 km, up to about 100 km, up to about 50 km, or up to about 10 km.

In some embodiments, the system 10 can operate effectively on any terrain surface, making it a versatile solution for diverse geographical locations. In some embodiments, the system 10 is insensitive to transmission structure flexing or bending. This ensures that the system's performance remains consistent, regardless of the physical conditions of the transmission structure.

In some embodiments, the system 10 allows the use of dual interrogation modules (i.e., systems and techniques used to analyze and interpret the signals obtained from optical fiber assembly 550, such as techniques based on DTS+DSS and DTS+FBGs) which share a single optical fiber assembly 550 to determine a value of an operating parameter of the conductor 500. The use of dual modules can significantly improve the accuracy of a sag measurement. This is primarily due to their ability to simultaneously measure temperature and strain, while also distinguishing between the two. That is, by measuring temperature independently, the system 10 can accurately calculate the true strain, which is crucial for determining physical changes like sag. Furthermore, the shared single optical fiber assembly 550 in these dual modes may simplify the system structure, enhancing efficiency. Therefore, the integration of the dual or hybrid sensing modules may provide a more precise and comprehensive understanding of conductor behavior, leading to improved sag measurement accuracy. Accordingly, the system 10 provides a high accuracy in measuring sags. This allows for precise monitoring and maintenance of the power lines.

The system 10 is not limited to providing sag measurements. It can also enable real-time monitoring of at least one of temperature, strain, length, or sag of the conductor.

The remote server 962 may include a local server or a cloud based server configured to receive the sensing signals or values of the operating parameters from the controller 570 and store the values, and may also be configured to analyze the values to determine an operating status of the conductor 500 based on the operating parameters of the conductor 500. For example, the remote server 962 may be configured to determine mechanical parameters such as strain (e.g., distributed strain), stress, sag, change in length, etc., or temperature (e.g., distribute temperature) of the conductor 500, or electrical operating parameters (e.g., detect line faults or breaks), or any other suitable parameter of the conductor 500 to determine the operational health of the conductor 500 (e.g., sag exceeding a threshold, temperature of conductor or environment exceeding a threshold, a break in the conductor 500, or any other fault with the conductor 500 and indicate the fault to a user (e.g., generate alarms or faults codes indicative of a type of fault and location of the fault).

The controller 570 may also be mounted or disposed on the pole 12. In other embodiments, the controller 570 may be coupled to the coupler, for example, as described with respect to the coupler 640. The optical fiber assembly 550 is routed through the aperture 645 and communicatively coupled to the controller 570, as previously described. The controller 570 may be configured to receive a sensing signal from the optical fiber assembly 550 and transmit the sensing signal to remote server 962, or interpret the sensing signal to determine a value(s) of the operating parameter(s) and transmit the value of the operating parameter to the remote server 962 via a communication network 960.

In some embodiments, the controller 570 may include a plurality of controllers 570. In some embodiments, each one of the plurality of controllers 570 may include a single interrogation module. In some embodiments, the controller 570 may include a plurality of interrogation modules. In some embodiments, the controller 570 may include a first controller coupled to a first axial end of the optical fiber assembly 550 of the conductor 500, and a second controller coupled to a second axial end of the optical fiber assembly 550 of the conductor 500 opposite the first axial end. Having two controllers may provide redundancy by enabling optical measurements from each end of the optical fiber assembly 550 such that measurements can be made even if one of the controller malfunctions, as well as provide redundancy in measurements to increase accuracy.

The communication network 960 may include any suitable Local Area Network (LAN) or Wide Area Network (WAN) configured to receive sensing signals or values of the operating parameters from the controller 570 and transmit the sensing signals or values of the operating parameters to the remote server 962. In some embodiments, the communication network 960 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), Optical Ground Wire (OPGW), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, ZIGBEE®, BLUETOOTH®, WI-FI®, any suitable wired network, combination thereof, and/or the like. In some embodiments, the communication network 960 may include a satellite based network (e.g., the STARLINK® satellite network).

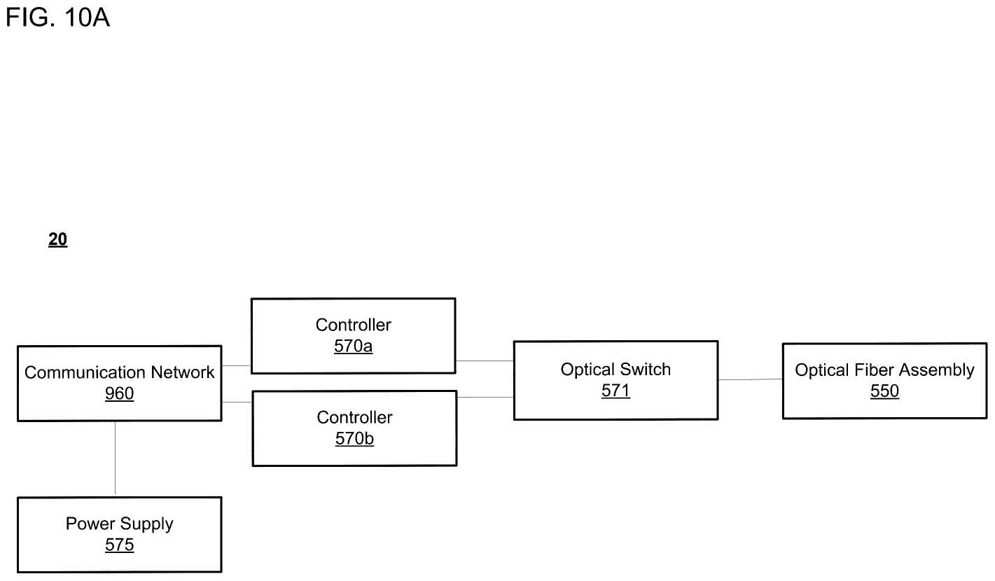

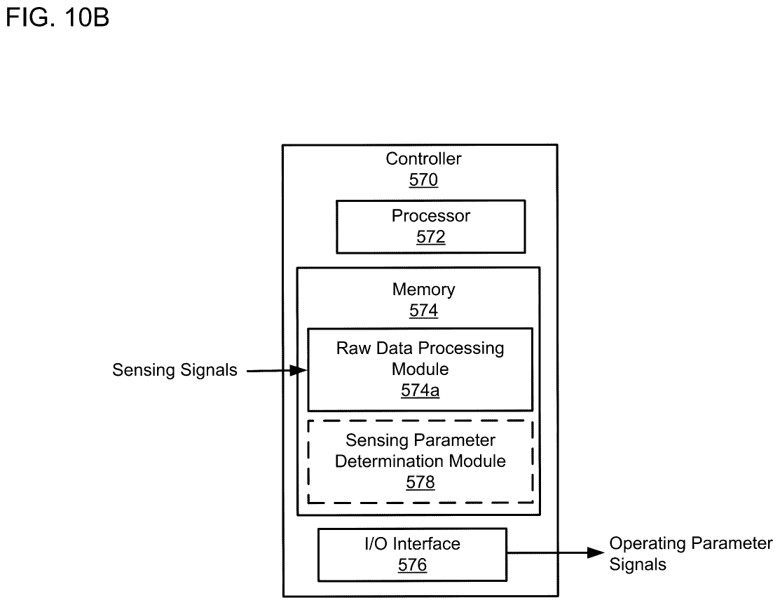

FIG. 10A is schematic block diagram of a system 20. The system 20 includes the optical fiber assembly 550 of the conductor 500 as shown and described with respect to FIGS. 5, 6, and 9, according to an embodiment. The optical fiber assembly 550 is communicatively coupled to a first controller 570a and a second controller 570b through an optical switch 571. In some embodiments, the first controller 570a can be configured to: receive a first sensing signal from the optical fiber assembly 550, and at least one of: transmit the first sensing signal to a first receiver, or interpret the first signal to determine a value of a first operating parameter of the conductor 500 and transmit the value of the first operating parameter to the first receiver. In some embodiments, the second controller 570b can be configured to: receive a second sensing signal from the optical fiber assembly 550, and at least one of: transmit the second sensing signal to a second receiver, or interpret the second signal to determine a value of a second operating parameter of the conductor 500 and transmit the value of the second operating parameter to the second receiver. In some embodiments, the first controller 570a may be operatively coupled to a first axial end of the optical fiber assembly 550 (e.g., through a first axial end of the conductor 500) and the second controller 570b may be operatively coupled to a second axial end of the optical fiber assembly 550 (e.g., through a second axial end of the conductor 500), for example, to operate independently and thus, independently measure the operational parameters of the conductor 500. In such embodiments, each of the controllers 570a, 570b may include the optical switch 571 (e.g., a dedicated or corresponding optical switch 571), optical source (e.g., lasers), optical detector, power supply, communication module, or any other suitable components to facilitate independent operation such that there is no sharing of components between those associated with the first controller 570a and the second controller 570b.

The system 20 can further include the communication network 960 (e.g., as described with respect to FIG. 9) that is communicatively coupled to the first controller 570a and the second controller 570b. In some embodiments, communication network 960 can include the first receiver and the second receiver. The communication network 960 is included in the system of FIG. 9. In some embodiments, the communication network 960 is electrically coupled to a power supply 575 to function.

In some embodiments, the system 20 is the same or substantially similar to the system 10 described with respect to FIG. 9. In some embodiments, the system 20 may include a conductor that is same or substantially similar to the conductor 500 described with respect to FIG. 9.

In some embodiments, the first controller 570a includes a DTS interrogation module and the second controller 570b includes a DSS interrogation module. In some embodiments, the first controller 570a includes a DTS interrogation module and the second controller 570b includes a FBG interrogation module, wherein the optical fiber assembly 550 includes at least one FBGs (i.e., at least one set of gratings) disposed within the fiber core at a predetermined location along a length of the fiber core.

In some embodiments, the first sensing signal received from the optical fiber assembly 550 includes a Brillouin backscattered signal, and the first operating parameter of the conductor (e.g., conductor 500) includes strain.

In some embodiments, the first sensing signal received from the optical fiber assembly 550 includes a Brillouin backscattered signal and the operating parameter of the conductor (e.g., conductor 500) includes strain and temperature.

In some embodiments, the second sensing signal received from the optical fiber assembly 550 includes a Raman backscattered signal and the operating parameter of the conductor (e.g., conductor 500) includes temperature.

In some embodiments, at least a portion of the conductor (e.g., conductor 500) including the optical fiber assembly 550 is an overhead power line.

In some embodiments, the optical switch 571 may include 2×1 optical switch which allows using a single fiber optical fiber assembly 550 for system 20. In some embodiments, the optical switch 571 may include 3×1 optical switch.

The systems 10 and 20 described herein provide a more accurate way to calculate sag error based on FBG and DTS measurements. For example, the true strain can be calculated using both DTS and FBG measurements for each span of an overhead conductor (e.g., power line), which allows for an accurate calculation of the conductor's true physical length change and sag change. To illustrate, the FBG peak wavelength shift (Δλ), temperature change (ΔT), and strain change (Δε) may be used in the calculations. The FBG's thermal wavelength coefficient c(t) may be about 13 pm/° C. and the wavelength strain change coefficient c(ε) may be about 1.55 pm/E. In some embodiments, the equation Δλ=c(t)ΔT+c(ε)Δε may be used to calculate the change in wavelength.

For example, if the FBG wavelength is 1,550,000 pm, the span is 573 m, and the arc length is 580.31 m (in the worst-case scenario with ice and strong wind), the sag is 39.64 m. If the DTS temperature measurement accuracy is +2° C. and the FBG wavelength measurement accuracy is ±2 μm, the strain change Δε error will be (2+2*13)/1.55=18 8. This results in an arc length change measurement error of 580.31 m*18 ε=1.04 cm.

In some embodiments, the sag can then be calculated using the equation: sag=sqrt(3Span(Arc length−Span)/8). Therefore, the sag change calculation error will be 3 cm.

In some embodiments, the error obtained in a sag change measurement by using methods and systems according to the embodiments described herein is no more than about 10 cm, no more than about 9 cm, no more than about 8 cm, no more than about 7 cm, no more than about 6 cm, no more than about 6 cm, no more than about 5 cm, no more than about 4 cm, no more than about 3 cm, no more than about 2 cm, or no more than about 1 cm.

FIG. 10B is a schematic block diagram of the controller 570 as shown and described with respect to FIGS. 5, 6, and 9, and may include the controllers 570a, 570b as described in FIG. 10A, according to an embodiment. While FIG. 5 illustrates a particular embodiment of the controller 570, the controller 570 may include any other suitable controller configured to perform the operations described herein. The controller 570 includes a processor 572, a memory 574, and an input/output (I/O) interface 576. The processor 572 may be implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 574 (e.g., Random Access Memory (RAM), Read-Only Memory (ROM), Non-volatile RAM (NVRAM), Flash Memory, hard disk storage, etc.) stores data (e.g., operating parameter data) and/or computer code (e.g., operating parameter filtering or processing algorithms, etc.) for facilitating at least some of the various processes described herein. The memory 574 may include tangible, non-transient volatile memory, or non-volatile memory. The memory 574 may include a non-transitory processor-readable medium having stores programming logic that, when executed by the processor 572, controls the operations of the controller 570. In some arrangements, the processor 572 and the memory 574 form various processing circuits described with respect to the controller 570.

The I/O interface 576 is structured for sending and receiving data (e.g., over a communication network) from the controller 570. Accordingly, the I/O interface 576 includes any of a cellular transceiver (for cellular standards), local wireless network transceiver (for 802.11X, ZIGBEE®, BLUETOOTH®, WI-FI®, or the like), wired network interface, a combination thereof (e.g., both a cellular transceiver and a BLUETOOTH® transceiver), and/or the like.

In some embodiments, the controller 570 may include various circuitries or modules configured to perform the operations of the controller 570. For example, as shown in FIG. 10B, the controller 570 includes a raw data processing module 574a, and optionally, a sensing parameter determination module 578. In one configuration, the raw data processing module 574a, and the sensing parameter determination module 578 are embodied as machine or computer-readable media (e.g., stored in the memory 574) that is executable by a processor, such as the processor 572. As described herein and amongst other uses, the machine-readable media (e.g., the memory 574) facilitates performance of certain operations of the raw data processing module 574a, and the sensing parameter determination module 578 to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). Thus, the computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, wireless network, etc.).

In some embodiments, the raw data processing module 574a, and the sensing parameter determination module 578 may be embodied as one or more circuitry components including, but not limited to, processing circuitry, network interfaces, peripheral devices, input devices, output devices, sensors, etc. In some embodiments, the raw data processing module 574a, and the sensing parameter determination module 578 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the raw data processing module 574a, and the sensing parameter determination module 578 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

Thus, the raw data processing module 574a, and the sensing parameter determination module 578 may also include programmable hardware devices such as field programmable gate arrays, programmable array logic, programmable logic devices or the like. In this regard, the raw data processing module 574a, and the sensing parameter determination module 578 may include one or more memory devices for storing instructions that are executable by the processor(s) of the raw data processing module 574a, and the sensing parameter determination module 578. The one or more memory devices and processor(s) may have the same definition as provided below with respect to the memory 574 and the processor 572.

In some embodiments, the raw data processing module 574a, and/or the sensing parameter determination module 578 may receive a Brillouin backscattered signal from the optical fiber assembly 550 to calculate strain of pre-determined length (e.g., arch length) the conductor 500. In such embodiments, the raw data processing module 574a, and/or the sensing parameter determination module 578 may include a DSS interrogation module.

In some embodiments, the raw data processing module 574a, and/or the sensing parameter determination module 578 may receive a Rayleigh backscattered signal from at least one FBGs disposed within the optical fiber assembly 550 to calculate strain of pre-determined length (e.g., arc length) the conductor 500. In such embodiments, the raw data processing module 574a, and/or the sensing parameter determination module 578 may include a FGB interrogation module.

In some embodiments, the raw data processing module 574a, and/or the sensing parameter determination module 578 may receive a Brillouin backscattered signal from the optical fiber assembly 550 to calculate temperature of pre-determined length (e.g., arc length) the conductor 500. In such embodiments, the raw data processing module 574a, and/or the sensing parameter determination module 578 may include a DTS interrogation module.

In some embodiments, the raw data processing module 574a, and/or the sensing parameter determination module 578 may receive a Raman backscattered signal from the optical fiber assembly 550 to calculate temperature of pre-determined length (e.g., arc length) the conductor 500. In such embodiments, the raw data processing module 574a, and/or the sensing parameter determination module 578 may include a DTS interrogation module.

In some embodiments, the raw data processing module 574a, and/or the sensing parameter determination module 578 may receive a Raman backscattered signal from the optical fiber assembly 550 to calculate temperature of pre-determined length (e.g., arc length) the conductor 500. In such embodiments, the raw data processing module 574a, and/or the sensing parameter determination module 578 may include a DTS interrogation module.

In some embodiments, the raw data processing module 574a, and/or the sensing parameter determination module 578 may receive a Brillouin and a Rayleigh backscattered signal backscattered signal from the optical fiber assembly 550 to calculate Landau Placzek ratio, thereby determining temperature of pre-determined length (e.g., arc length) the conductor 500. In such embodiments, the raw data processing module 574a, and/or the sensing parameter determination module 578 may include a DTS interrogation module.

In some embodiments, the raw data processing module 574a, and/or the sensing parameter determination module 578 may receive at least one of a Rayleigh backscattered signal, a Brillouin backscattered signal, and/or a Raman backscattered signal to calculate at least one of temperature, strain, or sag of the conductor 500.

In some embodiments, the raw data processing module 574a may include a plurality of raw data processing module 574a, each of which receives a different backscattering signal. In some embodiments, the sensing parameter determination module 578 may include a plurality of the sensing parameter determination module 578, each of which receives a different backscattering signal.

In some embodiments, the controller 570 may use dual Brillouin backscattered signal to measure both temperature and strain profile of the conductor 500.

In the example shown, the controller 570 includes the processor 572 and the memory 574. The processor 572 and the memory 574 may be structured or configured to execute or implement the instructions, commands, and/or control processes described herein with respect to the raw data processing module 574a, and the sensing parameter determination module 578. Thus, the depicted configuration represents the aforementioned arrangement in which the raw data processing module 574a, and the sensing parameter determination module 578 are embodied as machine or computer-readable media. However, as mentioned above, this illustration is not meant to be limiting as the present disclosure contemplates other embodiments such as the aforementioned embodiment including the raw data processing module 574a, and the sensing parameter determination module 578, or embodiments in which at least one circuit of the raw data processing module 574a, and the sensing parameter determination module 578 are configured as a hardware unit. All such combinations and variations are intended to fall within the scope of the present disclosure. In some embodiments, the one or more processors may be shared by multiple circuits (e.g., the raw data processing module 574a, and the sensing parameter determination module 578) may comprise or otherwise share the same processor which, in some example embodiments, may execute instructions stored, or otherwise accessed, via different areas of memory 254.

The raw data processing module 574a is configured to receive sensing signals from the optical fiber assembly 550 or any other optical fiber assembly described herein, and process the sensing signals. In some embodiments, the raw data processing module 574a may include a photodetector configured to transform the optical signals received from the optical fiber assembly 500 into electrical signals that can be communicated by the controller 570 to the remote server 962. In some embodiments, the raw data processing module 574a may also be configured to filter the sensing signals using hardware or software filters (e.g., low pass filters, high pass filters, band pass filters, Fourier transform filters, band stop filter, notch filter, comb filter, all pass filter, cut-off frequency filter, roll off filter, transition band filter, ripple filter, any other suitable filter or a combination thereof) configured to filter noise from the raw sensing signals received from the optical fiber assembly.

In embodiments in which the controller 570 includes the sensing parameter determination module 578, the sensing parameter determination module 578 may be configured to analyze the processed sensing signals and determine one or more operating parameters of the conductor 500 (e.g., any of the operating parameters described herein) from the processed sensing signals. The I/O interface 576 is configured to generate an operating parameter signal indicative of the processed operating parameters and/or the operating parameter values obtained therefrom. The operating parameter signal may be communicated to the remote server 962 via the communication network 960 as previously described herein.

Many electrical transmission systems that are used to communicate electrical energy via conductors suspended between poles or towers also include communication fibers suspended between the same poles or towers. Such communication fibers [e.g., optical ground wire (OPGW) fibers] are used to communicate communication signals such as cable or internet signals to remote servers, but may also be used to communicate the sensing signals measured by optical fiber assemblies included in conductors. For example, FIG. 11 is schematic illustration of a system 30 for transmitting sensing signals measured from the conductor 500 by the optical fiber assembly 550, according to an embodiment. The system 30 is similar to the system 10 and includes the conductor 500 coupled to the pole 12 via the coupler 640, as previously described herein. However, different from the system 10, the system 30 also includes a communication fiber 32 coupled to the pole 12, and configured to transmit communication signals. The communication fiber 32 may be configured to communicate communication signals to the remote server 962 or any other remote server. An optical coupler 964 may be disposed on the pole 12 and is coupled to the communication fiber 32. The optical fiber assembly 550 is routed through the aperture 645 of the coupler 640, and communicatively coupled to the optical coupler 964. The optical coupler 964 may include, for example, an X coupler, a combiner, a splitter, star coupler, a tree coupler, any other suitable optical coupler or a combination thereof, and is configured to communicate the sensing signals measured by the optical fiber assembly 550 to the communication fiber 32, which in turn communicates the sensing signals to the remote server 962 along with the communication signals.

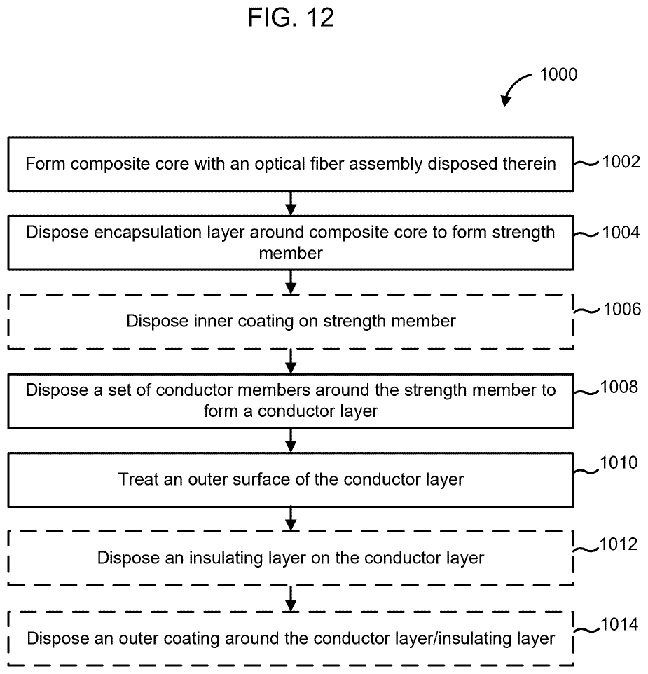

FIG. 12 is a schematic flow chart of a method 1000 for manufacturing a conductor (e.g., the conductor 100, 200, 300, 400, 500, 700a, 700b) including a strength member (e.g., the strength member 110, 210, 310, 410, 510, 710a, 710b) that includes a composite core (e.g., the core 112, 212, 312, 412, 512, 712a, 712b) having an optical fiber assembly (e.g., the optical fiber assembly 150, 250, 350, 450, 550, 750a, 750b) disposed in the composite core and an encapsulation layer (e.g., the encapsulation layer 114, 214, 314, 414, 514, 714a, 714b) disposed around the composite core, and a conductor layer (e.g., the conductor layer 120, 220, 320, 420, 520, 720a, 720b) disposed around the strength member, according to an embodiment. While the method 1000 is described with respect to the conductor 100, this should not be construed as limiting the disclosure and various operations of the method 1000 may be used to form any conductor including a composite core and an optical fiber assembly disposed in the composite core, as described herein.

The method 1000 includes forming the composite core 112 with the optical fiber assembly 150 disposed therein, at 1002. For example, a composite material (e.g., any of the composite materials described herein with respect to the composite core 112) may be heated to a temperature about equal to or greater than a first glass transition temperature or melting temperature of the composite material but less than the second glass transition temperature or melting temperature of the fiber encapsulation layer 154 of the optical fiber assembly 150, and the composite material molded, pulled, pultruded, or extruded along with the optical fiber assembly 150 to form the core 112 with the optical fiber assembly 150 disposed or embedded therein, and being in intimate contact with the core 112. Because the second glass transition temperature or melting temperature of the fiber encapsulation layer 154 of the optical fiber assembly 150 is greater than the first glass transition temperature or melting temperature, heating of the composite material during forming of the core 112 does not damage the fiber encapsulation layer 154. Thus, the optical fiber assembly 150 can be disposed in, embedded in, or integrated into the core 112 while damage to the fiber encapsulation layer 154 is inhibited due to its higher second glass transition temperature or melting temperature.

In some embodiments, the composite core 112 may have a first color and the fiber encapsulation layer 152 may have a second color different from the first color. For example, the composite material used to form the core 112 may have a dark color (e.g., black or near black color), and the fiber encapsulation layer 154 may have a bright color such as, for example, white, bright pink, bright green, bright orange, bright blue, or any other suitable color that has substantial contrast with the color of the core 112 to allow a user to visually differentiate the optical fiber assembly 150 from the core 112, as previously described. In some embodiments, the fiber encapsulation layer 154 may include a fluorescent material or include a fluorescent dye, as previously described.

The optical fiber assembly 150 may be disposed at any suitable location in the core 112. In some embodiments, the optical fiber assembly 150 may be disposed approximately along a central axis of the strength member 110, or a central axis of the conductor 100 in embodiments in which the conductor 100 has a single strength member 110, for example, to reduce micro bending losses, as previously described herein. In some embodiments, the optical fiber assembly 150 may be disposed proximate to a radially outer edge of the core 112, for example, parallel to the central axis of the core 112 proximate to an outer peripheral edge of the core 112. This may allow a user to easily access the optical fiber assembly 150 by removing only a small portion of the core 112, as described herein. In some embodiments, a shortest radial distance from an outer edge of optical fiber assembly 150 to a radial outer edge of the core 112 may be in a range of about 0.1 mm to about 3 mm, inclusive (e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.2, 2.4, 2.6, 2.8, or 3.0 mm, inclusive). In some embodiments, the shortest radial distance may be at most 3 mm.

In some embodiments, the method 1000 includes disposing the encapsulation layer 114 around the core 112 to form the strength member 110, at 1004. In other words, at 1004, the encapsulation layer 114 is disposed around the core 112. The encapsulation layer 114 may include a conductive material or an insulative material, as previously described herein. In some embodiments, the encapsulation layer 114 may be disposed around the core 112 using a conforming machine or a similar function machine, and be optionally further drawn to achieve target characteristics of the encapsulation layer 114 (e.g., a desired geometry or stress state). The conforming machines or similar machines used for disposing the encapsulation layer 114 may allow quenching of the encapsulation layer 114. The conforming machine may be integrated with stranding machine, or with pultrusion machines used in making fiber reinforced composite strength members such that the encapsulation layer 114 may disposed on the composite core 112 simultaneously during the forming process of the core 112. In some embodiments, multiple encapsulation layers 114 may be disposed around the core 112, which may be substantially similar to each other, or may be different from each other (e.g., formed from different materials, have different thicknesses, have different tensile strengths, etc.). In some embodiments, core 112 may include a carbon fiber reinforced composite, and the encapsulation layer 114 may include aluminum, for example, pre-tensioned or pre-compressed aluminum, as previously described.

In some embodiments, the method 1000 may include disposing the inner coating 116 on the strength member 110, at 1006. In other words, in some embodiments, the inner coating 116 may be disposed on an outer surface of the encapsulation layer 114, at 1006, for example, via painting spray coating, depositing and cross-linking, shrink wrapping, any other suitable method, or combination thereof. In some embodiments, the inner coating 116 may be formulated to have a low absorptivity of less than 0.5 at a wavelength in a range of 2.5 microns to 15 microns, inclusive, at an operating temperature in a range of 60 degrees C. to 250 degrees Celsius, inclusive, and may be formed from any suitable material, as described herein. In some embodiments, the inner coating 116 may be disposed on the outer surface of the encapsulation layer 114 subsequently to, or substantially simultaneously with, disposing the encapsulation layer around the core 112, at 1004.

In some embodiments, the method 1000 includes disposing a set of conductor members around the strength member 110 to form a conductor layer 120, at 1008. In other words, at 1008, the set of conductive members (e.g., conductive strands) are disposed over the strength member 110 (e.g., around the encapsulation layer 114 or around the inner coating 116 disposed around the encapsulation layer 114) to form the conductor layer 120. The conductive strands may be formed from aluminum, aluminum alloy, copper or copper alloy including micro alloy as conductive media, etc. In some embodiments, the conductor layer 120 may include conductive strands including Z, C, or S wires to keep the outer strands in place. The conductor layer 120 may have any suitable cross-sectional shape, for example, circular, triangular, trapezoidal, etc. In some embodiments, the conductor layer 120 may include stranded aluminum layer that includes round or trapezoidal aluminum strands. In some embodiments, the conductor layer 120 may include Z shaped aluminum strands. In some embodiments, the conductor layer 120 may include S shaped aluminum strands.

The conductive strands may be disposed around strength member 110, at 1008, using a conforming machine or any suitable method, as described herein. In some embodiments, the conductor layer 120 may include a first set of conductive strands included in disposed around the strength member 110 in a first wound direction (e.g., wound helically around the strength member 110 in a first rotational direction), a second set of conductive strands disposed around the first set of strands in a second wound direction (e.g., wound helically around the first set of conducive strands in a second rotational direction opposite the first rotational direction), and may also include a third set of strands wound around the second set of strands in the first wound direction.

In some embodiments, the method 1000 includes treating an outer surface of the conductor layer 120, at 1010. In other words, in some embodiments, the outer surface of the conductor layer 120 (e.g., an outer surface of each conductive strand, or a radially outer surface of only the outer most conductive strands included in the conductor layer 120) is treated, at 1010. For example, the outer surface of the conductive strands of the conductor layer 120 may be cleaned using any suitable method such as, for example, via acid, solvents, and/or texturized using mechanical means (e.g., sand blasted) to facilitate adhesion of the outer coating 130 to the outer surface of the conductor layer 120.

In some embodiments, the method 1000 may include disposing the insulating layer 122 on the conductor layer 120, at 1012. In other words, in some embodiments, the insulating layer 122 is disposed on the conductor layer 120, at 1012. The insulating layer 122 may be formed from any suitable electrically insulative material, for example, rubber, plastics, or polymers (e.g., polyethylene, PTFE, high density polyethylene, cross-linked high density polyethylene, etc.), and may be configured to electrically isolate or shield the conductor 100. In some embodiments in which the insulating layer 122 is disposed around the conductor layer 120, the outer surface of the insulating layer 122 may be cleaned or texturized (e.g., via sand blasting).

In some embodiments, the method 1000 may include disposing the outer coating 130 around the conductor layer 120 and/or the insulating layer 122, at 1014. In other words, in some embodiments, at 1014, the outer coating 130 may be disposed around (e.g., disposed on an outer surface of) the conductor layer 120, or disposed around (e.g., disposed on an outer surface of) the insulating layer 122 in embodiments in which the insulating layer 122 is disposed around the conductor layer 120. The outer coating 130 may be disposed using any suitable method, for example, via painting spray coating, depositing and cross-linking, shrink wrapping, any other suitable method, or combination thereof. The outer coating 130 may be formulated to have a solar absorptivity of less than 0.5 (e.g., 0.49, 0.45, 0.40, 0.35, 0.30, 0.25, 0.20, 0.15, 0.1, inclusive or even lower) at a wavelength of less than 2.5 microns, and a radiative emissivity of greater than 0.5 (e.g., 0.51, 0.55, 0.60, 0.65, 0.70, 0.75, 0.80, 0.85, 0.90, 0.95, inclusive, or even higher) at a wavelength in a range of 2.5 microns to 15 microns, inclusive at an operating temperature in a range of 60 degrees C. to 250 degrees Celsius, inclusive. For example, the outer coating 130 may be formulated to have a radiative emissivity of equal to or greater than 0.85 (e.g., 0.85, 0.86, 0.87, 0.88, 0.89, 0.90, 0.91, 0.92, 0.93, 0.94, 0.95, inclusive, or even higher) at a wavelength of about 6 microns, and a solar absorptivity of less than 0.3 (e.g., 0.29, 0.28, 0.27, 0.26, 0.25, 0.24, 0.23, 0.22, 0.21, 0.20, 0.15, 0.10, inclusive, or even lower) at a wavelength of less than 2.5 microns at an operating temperature of about 200 degrees Celsius. In some embodiments, the outer coating 130 may be configured to cause a reduction in operating temperature of the conductor 100 at a particular current in a range of about 5 degrees Celsius to about 40 degrees Celsius, inclusive (e.g., 5, 6, 7, 8, 9, 10, 12, 14, 16, 18, 20, 25, 30, 35, or 40 degrees Celsius, inclusive), as described herein. The coating 130 may include microstructures and nanoporosities, and may be formed from any suitable material, as described herein. In some embodiments, the outer coating 130 may additionally, or alternatively be formulated to have an erosion resistance that is at least 5% greater than an erosion resistance of aluminum or aluminum alloys (e.g., an erosion resistance that is at least about 100% greater than the erosion resistance of aluminum or aluminum alloys.). In some embodiments, the outer coating 130 may have a Vicker hardness of greater than 200.

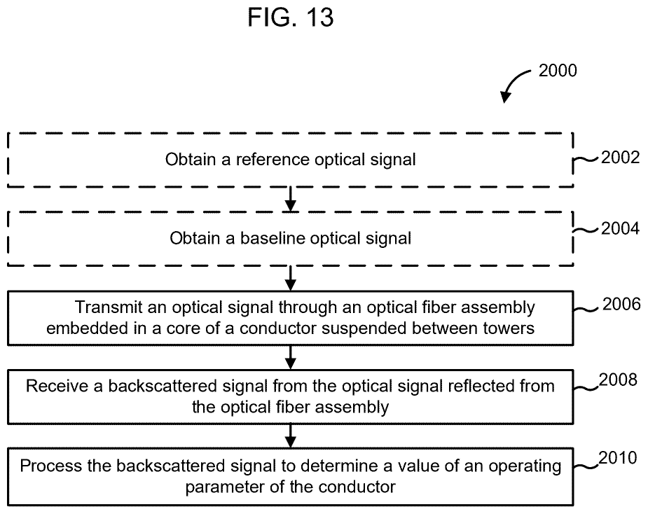

FIG. 13 is a schematic flow chart of a method 2000 for determining and/or continuously monitoring an operating parameter of conductor (e.g., the conductor 100, 200, 300, 400, 500, 700a, 700b) including a strength member (e.g., the strength member 110, 210, 310, 410, 510, 710a, 710b) that includes a composite core (e.g., the core 112, 212, 312, 412, 512, 712a, 712b) having an optical fiber assembly (e.g., the optical fiber assembly 150, 250, 350, 450, 550, 750a, 750b) disposed in the composite core and an encapsulation layer (e.g., the encapsulation layer 114, 214, 314, 414, 514, 714a, 714b) disposed around the composite core, and a conductor layer (e.g., the conductor layer 120, 220, 320, 420, 520, 720a, 720b) disposed around the strength member, according to an embodiment. While the method 2000 is described with respect to the conductor 100, this should not be construed as limiting the disclosure and various operations of the method 2000 may be used to form any conductor including a composite core and an optical fiber assembly disposed in the composite core, as described herein.

The method 2000 includes transmitting an optical signal through the optical fiber assembly 150 included in the conductor 100, at operation 2006. For example, in some embodiments, the method 2000 may include transmitting the optical signal through the optical fiber assembly 150 embedded in the core 112 of the conductor 100, for example, suspended between towers, at operation 2006. In some embodiments, the method 2000 may further include obtaining a reference optical signal from the optical fiber assembly 150, at operation 2002, prior to operation 2006. In some embodiments, the method 2000 may also include obtaining a baseline optical signal based on an optical signal transmitted into the optical fiber assembly 150 to the backscattered signal from the optical fiber assembly 150, at operation 2004, prior to operation 2006. The method 2000 further includes receiving a backscattered signal from the optical signal reflected from the optical fiber assembly, at operation 2008. The method 2000 further includes processing the backscattered signal from the optical fiber assembly, at operation 2010, to determine a value of an operating parameter of the conductor.

The method 2000 may optionally include obtaining a reference optical signal (i.e., reference signal) from the optical signal backscattered from the optical fiber assembly prior to the conductor being disposed in the field (e.g., outside of a manufacturing factory). In some embodiments, obtaining a reference optical signal can include sending a light signal into an optical fiber and then using the light that is scattered back from a portion of the conductor length and temperature of which is known to establish a reference signal.

The method 2000 may optionally include obtaining a baseline optical signal from the optical signal backscattered from the optical fiber assembly immediately after the conductor is initially installed in the field. In some embodiments, the baseline optical signal can obtained within three days after disposing the conductor in the field.

The transmitting the optical signal into the optical fiber assembly 150 (e.g., at operation 2006) may include sending a pulsed light or a continuous-wave light to the optical fiber assembly 150 with a light source. The transmitting, at operation 2006, can include the transmitting the optical signal into the optical fiber assembly 150 from a narrowband light source or a broadband light source. Operation 2006 may include providing a source of electromagnetic radiation having a wavelength in the range of about 300 nm to about 600 nm. In some embodiments, the transmitting the optical signal at operation 2006, may include transmitting the optical signal through the optical fiber assembly 150 to a selected location within the fiber core (e.g., fiber core 152) or cladding layer (e.g., cladding layer 153) such that the delivered electromagnetic radiation may get altered by the fiber core (e.g., fiber core 152) or cladding layer (e.g., cladding layer 153) to create at least one backscattered signal at the selected location. In some embodiments, the transmitting may include splitting a first portion of the light along a first optical path and a second portion of the light along a second optical path. In some embodiments, the first optical path may extend through a fiber core including at least one FBGs. In some embodiments, the second optical path may extend through a cladding layer of the optical fiber assembly 150. This may allow use of a multi-modal interrogator (e.g., including at least one of DTS, FBG, or DSS) by using a single mode fiber, thereby increasing accuracy of measurement while reducing the cost.

In some embodiments, the transmission of the optical signal into the optical fiber assembly 150 is continuous, thereby allowing in-situ continuous monitoring of the change in the value of the operating parameter of the conductor 100.

At operation 2008, a backscattered signal is received from the optical signal reflected from the optical fiber assembly 150. In some embodiments, the received backscattered signal may include at least one of a Rayleigh backscattered signal, a Brillouin backscattered signal, and/or a Raman backscattered signal. In some embodiments, the backscattered signal may be received from a controller (e.g., any of controllers 570, 570a, 570b as described with respect to FIGS. 5-6, 9, and 10A-B) that is communicatively coupled to the optical fiber assembly 150. In some embodiments, the backscattered signal may be received via an optical receiver (e.g., any of the receivers as described herein). In some embodiments, the optical receiver may include at least one of an optical switch (e.g., optical switch 571), an optical coupler (e.g., optical coupler 964), a communication fiber (e.g., communication fiber 32), a controller (e.g., controllers 570, 570a, 570b), any of the receivers described herein (e.g., first receiver, second receiver), or a combination thereof.

At operation 2010, the backscattered signal is processed to determine a value or change in a value of an operating parameter of the conductor 100. The processing can include processing the backscattered signal to determine a value of at least one of temperature, strain, length, or sag of the conductor 100, as described herein. The processing of the backscattered signal can be performed by the controller 570 described above with respect to multiple embodiments. The processing of the backscattered signal can include determining at least one of: a change in strain distribution along a pre-determined length of the optical fiber assembly based on the received backscattered signal, or a change in temperature distribution along a pre-determined length of the optical fiber assembly based on the received backscattered signal. In some embodiments, the determined change in strain distribution is representative of a corresponding change in strain distribution of the conductor 100. In some embodiments, the determined change in temperature distribution is representative of a corresponding change in temperature distribution of the conductor 100. In some embodiments, the value of the parameter may be a first value of the parameter. In such embodiments, the method 2000 may optionally include modifying the parameter, via the controller (e.g., controller 570), from the first value to a second value different from the first value. For example, in some embodiments, the parameter may be a first temperature in the conductor 100, and the controller may be configured to selectively modify a current in the conductor 100 so as to modify the first temperature to a second temperature different from the first temperature. In some embodiments, the second temperature may be less than the first temperature.

In some embodiments, the processing of the backscattered signal may include measuring the conductor's 100 total arc length (from dead-end to dead-end), each tower's location, arc length, temperature, and strain for each span using at least one of DSS, DTS, FBG interrogation systems.

The method 2000 may further include comparing a reference optical signal and/or baseline optical signal with the received backscattered signal. In some embodiments, the reference optical signal and/or baseline optical signal can be representative of a strain of a pre-determined length the conductor 100. In some embodiments, the reference optical signal and/or baseline optical signal can be representative of a temperature of a pre-determined length the conductor 100. In some embodiments, the reference optical signal may be obtained after manufacturing of the conductor 100 but before the conductor 100 is deployed in the field, for example, to determine an initial length, temperature, and/or strain of the conductor 100. In some embodiments, the baseline optical signal may be obtained immediately after deploying the conductor 100 in the field, for example, to set baseline measurements of initial length, temperature, strain, and/or sag of the conductor 100 against which future measurements can be compared.

In some embodiments, the method 2000 may further include a method for the monitoring and management of conductors' status, which may include pre-testing the conductor (e.g., conductor 100) at the factory using a high-end, well-calibrated techniques including at least one of DSS, DTS, or FBG interrogation methods to determine the conductor's length and strain at factory room temperature. Upon initial installation of the conductor (e.g., conductor 100) in the field, a similar interrogation system can be employed to measure at least one of total arc length, the location of each tower, arc length, temperature, or strain of the conductor for each span of the conductor. In some embodiments, a hybrid DTS+FBG interrogation system can then be permanently installed in the field. This system can measure the temperature profile over each arc length, particularly where FBGs are located, and the wavelength shift for each span. It can calculate the strain change for each span, followed by the arc length change, and subsequently, the sag change. In some embodiments, the method can continuously measure temperature and strain changes, enabling in-situ continuous monitoring of conductors, temperature profiles, and sag changes. In some embodiments, the collected data can then be communicated to a central control room via long-distance WIFI or LTE, or even via the optical fiber in the Optical Ground Wire (OPGW). The method can provide a robust and comprehensive solution for conductor monitoring and management, enhancing the efficiency and reliability of the system.

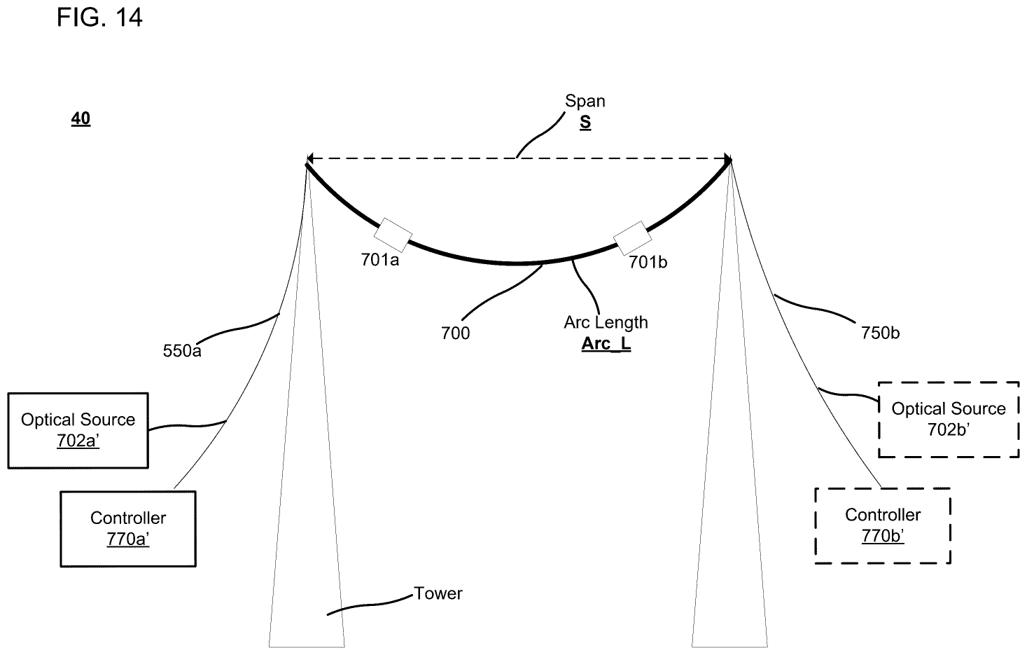

FIG. 14 is schematic of a system 40, according to an embodiment. As shown, the system 40 includes an overhead transmission line 700 that carries electric power along its arc length Arc_L between two electrical towers. In some embodiments, the overhead transmission line 700 is same or substantially similar to the conductor 500 described above. The system 40 further includes the optical fiber assembly 550 (not shown) that is included in the systems of FIGS. 5, 6, and 9, according to an embodiment. The system 40 further includes a first optical source 702a′ and a first controller 770a′ (e.g., the first controller 570a described with respect to FIG. 10A) communicatively coupled to a first end 750a of the optical fiber assembly 750. In some embodiments, the system 40 may optionally include a second optical source 702b′ and a second controller 770b′ (e.g., the second controller 570b described with respect to FIG. 10A) communicatively coupled to a second end 750b of the optical fiber assembly 550. The system 40 further includes a first FBGs 501a and a second FBGs 701b disposed along the arc length of the overhead transmission line 700 with a pre-determined space therebetween.

In some embodiments, the second optical source 702b′ and the second controller 770b′ may act as backup such that in case the overhead transmission line 700 gets broken at a certain location, the optical fiber assembly 550 can be interrogated from the other end without the need for slicing the optical fiber.

Conducting electricity causes the overhead transmission line 700 to heat up and, in turn, sag. This sagging can violate the line's clearance requirement and cause outages. Accordingly, in some embodiments, the method 2000 described with respect to FIG. 13 can be applied to the system 40 to determine at least one of sag, arc length, or span (i.e., distance between two electrical towers) of the conductor 700 for transmission line health monitoring, vegetation management, and the like.

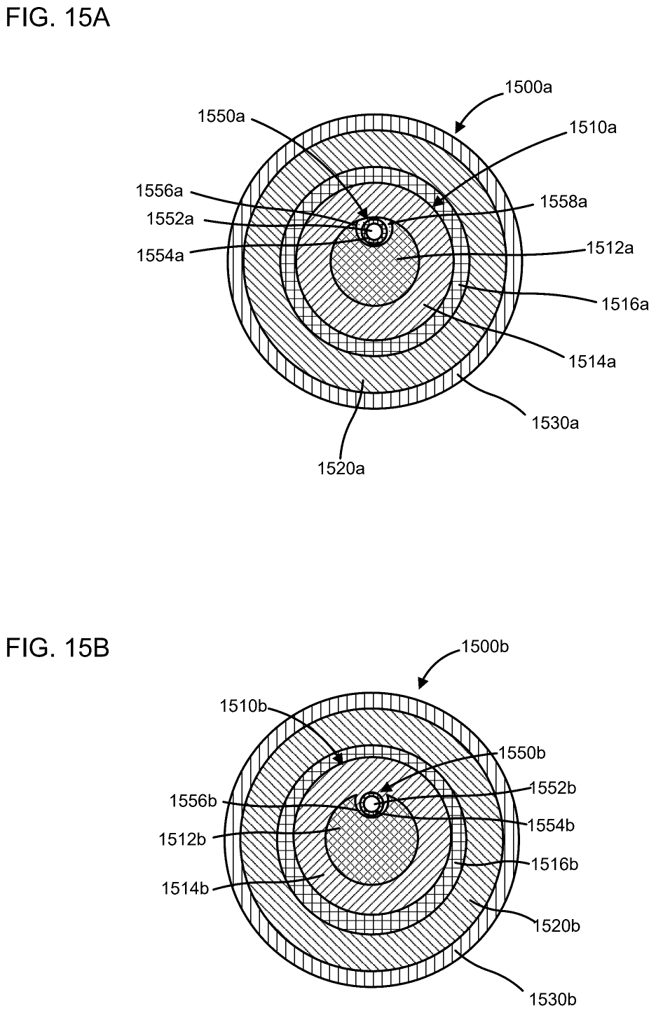

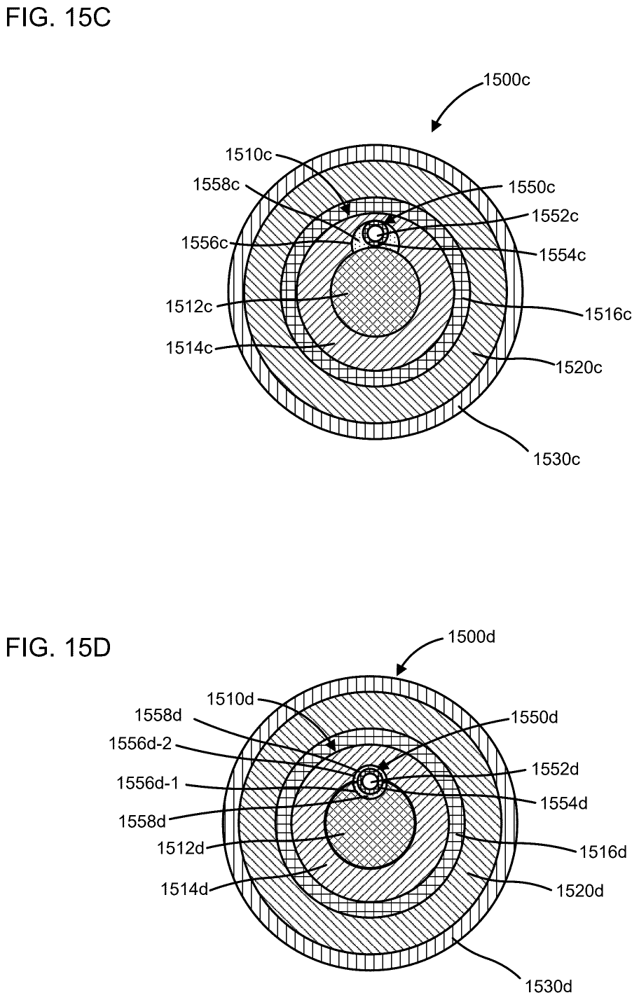

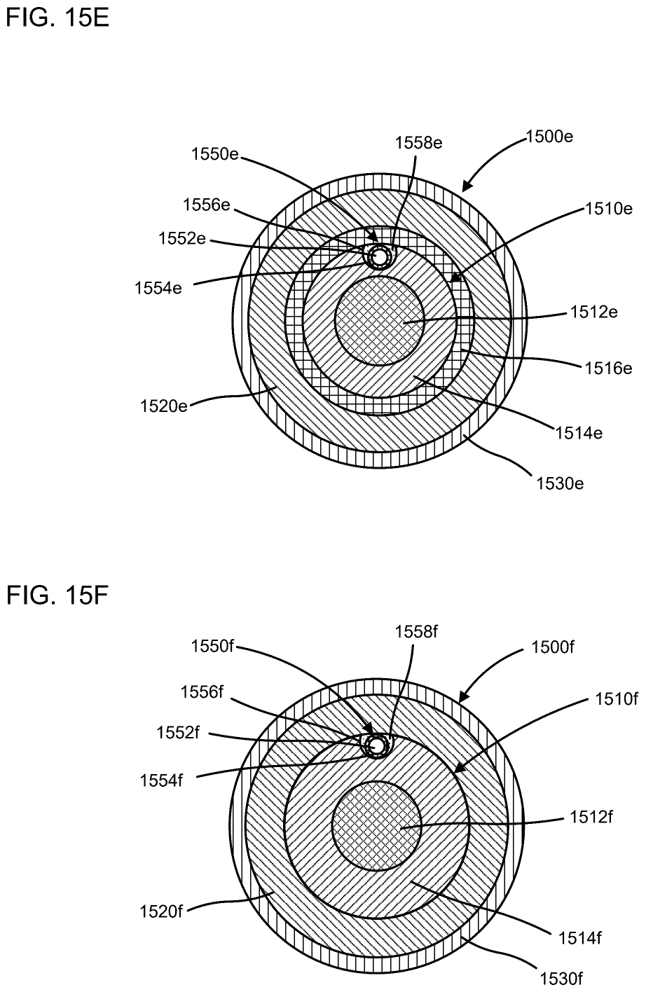

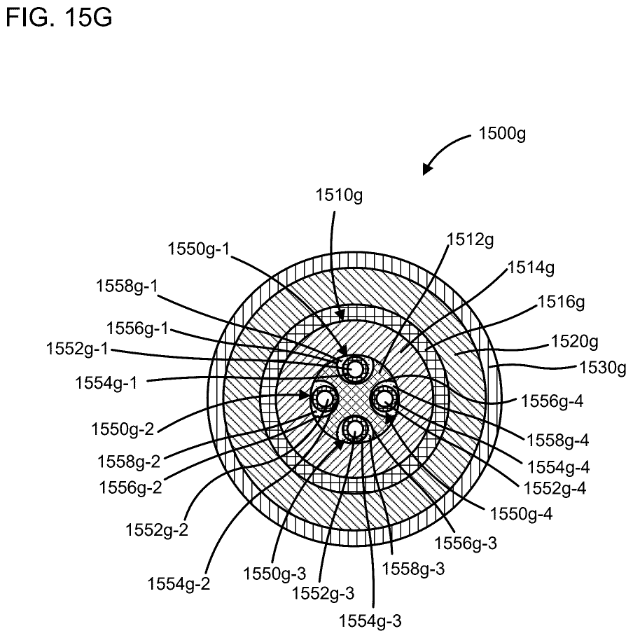

FIG. 15A-G display schematic illustrations of several conductors including grooves for optical fiber assemblies, according to various embodiments. FIGS. 15A-G display conductors 1500a, 1500b, 1500c, 1500d, 1500e, 1500f, and 1500g, respectively, (collectively referred to as “conductors 1500”) including strength members 1510a, 1510b, 1510c, 1510d, 1510e, 1510f, and 1510g (collectively referred to as “strength members 1510”), respectively. The strength members 1510 each include a core 1512a, 1512b, 1512c, 1512d, 1512e, 1512f, and 1512g (collectively referred to as “cores 1512”), respectively and an encapsulation layer 1514a, 1514b, 1514c, 1514d, 1514e, 1514f, and 1514g (collectively referred to as “encapsulation layers 1514”), respectively.

In some embodiments, the conductors 1500 may each include a corresponding inner coating 1516a, 1516b, 1516c, 1516d, 1516e, and 1516g (collectively referred to herein as “inner coatings 1516”), respectively, for example, around each of the strength members 1510. In some embodiments, the conductors 1500 may each include a corresponding conductor layer 1520a, 1520b, 1520c, 1520d, 1520e, 1520f, and 1520g (collectively referred to as “conductor layers 1520”), respectively. In some embodiments, the conductors 1500 may each include a corresponding outer coating 1530a, 1530b, 1530c, 1530d, 1530e, 1530f, and 1530g (collectively referred to herein as “outer coatings 1530”), respectively, for example, disposed on the conductor layers 1520.

In some embodiments, the conductors 1500 may each include a corresponding optical fiber assembly 1550a, 1550b, 1550c, 1550d, 1550e, 1550f, 1550g-1, 1550g-2, 1550g-3, and 1550g-4 (collectively referred to as “optical fiber assemblies 1550”), respectively. In some embodiments, the optical fiber assemblies 1550 may each include a corresponding fiber core 1552a, 1552b, 1552c, 1552d, 1552e, 1552f, 1552g-1, 1552g-2, 1552g-3, and 1552g-4 (collectively referred to as “fiber cores 1552”) and a corresponding fiber encapsulation layer 1554a, 1554b, 1554c, 1554d, 1554e, 1554f, 1554g-1, 1554g-2, 1554g-3, and 1554g-4 (collectively referred to as fiber encapsulation layers 1554”), respectively, for example, around each of the fiber cores 1552. In some embodiments, the conductors 1500 may each include one or more grooves 1556a, 1556b, 1556c, 1556d-1, 1556d-2, 1556e, 1556f, 1556g-1, 1556g-2, and 1556g-3, and 1556g-4 (collectively referred to as “grooves 1556”), respectively, for example, configured to contain each of the optical fiber assemblies 1550. In other words, in some embodiments, the optical fiber assemblies 1550 may be disposed in the grooves 1556. In some embodiments, the grooves 1556 may each optionally include a binding material 1558a, 1558c, 1558d, 1558e, 1558f, 1558g-1, 1558g-2, 1558g-3, and 1558g-4, respectively.

In some embodiments, each of the conductors 1500, the strength members 1510, the cores 1512, the encapsulation layers 1514, the inner coatings 1516, the conductor layers 1520, the outer coatings 1530, the optical fiber assemblies 1550, the fiber cores 1552, and/or the fiber encapsulation layers 1554 may be substantially the same as the conductors 100, 200, 300, 400, the strength members 110, 210, 320, 410, the cores 112, 212, 312, 412, the encapsulation layers 114, 214, 314, 414, the inner coatings 116, 316, the conductor layers 120, 220, 320, 420, the outer coatings 130, 230, 330, 430, the optical fiber assemblies 150, 250, 350, 450, the fiber cores 152, 252, 352, 452, and/or the fiber encapsulation layers 154, 254, 354, 454, respectively, as described herein with respect to FIGS. 1A-D, 2, 3, and/or 4. Therefore, certain features of the conductors 1500, the strength members 1510, the cores 1512, the encapsulation layers 1514, the inner coatings 1516, the conductor layers 1520, the outer coatings 1530, the optical fiber assemblies 1550, the fiber cores 1552, and/or the fiber encapsulation layers 1554 are not described in further detail herein.

In some embodiments, the grooves 1556 may each include a plurality of surfaces (“surfaces”), and an inner volume defined by the surfaces. In some embodiments, the inner volume may be configured to contain (e.g., hold, include, etc.) the optical fiber assemblies 1550 therein. In some embodiments, the inner volume may be at least partially enclosed via the surfaces. In some embodiments, at least one the surfaces of the grooves 1556 may include a curved surface, a straight surface, an asymmetric surface, or a combination thereof. In some embodiments, the grooves 1556 may include notches, depressions, channels, indentations, or any suitable cavity configured to receive at least a portion of an optical fiber assembly 1550.

In some embodiments, the grooves 1556 may each define any suitable shape. For example, in some embodiments, the grooves 1556 may each at least partially define a polygon, such as a triangle, a quadrilateral (e.g., a rectangle, a square, a kite, a diamond, a parallelogram, a trapezium, a trapezoid, etc.), a pentagon, a hexagon, a heptagon, an octagon, a nonagon, a decagon, any other suitable shape including a planar surface and/or a curved surface, or a combination thereof. In some embodiments, the grooves 1556 may each at least partially define a round shape, for example, a circle, a semi-circle, an oval, an ellipse, or any other suitable shape including a round surface, or combination thereof. In some embodiments, the grooves 1556 may define a symmetrical shape or an asymmetrical shape. In some embodiments, the grooves 1556 may define any suitable shape configured to contain the optical fiber assemblies 1550. For example, in some embodiments, the grooves 1556 may be shaped to conform to a shape of the optical fiber assemblies 1550. For example, in some embodiments, if the optical fiber assemblies 1550 define a round shape (e.g., circular, semi-circular, etc.), the groove 1556 may also define a round shape (e.g., circular, semi-circular, etc.), for example, such that the optical fiber assemblies 1550 may couple (e.g., match, fit, matingly couple) with the grooves 1556.

In some embodiments, the grooves 1556 may at least partially define a shape including at least one of a triangle, a semi-circle, or a rectangle. In some embodiments, the optical fiber assemblies 1550 may contact (e.g., abut) at least a portion of the grooves 1556. In some embodiments, the grooves 1556 may substantially encapsulate the optical fiber assemblies 1556. In other words, in some embodiments, the groove 1556 may be configured to contain the optical fiber assembly 1550 such that there is a substantially gap-free fit between the groove 1556 and the optical fiber assembly 1550. Without being bound by theory, matching the shapes of the grooves 1556 with the optical fiber assemblies 1550 may protect the optical fiber assemblies 1550 from mechanical damage due to excessive movements and/or vibrations as the optical fiber assemblies 1550 will be inhibited from moving during the manufacturing and/or operation of the conductors 1500.

In some embodiments, the optical fiber assemblies 1550 may have a first cross-sectional area, and the grooves 1556 may have a second cross-sectional area greater than the first cross-sectional area, for example, such that the optical fiber assemblies 1550 may be substantially contained within the grooves 1556.

In some embodiments, the grooves 1556 may have any suitable groove depth, size, and/or shape. In some embodiments, the grooves 1556 may have a substantially consistent groove depth, size, and/or shape along a length thereof. In some embodiments, the groove depth, size, and/or shape of the grooves 1556 may vary along a length thereof. In some embodiments, the groove depth, size, and/or shape of the grooves 1556 may vary to accommodate various sizes and/or shapes of the optical fiber assemblies 1550 (which may have any suitable diameter, size and/or shape) and/or may vary to accommodate various applications of the conductors 1500 (e.g., splicing applications, dead-end applications, etc.). All such variations are envisioned herein and should be considered as part of the present disclosure. In some embodiments, the grooves 1556 may have a cross-sectional width (e.g., radius or diameter) that corresponds to an outer cross-sectional width (e.g., outer radius or diameter) of the optical fiber assemblies 1550 disposed therewithin such that the optical fiber assemblies 1550 are snugly disposed within the corresponding one of the grooves 1556.

In some embodiments, the groove depth of the grooves 1556 may be equal to or greater than a diameter of the optical fiber assemblies 1550, for example, such that the optical fiber assemblies 1550 are disposed substantially within the grooves 1556. In some embodiments, the groove depth of the grooves 1556 may be less than a diameter of the optical fiber assemblies 1550, for example, such that a portion of the optical fiber assemblies 1550 protrudes or is disposed outside of the corresponding one of the grooves 1556. In such embodiments, conductors 1500 may include a first groove in the cores 1512, the optical fiber assemblies 1550 being disposed at least partially in the first groove, and a second groove in the encapsulation layers 1514 aligned with the first groove so as to substantially enclose the optical fiber assemblies 1550.

In some embodiments, each of the grooves 1556 may be included in at least one of the cores 1512 or the encapsulation layers 1514 for each of the respective conductors 1500. For example, in some embodiments, the grooves 1556 may be defined (e.g., mechanically formed, cut, engraved, impressed, inscribed, scraped, etc.) in at least one of the cores 1512 or the encapsulation layers 1514. In some embodiments, the grooves 1556 may be included (e.g., defined) in the cores 1512 of each of the conductors 1500. In some embodiments the grooves 1556 may be included (e.g., defined) in the encapsulation layers 1514 of each of the conductors 1500. In some embodiments, the grooves 1556 may be defined at an interface between the cores 1512 and the encapsulation layers 1514 in the conductors 1500. In some embodiments, the grooves 1556 may be defined at a peripheral (e.g., outer) surface of the cores 1512, and inner surface of the encapsulation layers 1514, a peripheral (e.g., outer) surface of the encapsulation layers 1514, or a combination thereof. In some embodiments, the grooves 1556 may extend from a first axial end to a second axial end of at least one of the cores 1512 or the encapsulation layers 1514.

In some embodiments, each of the conductors 1500 may include a plurality of grooves 1556, for example, one or more grooves 1556 defined in the cores 1512 and/or the encapsulation layers 1514. In some embodiments, each of the cores 1512 and the encapsulation layers 1514 may include corresponding grooves 1556 defined therein. Without being bound by theory, including grooves 1556 in both the cores 1512 and encapsulation layers 1514 may aid in alignment during manufacturing of the conductors 1500.

In some embodiments, the grooves 1556 may be defined in the cores 1512, and the encapsulation layers 1514 may be configured to at least partially encase the optical fiber assemblies 1550 in the grooves 1556, for example, to protect the optical fiber assemblies 1550 from physical damage or chemical damage. However, in some embodiments, the optical fiber assemblies 1550 may be substantially enclosed by the grooves 1556, the cores 1512, and/or the binding material 1558, such that the optical fiber assemblies 1550 may be substantially isolated (e.g., not in physical contact with) the encapsulation layers 1514. In other words, in some embodiments, the encapsulation layers 1514 may, or may not, be in direct contact with the optical fiber assemblies 1550.

In some embodiments, the grooves 1556 may be formed during formation of the conductors 1500. For example, in some embodiments, the grooves 1556 may be formed by embedding the optical fiber assemblies 1550 in at least one of the cores 1512 or the encapsulation layers 1514. In some embodiments, the grooves 1556 may be mechanically formed (e.g., cut, engraved, impressed, inscribed, scraped, etc.) into at least one of the cores 1512 or the encapsulation layers 1514. In some embodiments, the grooves 1556 may be formed during a pultrusion process using a die having a predetermined shape, for example, so as to create the grooves 1556 during the pultrusion or extrusion of the core and/or encapsulation layer having the predetermined shape.

In some embodiments, the grooves 1556 may at least partially contain (e.g., hold, include) each of the optical fiber assemblies 1550. In some embodiments, the optical fiber assemblies 1550 may be disposed in the grooves. In some embodiments, the grooves 1556 may include a cross-sectional area greater than a cross-sectional area of the optical fiber assemblies 1550, for example, such that the optical fiber assemblies 1550 may be disposed in the grooves 1556 substantially without the optical fiber assemblies 1550 protruding (e.g., extending) outside of the grooves 1556. In some embodiments, a portion of the optical fiber assemblies 1550 may extend outside an outer boundary of the grooves 1556. In some embodiments, the optical fiber assemblies 1550 may contact (e.g., abut) a surface of the grooves 1556.

In some embodiments, the grooves 1556 may be substantially larger than the optical fiber assemblies 1550 such that the grooves 1556 include a free volume, for example, on at least one side of the optical fiber assemblies 1550 when the optical fiber assemblies 1550 are disposed in the grooves 1556. In some embodiments, the grooves 1556 may include free volume after disposing the optical fiber assembly therein 1556. In some embodiments, the free volume in the grooves 1556 may include a material, which may substantially fill the free volume. For example, in some embodiments, the free volume of the grooves 1556 may include the binding material 1558 disposed therein.

In some embodiments, the free volume of the grooves 1556 may include a material from an adjacent layer in the conductors 1500. For example, in some embodiments, if the optical fiber assemblies 1550 are disposed in the grooves 1556 defined in the cores 1512, a portion of material from the encapsulation layers 1514 may be included (e.g., embedded, incorporated, projected) in the grooves 1556, or vice versa. In such embodiments, the optical fiber assemblies 1550 may be substantially surrounded (e.g., encapsulated) by material from at least one of the cores 1512 and/or the encapsulation layers 1514. Without being bound by theory, including material from the adjacent layer in the grooves 1556 to substantially encapsulate the optical fiber assemblies 1550 may protect the optical fiber assemblies 1550 from mechanical damage due to excessive movements and/or vibrations as the optical fiber assemblies 1550 will be inhibited from moving during the manufacturing and/or operation of the conductors 1500.

In some embodiments, the grooves 1556 may include the binding material 1558. In some embodiments, the binding material 1558 may be configured to inhibit movement of the optical fiber assemblies 1550 in the grooves 1550. In some embodiments, the binding material 1558 may include an adhesive or a glue, such as a high-temperature adhesive or a high-temperature glue (i.e., adhesives or glues configured to remain substantially intact at an operating temperature of the conductors 1500 (e.g., operating temperatures in a range of about 90 degrees Celsius to about 250 degrees Celsius, inclusive)). In other words, in some embodiments, the optical fiber assemblies 1550 may be held in place in the grooves 1556 via the binding material 1558 including glue and/or adhesive (e.g., high temperature adhesive tape).

In some embodiments, the binding material 1558 may be configured to flow in an uncured state so as to substantially fill the free volume of the grooves 1556 and substantially encapsulate the optical fiber assemblies 1550. In some embodiments, the binding material 1558 may be configured to cure so as to harden around the optical fiber assemblies 1550 in the grooves 1550, for example, to inhibit movement of the optical fiber assemblies 1550 in the grooves. In some embodiments, the binding material 1558 may include any suitable material configured to fill the free volume of the grooves 1556 (e.g., the volume around the optical fiber assembly 1550 disposed therein) and inhibit movement and/or vibration of the optical fiber assemblies 1550 during manufacturing and/or operation of the conductors 1500.

For example, in some embodiments, the binding material 1558 may include silicone, such as room-temperature-vulcanizing (RTV) silicone. In some embodiments, the binding material 1558 may include a ultraviolet (UV) light curable monomer, oligomer, and/or polymer. In some embodiments, the binding material 1558 may include polydimethylsiloxane (PDMS). In some embodiments, the binding material 1558 may include at least one of an epoxy, a polyurethane, or a cyanoacrylate. In some embodiments, the binding material 1558 may include a first portion including a curable material (e.g., epoxy, polyurethane, silicone) and a second portion including a curing agent that is configured to cure the curable material.

In some embodiments, the binding material 1558 may include any suitable monomer, oligomer, polymer, co-polymer, derivatives thereof, or a combination thereof. Without being bound by theory, including the binding material 1558 in the grooves 1556 around the optical fiber assemblies 1550 may inhibit the optical fiber assemblies 1550 from moving and/or vibrating (e.g., may damp vibrations) during the manufacturing and/or operation of the conductors 1500, and, consequently, may protect the optical fiber assemblies 1550 from mechanical damage.

In some embodiments, the optical fiber assemblies 1550 may be pre-tensioned, for example, prior to, during, and/or after disposal in the grooves 1556. For example, in some embodiments, a tension force (e.g., pulling force) may be applied to the optical fiber assemblies 1550 prior to, during, and/or after disposal of the optical fiber assemblies 1550 in the grooves 1556, for example, to reduce slack and/or substantially straighten the optical fiber assemblies 1550. In some embodiments, the tension force may be applied along a central axis of the optical fiber assemblies 1550. In some embodiments, the tension force may be applied to the optical fiber assemblies 1550 prior to and/or substantially simultaneously (e.g., contemporaneously, concurrently, etc.) with disposing (e.g., embedding, bonding) the optical fiber assemblies 1550 in the strength members 1510, for example, in at least one of the cores 1512 or the encapsulation layers 1514.

In some embodiments, the tension force may be in a range of about 10 grams to about 100 grams (g), inclusive of all values and ranges therebetween. For example, in some embodiments, the tension force may be at least about 10 g, at least about 15 g, at least about 20 g, at least about 25 g, at least about 30 g, at least about 35 g, at least about 40 g, at least about 45 g, at least about 50 g, at least about 55 g, at least about 60 g, at least about 65 g, at least about 70 g, at least about 75 g, at least about 80 g, at least about 85 g, at least about 90 g, or at least about 95 g. In some embodiments, the tension force may be no more than about 100 g, no more than about 95 g, no more than about 90 g, no more than about 85 g, no more than about 80 g, no more than about 75 g, no more than about 70 g, no more than about 65 g, no more than about 60 g, no more than about 55 g, no more than about 50 g, no more than about 45 g, no more than about 40 g, no more than about 35 g, no more than about 30 g, no more than about 25 g, no more than about 20 g, or no more than about 15 g. Combinations of the above-referenced tension forces are also possible (e.g., at least about 10 g and no more than about 100 g, or at least about 20 g and no more than about 50 g), inclusive of all values and ranges therebetween. For example, in some embodiments, the tension force may be about 20 g, about 25 g, about 30 g, about 35 g, about 40 g, about 45 g, or about 50 g, inclusive.

Without being bound by theory, pre-tensioning the optical fiber assemblies 1512, for example, by applying the tension force to the optical fiber assemblies 1550 prior to and/or simultaneously with disposing the optical fiber assemblies 1550 in the grooves 1556, may advantageously reduce slack and/or straighten the optical fiber assemblies 1550 in the grooves 1556 and improve sensitivity of the optical fiber assemblies 1550 to one or more operational parameters (e.g., stress, strain, sag, temperature, etc.) of the conductors 1500, for example, during operation of the conductors 1500. For example, in such embodiments, the optical fiber assemblies 1550 may advantageously provide higher sensitivity (e.g., higher resolution) signals of stresses or strains during operation of the conductors 1500, for example, caused by sag of the conductors 1500. In some embodiments, the optical fiber assemblies 1550 may advantageously enable higher accuracy for calculations and predictions of the sag of the conductors 1500, for example, from remote locations.

In some embodiments, pre-tensioning the optical fiber assemblies 1550 may compensate for compression experienced by the optical fiber assemblies 1512 during operation of the conductor 1500, for example, due to sagging of the conductor. For example, a portion of the conductor located a higher elevation with respect to a central axis of the conductor 1512 (e.g., the central axis that passes through the core 1512) may be in compression, and one or more of the optical fiber assemblies 1550 may be disposed in this region or area of the conductor 1500 (e.g., the core 1512 or encapsulation layer 1514). In such embodiments, the pre-tensioning of the optical fiber assemblies 1550 may be configured to compensate for the compression experienced during operation, which may advantageously reduce micro-bending and related optical signal losses.

In some embodiments, the optical fiber assemblies 1550 may be substantially free of tension (i.e., slack), for example, prior to and/or after disposal in the grooves 1556. In other words, in some embodiments, the optical fiber assemblies 1550 may be disposed (e.g., laid, embedded) in the grooves 1556 while in tension or slack (i.e., substantially free of tension).

In some embodiments, the optical fiber assemblies 1550 may extend at least partially beyond a first end or a second end of the grooves 1556 and/or the conductors 1500 (e.g., at least partially beyond the cores 1512, encapsulation layers 1514, or the conductor layers 1520). In such embodiments, a portion of the optical fiber assemblies 1550 may be passed or extended through an aperture (e.g., in the conductors 1500) and/or communicated to a dead-end hardware, for example, to allow connection to external interrogation equipment.

In some embodiments, the binding material 1558 may be configured to release from the optical fiber assemblies 1550. In other words, in some embodiments, the binding material 1558 may be configured to peel away from the optical fiber assemblies 1550 so as to enable the optical fiber assemblies 1550 to be extracted (e.g., removed, retrieved) from the grooves 1556, for example, during or after formation of the conductors 1500. In some embodiments, the optical fiber assemblies 1550 may be configured to peel away or out of the binding material 1558, for example, after curing of the binding material 1558. In some embodiments, the binding material 1558 may include a material configured to provide a shock absorbing cushion for the optical fiber assembly while having a weak adhesive force (e.g., PDMS, glue, adhesive tape), for example, such that the optical fiber assemblies 1550 may be easily retrieved after insertion into the grooves 1556. Without being bound by theory, using the binding material 1558 configured to release from the optical fiber assemblies 1550 may enable the optical fiber assemblies 1550 to be easily retrieved during or after formation and/or operation of the conductor 1500 while maintaining the structural and/or optical integrity of the optical fiber assemblies 1550 such that they may be reused in other devices and/or reliably connected to other equipment (e.g., interrogation equipment). In other words, in some embodiments, the binding material 1558 may enable retrieval of the optical fiber assemblies 1558 without damage to the optical fiber assemblies 1558. This may be beneficial when a portion of the conductor layer 1520 is peeled back from an axial end of the conductor 1500, for example, to splice the conductor 1500 to another conductor or to couple to a dead end coupler. In such embodiments, providing an easily removable binding material 1558 may facilitate extraction of at least a portion of the optical fiber assemblies 1550 disposed therewithin, for example, to couple to an optical coupler or a controller.

In some embodiments, the grooves 1556 may be substantially free of the binding material 1558. In other words, in some embodiments, the optical fiber assemblies 1550 may be disposed in the grooves 1556 with or without the binding material 1558.

As shown in FIG. 15A, in some embodiments, the groove 1556a may be defined in the core 1512a, such as in an outer surface of the core 1512a. In some embodiments, the optical fiber assembly 1556a may be disposed in the groove 1556a and substantially encapsulated by the binding material 1558a. As shown, in some embodiments, the groove 1556a may define a semi-circular shape. Without being bound by theory, in some embodiments, including the groove 1556a in the core 1512a may be beneficial for minimizing bending of the optical fiber assemblies 1550a so as to minimize micro-bending induced optical energy transmission losses, for example, such that the micro-bending induced optical energy transmission losses may be equal to or less than about 5 dB/km.

As shown in FIG. 15B, in some embodiments, the groove 1556b may be defined in an outer surface of the core 1512b, and the optical fiber assembly 1556b may be disposed in the groove 1556b. In some embodiments, the groove 1556b may include free space around the optical fiber assembly 1550b. As shown in some embodiments, material from the encapsulation layer 1514b may substantially fill the free space around the optical fiber assembly 1550b. Without being bound by theory, such embodiments may enable intimate (e.g., substantially gap-free) contact between the core 1512b, the encapsulation layer 1514b, and the optical fiber assembly 1550b so as to minimize movement and/or vibration of the optical fiber assembly 1550b in the groove 1556b. Furthermore, in such embodiments, the groove 1556b may be substantially free of binding material. In other words, such implementations may enable the optical fiber assembly 1550b to be disposed in the groove substantially without gaps and/or additional materials to fill in the gaps.

As shown in FIG. 15C, in some embodiments, the groove 1556c may be defined in an internal surface of the encapsulation layer 1514c, and the optical fiber assembly 1556c may be disposed in the groove 1556c in the encapsulation layer 1514c. As shown, in some embodiments, the binding material 1558c may be disposed in the groove 1556c, however, in some embodiments, the groove 1556c may be substantially free of the binding material 1558c. In some embodiments, a portion of material of the core 1512c may protrude into the groove 1556c so as to substantially encapsulate the optical fiber assembly 1556c, as described herein.

As shown in FIG. 15D, in some embodiments, a first groove 1556d-1 may be defined in the core 1512d (e.g., in an outer surface of the core 1512d), and a second groove 1556d-2 may be defined in the encapsulation layer 1514d (e.g., in an inner surface of the encapsulation layer 1514d). In some embodiments, the first groove 1556d-1 and the second groove 1556d-2 may each form a half of a shape (e.g., semi-circle). In some embodiments, the first groove 1556d-1 and the second groove 1556d-2 may be aligned so as to form a complete shape (e.g., circle). In such a manner, the first groove 1556d-1 and the second groove 1556d-2 may serve as alignment tools (e.g. alignment aids) during manufacturing of the conductor 1500d.

In some embodiments, the optical fiber assembly 1550d may be disposed at least partially in the first the first groove 1556d-1 and the second groove 1556d-2. In some embodiments, the optical fiber assembly 1550d may be substantially encapsulated by the complete shape formed by the first groove 1556d-1 and the second groove 1556d-2. In some embodiments, each of the first groove 1556d-1 and the second groove 1556d-2 may include binding material 1558d disposed therein, respectively. In some embodiments, the binding material 1558d in the first groove 1556d-1 may be substantially the same as, or different from, the binding material 1558d in the second groove 1556d-2.

As shown in FIG. 15E, in some embodiments, the groove 1556e may be defined in an outer surface of the encapsulation layer 1514e, such as at an interface between the encapsulation layer 1514e and the inner coating 1516e. In some embodiments, the optical fiber assembly 1550e may be disposed in the groove 1556e in the outer surface of the encapsulation layer 1514e. In such embodiments, the optical fiber assembly 1550e may be in contact with the inner coating 1516e and/or may be coated on a portion of an exposed surface via the inner coating 1516e. In such embodiments, the inner coating 1516e may protect the optical fiber assembly 1550e from damage. In some embodiments, the optical fiber assembly 1550e may be substantially encapsulated by the binding material 1558e.

As shown in FIG. 15F, in some embodiments, the groove 1556f may be defined in an outer surface of the encapsulation layer 1514f, such as at an interface between the encapsulation layer 1514f and the conductor layer 1520f. In some embodiments, the optical fiber assembly 1550f may be disposed in the groove 1556f in the outer surface of the encapsulation layer 1514f. Although not shown, in some embodiments the conductor layer 1520f may include a groove defined in an inner surface thereof, and the optical fiber assembly 1550f may be at least partially disposed therein.

As shown in FIG. 15G, in some embodiments, conductor 1500g may include a plurality of grooves 1556g-1, 1556g-2, 1556g-3, and/or 1556g-4 (collectively referred to as grooves 1556g) defined in the strength member 1510g, and optical fiber assemblies 1550g-1, 1550g-2, 1550g-3, and/or 1550g-4 (collectively referred to as optical fiber assemblies 1550g) disposed in each of the plurality of grooves 1556g-1, 1556bg-2, 1556g-3, and/or 1556g-4. While four grooves 1556g are shown in FIG. 15G, in some embodiments, the conductor 1500g may include two, three, four, five, six, seven eight, nine, ten, or even greater numbers of grooves 1556g defined in the strength member 1510g. In some embodiments, each of the grooves 1556g may be substantially the same as, or different from one another.

Likewise, while four optical fiber assemblies 1550g are shown in FIG. 15G, in some embodiments, the conductor 1500g may include two, three, four, five, six, seven eight, nine, ten, or even greater numbers of optical fiber assemblies 1550g. In some embodiments, each of the optical fiber assemblies 1550g may be substantially the same, or different from one another. In some embodiments, each of the grooves 1556g include a single optical fiber assembly 1550g disposed therein, as shown in FIG. 15G. However, in some embodiments, a plurality of optical fiber assemblies 1550g may be disposed in a single groove 1556g. While the grooves 1556g are shown in the core 1512g, in some embodiments, a plurality of grooves 1556g may be defined in the encapsulation layer 1514g, or a combination of the encapsulation layer 1514g and the core 1512g. Accordingly, each of the grooves in the encapsulation layer 1514g and/or the core 1512g may each include one or more optical fiber assemblies 1550g. All such embodiments are envisioned herein and should be considered as part of the preset disclosure.

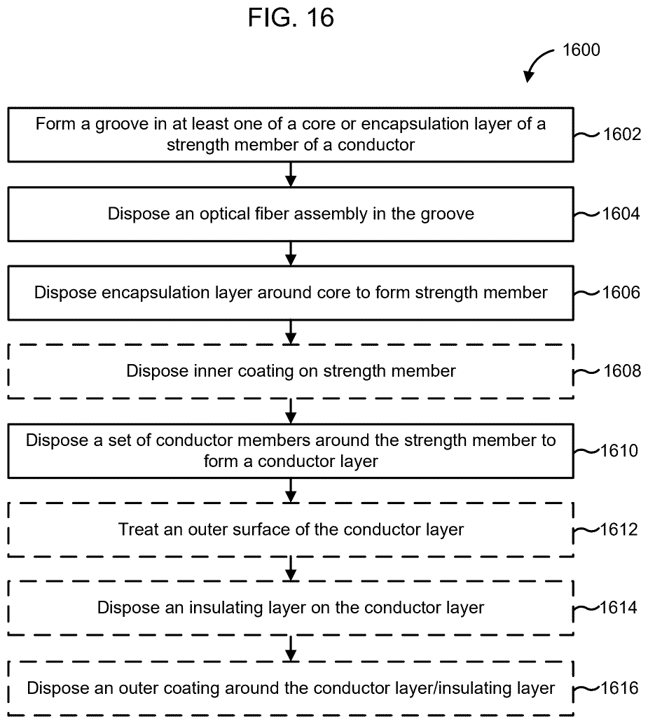

FIG. 16 is a schematic flow chart of a method 1600 for manufacturing a conductor including a groove and an optical fiber assembly in the groove, according to an embodiment. While described with respect to the conductor 1500a including the groove 1556a and optical fiber assembly 1550a of FIG. 15A, in some embodiments, the method 1600 may include any of the conductors 100, 200, 300, 400, 1500b, 1500c, 1500d, 1500e, 1500f, 1500g and/or any features thereof as described herein.

In some embodiments, the method 1600 may include forming a groove (e.g., groove 1556a) in at least one of a core (e.g., core 1512a) or an encapsulation layer (e.g., encapsulation layer 1514a), at operation 1602. In some embodiments, the groove (e.g., groove 1556a) may be formed at operation 1602 via any suitable apparatus, device, system, and/or method. For example, in some embodiments, operation 1602 may include mechanically forming the groove (e.g., groove 1556a) in at least one of the core (e.g., core 1512a) or the encapsulation layer (e.g., encapsulation layer 1514a). For example, in some embodiments, operation 1602 may include at least one of cutting, engraving, indenting, impressing, inscribing, or scraping the groove (e.g., groove 1556a) in at least one of the core (e.g., core 1512) or the encapsulation layer (e.g., encapsulation layer 1514a). In some embodiments, forming the groove (e.g., groove 1556a) may include pressing the optical fiber assembly (e.g., optical fiber assembly 1550a) into at least one of the core (e.g., core 1512a) or the encapsulation layer (e.g., encapsulation layer 1514a) to form the groove (e.g., groove 1556a) In some embodiments, the groove (e.g., groove 1556a) may be formed during pultrusion using a die having a predetermined shape as described herein.

In some embodiments, the method 1600 may include disposing an optical fiber assembly (e.g. optical fiber assembly 1550a) in the groove (e.g., groove 1556a), at operation 1604. In some embodiments, the optical fiber assembly may be disposed in the groove (e.g., groove 1556a) via any suitable apparatus, device, system, or method. For example, in some embodiments, the optical fiber assembly (e.g. optical fiber assembly 1550a) may be disposed along a length of the groove (e.g., groove 1556a). In some embodiments, the groove (e.g., 1556a) may span at least a portion or substantially an entire length of the conductor (e.g., conductor 1500a) such that the optical fiber assembly (e.g., optical fiber assembly 1550a) may be disposed in the groove (e.g., groove 1556a) and extend from a first end to a second end of the conductor (e.g., conductor 1500a).

In some embodiments, the method 1600 may include disposing an encapsulation layer around the core to form a strength member, at operation 1606. In some embodiments, the method 1600 may include disposing an inner coating on the strength member, at operation 1608. In some embodiments, the method 1600 may include disposing a set of conductor members around the strength member to form a conductor layer, at operation 1610. In some embodiments, the method 1600 may include treating an outer surface of the conductor layer, at operation 1612. In some embodiments, the method 1600 may include disposing an insulating layer on the conductor, at operation 1614. In some embodiments, the method 1600 may include disposing an outer coating around the conductor layer and/or around the insulating layer, at operation 1616. In some embodiments, operations 1604, 1606, 1608, 1610, 1612, 1614, and/or 1616 of the method 1600 may be substantially the same as operations 1002, 1004, 1006, 1008, 1010, 1012, and/or 1014, respectively, of the method 1000 as described herein with respect to FIG. 12. Therefore, certain features of the method 1600 and/or operations 1604, 1606, 1608, 1610, 1612, 1614, and/or 1616 are not described in further detail herein.

As used herein, the terms “about” and “approximately” generally mean plus or minus 10% of the stated value. For example, about 0.5 would include 0.45 and 0.55, about 10 would include 9 to 11, about 1000 would include 900 to 1100.

As utilized herein, the terms “substantially” and similar terms are intended to have a broad meaning in harmony with the common and accepted usage by those of ordinary skill in the art to which the subject matter of this disclosure pertains. For example, the term “substantially flat” would mean that there may be de minimis amount of surface variations or undulations present due to manufacturing variations present on an otherwise flat surface. It should be understood by those of skill in the art who review this disclosure that these terms are intended to allow a description of certain features described and claimed without restricting the scope of these features to the precise arrangements and/or numerical ranges provided. Accordingly, these terms should be interpreted as indicating that insubstantial or inconsequential modifications or alterations of the subject matter described and claimed are considered to be within the scope of the inventions as recited in the appended claims.

The terms “coupled,” and the like as used herein mean the joining of two members directly or indirectly to one another. Such joining may be stationary (e.g., permanent) or moveable (e.g., removable, or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes, and omissions may also be made in the design, operating conditions, and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A conductor, comprising:
a strength member, including:
a core including a composite material,
an encapsulation layer disposed around the core,
a groove defined in at least one of the core or the encapsulation layer, and
an optical fiber assembly disposed at least partially in the groove, the optical fiber assembly including a fiber core, a fiber encapsulation layer disposed around the fiber core, and a sensing element disposed within the fiber core at a pre-determined location along a length of the fiber core, the sensing element configured to exhibit a change in at least one of its optical properties in response to a change in a value of an operating parameter of the conductor; and
a conductor layer disposed around the strength member.

2. The conductor of claim 1, wherein the optical fiber assembly has a first cross-sectional area, and the groove has a second cross-sectional area greater than the first cross-sectional area such that the optical fiber assembly is substantially disposed within the groove.

3. The conductor of claim 1, further comprising a binding material disposed in the groove.

4. The conductor of claim 3, wherein the binding material includes at least one of silicone, epoxy, polyurethane, or polydimethylsiloxane (PDMS).

5. The conductor of claim 3, wherein the binding material includes room-temperature-vulcanizing (RTV) silicone.

6. The conductor of claim 1, wherein the groove defines a semi-circular shape.

7. The conductor of claim 1, wherein the groove is defined in an outer surface of the core between the core and the encapsulation layer.

8. The conductor of claim 1, wherein the groove is defined in an inner surface of the encapsulation layer between the core and the encapsulation layer.

9. The conductor of claim 1, wherein the groove is defined in an outer surface of the encapsulation layer between the encapsulation layer and the conductor layer.

10. The conductor of claim 1, wherein the groove is a first groove, further comprising a second groove defined in at least one of the core or the encapsulation layer.

11. A method, comprising:
forming a groove in at least one of a core or an encapsulation layer, the groove extending from a first axial end to a second axial end of at least one of the core or the encapsulation layer;
disposing an optical fiber assembly in the groove, the optical fiber assembly including one or more optical fibers disposed axially along a length of the groove;
disposing the encapsulation layer around the core to form a strength member; and
disposing a conductor layer around the strength member to form a conductor.

12. The method of claim 11, wherein forming the groove includes mechanically defining the groove in the at least one of the core or the encapsulation layer.

13. The method of claim 12, wherein mechanically defining includes at least one of cutting, scraping, or indenting the core to form the groove.

14. The method of claim 11, further comprising:
disposing an inner coating on the strength member between the encapsulation layer and the conductor layer, the inner coating having a solar absorptivity of less than about 0.6 at a wavelength in a range of 2.5 microns to 15 microns.

15. The method of claim 11, further comprising:
disposing an outer coating on the conductor layer, the outer coating having a radiative emissivity of greater than about 0.55 at a wavelength of about 6 microns.

16. The method of claim 11, wherein the groove at least partially defines a shape including at least one of a triangle, a semi-circle, or a rectangle.

17. The method of claim 11, wherein:
the groove is formed in the core, and
disposing the encapsulation layer around the core embeds a portion of material of the encapsulation layer in the groove around the optical fiber assembly.

18. The method of claim 11, wherein forming the groove includes pressing the optical fiber assembly into at least one of the core or the encapsulation layer.

19. A system, comprising:
a conductor including:
a strength member, including:
a core formed of a composite material,
an encapsulation layer disposed around the core, and
an optical fiber assembly disposed in the core, the optical fiber assembly including: a fiber core, and a fiber encapsulation layer disposed around the fiber core, and a sensing element disposed within the fiber core at a pre-determined location along a length of the fiber core, the sensing element configured to exhibit a change in at least one of its optical properties in response to a change in a value of an operating parameter of the conductor; and
a conductor layer disposed around the strength member; and
a controller communicatively coupled to the optical fiber assembly, the controller configured to:
receive a sensing signal from the optical fiber assembly, the sensing signal indicative of the operating parameter of the conductor, and
at least one of: transmit the sensing signal to a receiver, or interpret the signal to determine a value of the operating parameter and transmit the value of the operating parameter to the receiver.

20. The system of claim 19, wherein the controller includes:
a first controller configured to:
receive a first sensing signal from the optical fiber assembly, and
at least one of: transmit the first sensing signal to a first receiver, or interpret the first sensing signal to determine a value of a first operating parameter and transmit the value of the first operating parameter to the first receiver; and
a second controller configured to:
receive a second sensing signal from the optical fiber assembly, and
at least one of: transmit the second sensing signal to a second receiver, or interpret the second sensing signal to determine a value of a second operating parameter and transmit the value of the second operating parameter to the second receiver.

21. The system of claim 20, wherein the first sensing signal received from the optical fiber assembly includes a Brillouin backscattered signal and the first operating parameter of the conductor includes strain.

22. The system of claim 20, wherein the first sensing signal received from the optical fiber assembly includes a Brillouin backscattered signal and the operating parameter of the conductor includes strain and temperature.

23. The system of claim 20, wherein the second sensing signal received from the optical fiber assembly includes a Raman backscattered signal and the operating parameter of the conductor includes temperature.

24. The system of claim 19, wherein the sensing signal received from the optical fiber assembly includes at least one of a Rayleigh backscattered signal, a Brillouin backscattered signal, or a Raman backscattered signal.

25. The system of claim 19, wherein the operating parameter of the conductor includes at least one of temperature, strain, length, or sag of the conductor.

26-50. (canceled)
